(19) United States
(12) Patent Application Publication
(10) Pub. No.: US 2026/0342959 A1
(43) Pub. Date: Oct. 29, 2026

(54) VISUAL DISPLAY SYSTEMS AND METHODS

(71) Applicant: Musikase, LLC, Reston, VA (US)

(72) Inventor: Jack Barufka, Reston, VA (US)

(73) Assignee: Musikase, LLC, Reston, VA (US)

(21) Appl. No.: 19/655,794

(22) Filed: Apr. 23, 2026

Related U.S. Application Data
(63) Continuation of application No. PCT/US2026/010088, filed on Jan. 5, 2026.
(60) Provisional application No. 63/793,492, filed on Apr. 23, 2025.
(60) Provisional application No. 63/841,333, filed on Jul. 9, 2025.
(60) Provisional application No. 63/872,355, filed on Aug. 28, 2025.
(60) Provisional application No. 63/876,024, filed on Sep. 5, 2025.

(51) Int. Cl. H04N 13/398; G06F 3/16; G10L 21/055; H04N 13/366

(52) U.S. Cl. CPC H04N 13/398; G06F 3/167; G10L 21/055; H04N 13/366; H04N 2213/008

(57) ABSTRACT

A system and method are provided for generating, processing, and presenting visual content. The system may include one or more display devices and a computer system configured to generate, control, and coordinate presentation of visual content. The visual content may include lyrics, characters, or other graphical representations. Some embodiments may be used in live settings and the visual output of the system may be based on the position and/or orientation of a performer.

This application is a continuation of International Application PCT/US2026/010088, filed Jan. 5, 2026, which claims the benefit of U.S. Provisional Application Nos. 63/741,980, filed Jan. 6, 2025, and 63/793,492, filed Apr. 23, 2025. This application also claims the benefit of and priority to U.S. Provisional Applications 63/793,492, filed Apr. 23, 2025, 63/841,333, filed Jul. 9, 2025, 63/872,355, filed Aug. 28, 2025, and 63/876,024, filed Sep. 5, 2025. The entire contents or each of the foregoing applications are hereby incorporated by reference in their entirety.

The present application provides various embodiments, including improvements to visual displays, visual effects, and methods and systems for presenting media and content, as described in the detailed description below, and as will be understood by the appended claims.

### BACKGROUND

Various “holographic” displays are known and that provide what appears to be a three-dimensional image to the observer.

For example, holographic fans, also known as 3D hologram fans, create visual illusions by using a rapidly spinning LED display. The fan has a plurality of blades, and a plurality of LEDs are mounted on each blade. The LEDs light up in precise sequences as they spin. When the fan rotates at high speed, the LEDs turn on and off quickly, creating the appearance of a three-dimensional image suspended in mid-air. This is achieved through the persistence of vision, where the human eye perceives continuous motion from rapidly changing images. The device is often controlled by software that uploads and sequences the images or videos to be displayed. As the LEDs light up at specific intervals and angles, they form what appears to be a coherent 3D image that appears to float in space.

Other “holographic” displays are also known, such as those formed by a Pepper's Ghost technique. Pepper's ghost is an optical illusion technique used to make objects appear as though they are floating, transparent, or in a different location. This can be done by use of a glass pane or a highly reflective, transparent surface, such as plexiglass or a specially coated foil, or reflective mesh that is placed at an angle between the audience and a hidden area. In another embodiment, the reflective/transparent surface can be essentially perpendicular to the audience, and a projector is placed at a steep angle (e.g., 45 degrees or more) from above or below, and projecting the image onto the surface. The hidden area (out of direct view of the audience) contains the projector, object, image, or performer to be projected. The reflective glass, mesh or foil redirects the image of the brightly lit object into the audience's line of sight. As a result of this arrangement, the audience sees the reflection of the hidden object on the surface, which appears to be floating in air or interacting with the visible stage scene behind it. In some implementations, such as for theatrical productions, a projector projects image content directly onto a substantially transparent holographic mesh or scrim positioned within a viewing volume. The mesh comprises a fine, light-diffusing structure that reflects and scatters projected light while remaining largely invisible under ambient lighting, thereby producing the appearance of a free-floating or volumetric image.

Yet another type of “holographic” device or display takes the form of volumetric displays that employ advanced projection systems, spatial computing, and/or directional layers (e.g., lenticular layers) to generate what appears to be a three-dimensional display.

Although Pepper's Ghost, holographic fans, and volumetric displays, for example, are not technically a form of true “holography” in the scientific sense (which typically utilizes lasers and interference patterns or light diffraction to form an image), they are often referred to as such due to their ability to create the illusion of a three-dimensional image, even though they are technically a two-dimensional image. Thus, as used herein, the term “holographic display” is used in a broad, functional sense to refer to any display medium or arrangement that produces for the audience the percept of three-dimensional, floating, or depth-enhanced imagery. Holographic displays therefore include, without limitation, transparent or semi-transparent projection surfaces (e.g., holographic mesh or scrim), LED meshes or fan-based arrays, transparent emissive panels (e.g., OLED, micro-LED), Pepper's Ghost systems, mist or water-based projection surfaces, and other optical arrangements that allow imagery to appear as volumetric or floating. In some embodiments, the term also encompasses advanced digital holographic devices such as spatial light modulators, optical phased arrays, or electroholography systems. Unless otherwise specified, “holographic display” as used in this disclosure does not require a particular physics-based holography technique, but broadly covers any display that provides the effect of holographic or three-dimensional imagery to the audience.

Other embodiments described herein pertain to different configurations or applications of various different display devices described herein. Specifically, modern performance venues, interactive installations, and multi-display entertainment systems, increasingly seek unique presentation of audiovisual content, and existing systems have not sufficiently addressed this need. Among other things, this disclosure addresses these deficiencies by providing various systems that manage and coordinate media sources—including audiovisual and/or textual content—across various different display and audio output devices and/or animation types. Among many various solutions, the present disclosure provides new systems, devices, controllers, displays, animations, and/or methods of operation thereof that provide unique audio-visual output and solve existing needs.

In another embodiment a system is provided for outputting audio/visual content. The system comprises memory storing pre-recorded audio content and visual content, a controller operatively connected with the memory, the controller configured to output the visual content to a display and output the audio content to an audio output device, and at least one sensor operatively connected with the controller, the at least one sensor configured to provide position and/or orientation data to the controller based on a sensed position and/or orientation of an individual, wherein the controller is configured to output the visual content at a position and/or orientation on the display based on the position and/or orientation data.

In another embodiment a method is provided for presenting synchronized lyrics. The method comprises outputting audio content stored in memory, outputting visual lyric content stored in memory, sensing a position and/or orientation of a performer and generating a sensor output signal based on the sensed position and/or orientation, and orienting the output visual lyric content based on the sensor output signal

In another embodiment a non-transitory computer-readable medium is provided that stores instructions that, when executed by at least one processor, cause a computer system to perform a method comprising outputting audio content stored in memory, outputting visual lyric content stored in memory, sensing a position and/or orientation of a performer and generating a sensor output signal based on the sensed position and/or orientation, and orienting the output visual lyric content based on the sensor output signal.

In another embodiment, a display system comprises memory storing lyric content, a controller operatively connected with the memory, the controller configured to output the lyric content to a display in temporal alignment with the audio content, and at least one sensor operatively connected with the controller, the at least one sensor configured to provide position and/or orientation data to the controller, wherein the controller uses the data to determine an origin point and/or initial direction of the lyric content movement on the display.

In another embodiment a system is provided for outputting audio/visual content. The system comprises a controller configured to receive audio input from a performer, memory storing visual lyric content, the memory operatively connected with the controller, the controller configured to output the visual lyric content to a display based on the received audio input, and at least one sensor operatively connected with the controller and configured to sense an orientation and/or position of the performer and, based thereon, output position and/or orientation data to the controller, wherein the controller uses the position and/or orientation data to determine an origin point and/or initial direction of visual lyric content movement on the display.

In another embodiment a method of displaying lyrics during a live performance is provided and comprises sensing a position and/or orientation of a performer, receiving audio corresponding to a vocal performance of the performer, and outputting visual lyrics in temporal alignment with the vocal performance on a display, the lyrics being positioned on the display based on the position and/or orientation of the performer.

In one embodiment, the controller renders at least a portion of visual text or visual lyrics based on a predictive determination of upcoming lyric content from the stored lyric data in response to detection of an initial phonetic element.

In other embodiments, a system and method provide a unique way of generating a visual representation of vocal expression. The system and method will function by generating audio output of vocal expression; generating a sequence of visual symbols on a display, the visual symbols corresponding to phonetic components of the vocal expression, the visual symbols being generated on the display at a location proximate a visual origin of the vocal expression, the visual symbols moving on the display in a direction corresponding to the direction at which the visual origin of the vocal expression is visually directing the vocal expression; arranging the symbols such that each new symbol appears closer to the visual origin than the previously generated symbol, thereby forming a temporally-ordered visual trail; and rendering the visual trail on the display in a manner that maintains a predetermined linguistic reading direction.

In accordance with various embodiments, a spoken or sung language is represented spatially by projecting letters outward or away from the visual vicinity of a live performer's mouth as the words are being enunciated (with or without a microphone/speaker system), or by projecting letters away from the visual vicinity of a recorded performer's mouth as they are sounded by the system (e.g., over speakers). The letters form a visible stream or trail, allowing a viewer to see words take shape in real time or as pre-recorded. The temporal sequence of letters is mapped to physical space so that each letter appears as it is enunciated and then moves farther from the performer over time.

In one embodiment, each letter appears initially near the performer's (singers or speakers) mouth at the moment (within a fraction of a second) it is enunciated (i.e., spoken or sung). As the next letter is enunciated, the previous letter is displaced further from the speaker. Thus, the most recently spoken letter is closest to the speaker, and earlier letters are progressively farther away, forming a visible word trail.

In one embodiment, the system includes one or more position markers, detectors or sensors carried by the live performer, such that the lyrics are positioned on the display based on the position and/or orientation of the performer. Numerous additional aspects and features of the various inventions disclosed herein and not mentioned above for brevity's sake can be appreciated from the following disclosure, claims, and drawings.

In another embodiment, different content (e.g., different videos or video types) may be integrated into single video-visual experience (e.g., a system that includes a primary video on one display and switches between “filler content” and a secondary video on another display). Other embodiments provide a means for synchronizing multiple secondary videos with repeated audio segments within or associated with the primary video, allowing different secondary videos to be played for each occurrence of the predefined audio segment. Additionally, in some embodiments, secondary videos can be selected from a predefined set based on a programmed sequence, randomized order, or user selection.

In one embodiment, the system utilizes predefined timestamps to trigger the playback of a secondary video at specific points within a primary video. This approach eliminates the need for real-time analysis of the primary video's audio or visual content by relying on preconfigured synchronization data. The system preloads the primary video and its corresponding timestamp mapping from a database or configuration file.

In one embodiment, the first display continuously plays the primary video, and the second display defaults to a mirrored version of the primary video, a lyrics video displaying the lyrics to the song of the primary video, and/or other filler content. At predefined timestamps, the system seamlessly transitions the second display to play the corresponding secondary video. After the secondary video completes, the second display reverts to filler content or mirrored primary video. If a repeated segment occurs in the primary video, the system either replays the same secondary video or selects an alternative from a predefined set.

It should be appreciated that, as used herein, the term “filler content” or “filler video” may refers to any content that may be displayed on the second display other than a short-form media clip (e.g., a TikTok or Reels clip). Thus, for example, the filler video can be a synchronized lyrics video, a mirror image of the primary video, or any video other than the short-form media clip.

In another embodiment, the entirety of the secondary video is prerecorded and is triggered to commence at the same time as the primary video and audio file, so that both video files and audio file are synchronized. In such embodiment, timestamp based switching may not be used, as editing is done in advance such that the system does not make decisions during playback.

In another embodiment, the entirety of the secondary video is a lyrics video displaying the lyrics of the song being performed as the primary video. The two videos and the lyrics are synchronized. It should thus be appreciated that the content of a lyrics video can serve as either the secondary video or the filler video.

### BRIEF DESCRIPTION OF THE DRAWINGS

FIG. 1 is a schematic view of a performance display system.

FIG. 2 is a top view of a display system with a live performer positioned in front of the display.

FIG. 3A is a top view of a display system with a live performer positioned behind a transparent or semi-transparent display.

FIG. 3B is a side view of a display system with a live performer positioned behind a transparent or semi-transparent display

FIG. 4A is a front view showing lyric formation.

FIG. 4B is a front view showing lyric formation with multiple letter repetition for elongated sounds.

FIG. 4C is a front view showing lyric formation with letter rotation for elongated sounds.

FIG. 4D is a front view showing curved lyric path formation to maintain proper English reading direction.

FIG. 5A is a schematic plan view of a hybrid display system with primary display and array of holographic fans.

FIG. 5B is a schematic top view of a subset of holographic fans from the array of FIG. 5A.

FIG. 5C is a schematic plan view showing lyric movement paths across different display types.

FIG. 6 is a schematic top view of a hybrid display system showing fan positioning relative to a primary display.

FIG. 7 is a schematic top view showing fans positioned in overlapping relationship in front of primary display.

FIG. 8 is a schematic top view showing fans positioned with front planes aligned with primary display.

FIG. 9 is a schematic perspective view of a hybrid display system and physical interaction elements.

FIG. 10A is a schematic front plan view of a transparent OLED display system with selective backing regions.

FIG. 10B is a schematic rear view of the transparent OLED display system showing a backing structure.

FIG. 10C is a schematic side view of the backing mechanism with motorized roll-up display.

FIGS. 10D and 10E are a front view of a transparent OLED display with cropped video in upper right region and schematically representing lyric formation.

FIG. 11 is a perspective view of a hybrid display system, including projection-mapping.

FIG. 12 is a block diagram of a controller used in the computer system disclosed herein, with various connected input and output devices.

FIGS. 13, 14, and 15 are block diagrams of a computing system with processors, memory, input/output interfaces, and other components used for multiple applications.

### DETAILED DESCRIPTION

In various embodiments, the system displays images of visual lyrics in synchronization with the audio lyrics in a unique manner. The lyrics will appear to move away from a live (physically present) performer, broadcast (live) performer, or recorded performer in a manner and direction such that they appear to emanate away from the performer, depending upon the location and/or orientation of the performer or performer's face (or head).

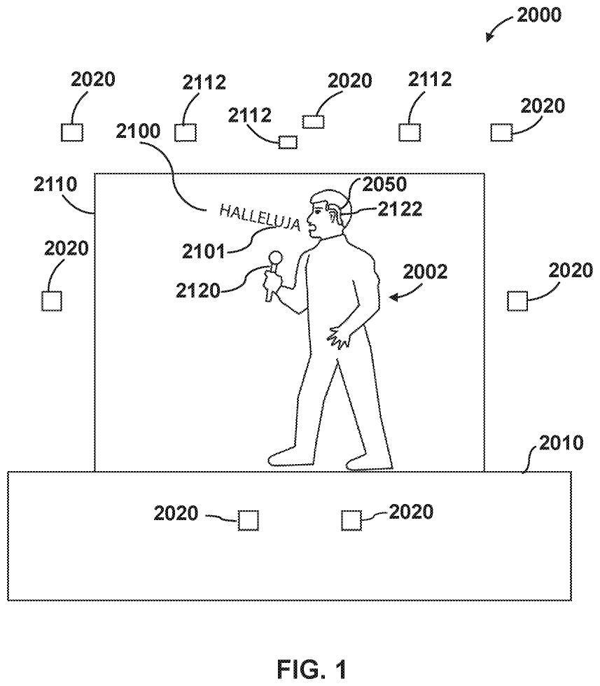

For example, in the embodiment of FIG. 1, a live performer (e.g., singer or speaker) 2002 is illustrated on a stage 2010. In this embodiment, the system 2000 uses one or more position detectors that provide output signals to a computer system 1000 and/or controller (see the description in connection with FIGS. 12-15) to determine the real-time location and/or orientation of a live singer's (or speaker's) mouth or facial orientation so that letters of the lyrics 2100 to a song can appear on a display as though they are being emitted from the vicinity of the performer's mouth. For example, in the embodiment of FIG. 1, the visual word or lyric “HALLELUJAH” is displayed on the display 2110 (in sync with the audio output of this word) at a location appearing to generally correspond to the location of the singer's mouth, as will be described in greater detail later in this disclosure. Various types of position and orientation detection systems may be employed for this purpose. These systems can include detectors and/or markers 2122 carried by the performer, such as on a wearable 2050, can include remote sensors 2020 disposed on or around the stage 2010 (with or without use of a wearable), or any combination thereof.

For example, in one embodiment, the wearable 2050 may comprise one or more markers 2122, such as retroflective film (e.g., small hemispherical or flat micro-glass beads or prisms, which for example can be 3-12 mm in diameter) that can be adhered at an appropriate location on the performer or a device carried or mounted on the performer. Such film may be used in conjunction with infrared illumination or near-infrared (“NIR”) LED illumination to illuminate the marker, and an NIR detector or camera (such as a monochrome CMOS camera) to detect the marker location. As another option, the marker 2122 may comprise discrete infrared LEDs that can be mounted on a wearable, such as glasses, a headband, etc. Such infrared (“IR”) LEDs may be powered by a coin cell or small Li-ion battery, and an IR-sensitive monochrome camera may be used as the detector. As another option, the marker 2122 may comprise black or white dots (e.g., non-glossy/matte vinyl material) that can be used as marker material, visible light can be used for illumination, and an RGB or monochrome visible light camera can be used as the detector or sensor 2020. In various embodiments, the marker 2122 can be positioned on any device, wearable, headset, glasses and/or microphone carried or worn by the performer.

In other embodiments, no marker is used. For example, in one embodiment, the performer is illuminated by visible light, and optionally supplemented by NIR flood illumination, and the sensor 2020 can be an RGB camera, and optionally paired with an IR mono camera 2020 for redundancy. In one embodiment where no marker is used, facial landmarks may be detected and tracked by computer vision software (e.g., MediaPipe, dlib, OpenFace, for example) that receives the detector/camera signal. In one or more embodiments, the sensor(s) 2020 may interface with one or more controllers, such as the type(s) discussed below with respect to FIGS. 12, 13, and 14, such that one or more real-time facial landmark detection algorithm(s) identifies facial landmarks using the software models mentioned above. Such models may include, for example, one or more of Haar cascades and/or face shape analyzers that rely on statistical models trained on the human face. In some embodiments, the system places several landmarks (e.g., 68 landmarks) on specific parts of the face, and may use a histogram of oriented gradients (HOG) combined with support vector machine (SVM) classifiers, convolutional neural networks (CNNs), and/or deep learning models trained to detect eye, nose, and mouth positions. In one embodiment, the coordinates of the mouth center (or lip corners) may be calculated and updated continuously during enunciation.

In another embodiment, infrared or depth-based detectors 2020 can be employed. In some embodiments, the speaker's face may be segmented, and/or the mouth cavity or opening may be detected based on geometric depth changes and/or thermal variation.

It should be appreciated that in some embodiments, the detector(s) or sensor(s) 2020 conduct sensing using various optical detection systems/components. These systems can be generically referred to as an optical detector or sensor. An “optical sensor” or “optical detector” as used herein refers broadly to any device, component, module, or arrangement of components capable of detecting, receiving, capturing, measuring, or otherwise responding to electromagnetic radiation, whether across the visible spectrum or any other portion of the electromagnetic spectrum, including without limitation ultraviolet, visible, near-infrared, short-wave infrared, mid-wave infrared, long-wave infrared, thermal, and terahertz radiation, and further including any radiation detectable through optical, electro-optical, photonic, or imaging means. An optical sensor may generate, as output, any form of signal or data representative of the detected radiation, including without limitation analog signals, digital signals, still images, sequences of images, video, frames, pixel data, raw sensor readings, point clouds, depth maps, disparity maps, range data, intensity data, phase data, polarization data, spectral data, event-based data, time-of-flight data, or any data derived, processed, compressed, encoded, or transformed therefrom. An optical sensor may take any form, including without limitation a camera (monocular, stereo, multi-camera, array, or plenoptic), an image sensor (including CCD, CMOS, sCMOS, EMCCD, InGaAs, or quantum-dot-based sensors), a photodetector, photodiode, phototransistor, or avalanche photodiode, a single-photon avalanche diode (SPAD) or SPAD array, a charge-coupled or active-pixel sensor, an event-based or neuromorphic vision sensor (including dynamic vision sensors), a thermal or infrared imager (including bolometers and microbolometer arrays), a time-of-flight sensor (including direct and indirect time-of-flight), a structured-light sensor, a LiDAR or laser-based ranging sensor (including flash, scanning, solid-state, and FMCW LiDAR), a depth sensor or 3D sensor, a hyperspectral, multispectral, or spectroscopic sensor, a polarimetric sensor, a light-field or plenoptic sensor, an interferometric sensor, a holographic sensor, a radiometric sensor, a photometric sensor, or any combination, array, or network of the foregoing. An optical sensor may further include, be coupled to, or cooperate with associated optical components, including without limitation lenses, mirrors, prisms, diffractive elements, gratings, filters, beam splitters, waveguides, apertures, shutters, polarizers, collimators, illumination sources (including active illumination such as lasers, LEDs, structured-light projectors, and flood illuminators), and any supporting or ancillary optics or electronics. References herein to an optical sensor shall be understood to encompass a single such sensor, a plurality of such sensors (whether of the same or different types), and any system, assembly, or module incorporating one or more such sensors, whether co-located or distributed.

It should be appreciated that while the position of the performer's mouth is discussed extensively herein, other features of the performer, and particularly on the performer's head (such as any feature on the performer's face, or the entire face itself), can be tracked for lyric placement. For example, the performer's nose, eye's, overall face, etc. can be surrogates for the mouth (meaning that these elements can be considered close enough to the performer's mouth that lyrics that are positioned based on the position of one or more of these facial features can be sufficient by themselves for tracking and/or can be used to approximate the position of the performer's mouth). As noted above, in some embodiments, the singer or speaker may wear a physical wearable, such as head mounted wearable 2050 illustrated in FIG. 1, connected to the computer system and/or controller 1010 described below. In one embodiment, the wearable 2050 enables head tracking. For example, in one embodiment, the wearable 2050 comprises one or more markers, or head-mounted position sensors or detectors 2122 that may be integrated with a wearable. In some embodiments, the wearable 2050 can be a headset, head-mounted microphone, smart glasses (e.g., as described later), or any other wearable that can be used to provide position information about the performer. In one embodiment, these sensors output spatial data that allows letter projections 2100 to be fixed relative to a world coordinate system relative to the speaker's body. As shown in FIG. 1, letter projections 2100 are displayed on a display 2110.

It should be appreciated that display 2110 can be any one or more of the various different types of displays (opaque display, augmented display, etc.) as disclosed herein without limitation, with different display types offering different advantages. Thus, any one, or various combinations of displays (referred to herein as a hybrid display) as disclosed herein can be used to constitute the display 2110. As used in this application, an “augmented display” shall mean non-traditional display devices that include, but are not limited to, holographic meshes or holographic projection scrim (such as Hologauze) in combination with a projector, holographic fan displays (rendering content via persistence of vision), transparent OLED displays, Pepper's Ghost projection systems, particle-based projection surfaces (e.g., mist curtains), or other three dimensional, transparent, and/or semi-transparent display types.

In one embodiment, the wearable 2050 can take the form of a head-mounted microphone or hand-held microphone 2120 to be held by the lead singer. In one embodiment, the microphone has a marker or position sensor 2122 disposed thereon to allow the computer system 1000 to receive a signal (e.g., from a tracking device) indicating the three dimensional position and orientation of the singer's mouth as approximated by the orientation of the microphone while the singer is using it to sing, such that the lyrics 2100 being projected by the adjacent display 2110 are projected in a direction that the singer is facing. In one embodiment, the microphone 2120 can not only provide audio input (from the performer) to the computer system 1000 for any of the purposes disclosed through this application, but can also be considered a “wearable” for the purposes of this disclosure and can function as the position detector.

Position sensors 2122 of the wearable 2050 may also, or alternatively, use or include inertial measurement sensors (which optionally utilize a combination of accelerometer(s), gyroscope(s) and magnetometer(s), or attitude heading reference systems, just for example, as will be described in greater detail later). In another embodiment, real time imaging of the lead singer is achieved by use of imaging sensors (such as any type of suitable camera) in combination with pose estimation software.

In one embodiment, the mouth position acts as a dynamic anchor point in a spatial model. In one embodiment, a projection algorithm uses directional vectors derived from the speaker's head pose to determine the initial direction of the letter stream. In one embodiment, if the speaker turns their head, the system adjusts the stream angle accordingly, maintaining correct spatial flow. As the system dynamically determines the mouth location, it dynamically generates a letter commencement point 2101 (see FIG. 1) projection trail along a defined direction in space. The projected visual symbols (which in some embodiments may be words or lyrics) may be displayed via one or more of the visual output systems and displays described herein.

In one embodiment, the system defines a unified world coordinate frame that binds the performer tracker, stage geometry, and the display 2110 (e.g., gauze plane, etc.) so that letter projections (lyrics) 2100 remain spatially registered as the performer moves. The controller calculates a lyric commencement point 2101 and directional vector for lyric projection by correlating the measured position and orientation of the performer's head, mouth and/or wearable with the known position and orientation of the display surface. This directional vector establishes the angle at which the lyric text will be projected so that it appears to emanate from the performer and in the direction the performer is facing. Orientation and position data may be obtained from one or more sensors/tracking systems, including one or more of optical tracking from performer-facing cameras, computer vision (such as facial landmark detection), one or more depth sensor (such as LiDAR, structured light, stereo cameras, and/or time of flight cameras), wearables that include one or more of inertial measurement units (IMUs) comprising accelerometers, gyroscopes, and/or magnetometers, ultra-wideband (UWB) positioning tags (described below), and/or any combination of these systems. When the performer's handheld or head-mounted microphone 2120 is equipped with position sensors 2122, it can serve as the wearable, and its location and/or orientation can be used as a proxy (or to generate a proxy) for mouth location and/or direction, serving as a reference for calculating the projection vector. As used herein, the term “sensor” is a more generic term than “optical sensor” as previously defined and refers broadly to any device or combination of devices capable of generating orientation and/or position information, and may include a single sensing component (e.g., an image sensor, camera, an inertial measurement unit) or multiple components (e.g., combination of one or more optical sensors, IMUs, magnetometers, just for example). Reference number 2020 as used herein applies to any/all of the sensors as described herein.

In one embodiment, the hardware and software within the controller (see FIGS. 12-15) process raw sensor data to filter noise, compensate for jitter, and stabilize the calculated directional vector. This processing may involve combining multiple data sources through sensor fusion techniques to improve accuracy. For example, one or more cameras 2020 aimed at the performer can detect head pose and mouth position, but it may lose accuracy if the face is partially or fully out of the camera's field of view for any reason. In one embodiment, an inertial measurement unit (IMU) 2122 in a wearable 2050 (e.g., inertial sensors such as one or more accelerometer(s), gyroscope(s), and magnetometer(s)) can track movement and orientation (e.g., yaw, pitch roll) without needing line of sight, but has the potential to drift over time and accumulate error. In one or more embodiments, the wearable sensor(s) may include radio frequency positioning tags, such as ultra-wideband (UWB) or Bluetooth angle-of-arrival beacons, which may cooperate with fixed anchors in the venue to yield three-dimensional position data. In some embodiments, the wearable may further include optical or infrared beacons that can be tracked by stage-mounted cameras or optical sensors 2020. If employed, a UWB tag (e.g., combined with UWB radio units installed at known/fixed positions around the stage) can optionally provide absolute position in a stage coordinate frame, but with somewhat limited orientation data. In one embodiment, combining or merging the output of these sensors can be used to improve accuracy of the system as a whole to generate a more accurate directional vector. In one embodiment, the stabilized vector output is supplied to the rendering subsystem and any associated media server, which may apply perspective correction so that the lyric text remains visually generally aligned with the desired orientation relative to the performer from the audience's viewpoint, regardless of stage position or movement.

In one embodiment, the performer-tracking subsystem can be implemented with one or more externally mounted, performer-facing optical sensor(s) 2020 located around the stage. In one embodiment, near-infrared (NIR) illumination with matched band-pass filters on the cameras provides robust facial feature contrast under bright or dynamic visible lighting. In low-light environments, the same NIR illumination ensures that the performer's face remains consistently trackable even when visible-light levels are insufficient for reliable detection. In one embodiment, by decoupling the tracking subsystem from the visible light spectrum, the system can maintain accurate facial and head pose tracking regardless of whether the stage is brightly lit, dimly lit, or undergoing rapid lighting transitions. In one embodiment, two or more cameras are used together to allow the system to perceive depth and improve its ability to track the performer even if part of the face is temporarily blocked. The cameras can be set up in a known spatial arrangement so that their images can be combined to calculate a consistent three-dimensional position of the performer's mouth and the orientation of the head.

Thus, in one embodiment, the system includes redundancy features designed to address real-world performance conditions such that if one of the tracking inputs becomes unavailable, such as when a position sensor (e.g., in a microphone or wearable) may temporarily stop transmitting, or a camera loses sight of the performer, the system can continue operating using the remaining data sources. For example, if the fusion process cannot combine multiple signals, the system may rely solely on vision-based tracking or on inertial sensors until full functionality is restored.

In one embodiment, the computer system 1000 performs a calibration process to ensure the one or more sensors 2020 and the display 2110 (e.g., hologauze, mesh, LED display, holographic fan(s)) are all working within the same coordinate space. This can be done by placing reference markers or using other simple calibration tools so that the system knows the precise location where each camera is located and how the display surface is positioned. Once this relationship is established, the media server or graphics engine can use it to place the lyric text at the correct depth and angle, ensuring that the words appear properly aligned with the performer and look consistent to the audience from different viewing positions.

In one embodiment, the calibration process is carried out using reference markers that are positioned at specific locations on or near the display surface 2110, such as at its corners, edges, or at defined grid points across the surface, so that the system can determine the exact plane and orientation of the display. Additional markers may also be placed at fixed points on the stage floor or stage structure surrounding the performer to provide further positional references. The sensors 2020 are arranged so that each can view at least some of the markers during calibration, allowing the system to calculate the relative positions and orientations of the cameras with respect to both the performer area and the display surface. Once calibration is complete, the markers may be removed for aesthetic purposes or left in place unobtrusively to allow for periodic recalibration during a performance run.

In an embodiment, calibration for the display 2110 may be carried out using built-in test patterns or display-level calibration routines rather than external physical markers. The display processors or controllers may generate reference grids, alignment crosses, or brightness/color patterns that are captured by the cameras during setup, allowing the system to determine the precise boundaries, alignment, and orientation of the display within the coordinate space. Small unobtrusive markers may optionally be placed along the frame or edges of the display to provide supplemental spatial references if needed. Once the calibration is complete, the system uses the established relationship between the performer's tracked position and the display surface to maintain correct lyric or other image placement. Periodic recalibration may be performed automatically or semi-automatically by briefly displaying reference patterns between shows or during setup, ensuring that the text continues to appear stable and properly aligned over time.

In one embodiment, the one or more sensors 2122 outputs position data over a wireless transmitter (e.g., Wi-Fi, Bluetooth, or proprietary RF) to the controller 1010 (see FIGS. 12-15) and provides continuous head-orientation data to controller 1010. In one embodiment, location data transmission may comprise a wireless communication interface implemented in whole or in part on the wearable, and may include associated radio-frequency components such as an antenna integrated into the wearable. In one embodiment, the controller 1010 uses this data to determine the display on-display origin point and initial trajectory of the lyric graphics for the audience-facing display(s). In some embodiments, when Bluetooth or other higher-latency wireless links are used, the controller 1010 may optionally apply a short buffering interval and interpolation to orientation data received from the wearable 2050. This buffer can be used to smooth jitter and, in combination with predictive filtering, can compensate for transmission delays so that the lyric graphics remain stable and appear temporally aligned to the performer's location and facing direction.

In one embodiment, the controller 1010 interprets the orientation data as a vector representing the facing direction of the performer. This vector is projected into the coordinate system of the target display surface (e.g., LED wall, scrim, fan, mesh, etc.), which defines the surface as a two-dimensional grid of horizontal and vertical pixel coordinates situated within the venue's three-dimensional coordinate frame. In one embodiment, when determining the lyric projection origin and direction, the controller may also take into account a representative audience viewpoint or region so that parallax is compensated and the apparent lyric origin aligns with the performer's head position as seen by the audience (at least a significant portion or majority of the audience). The intersection of the projected vector with the display plane, as viewed from that audience region, is assigned as the origin point for the lyric graphics, and the direction of the vector establishes the initial path along which the lyrics travel. In this way, the controller converts real-world head orientation/location and audience perspective into a defined starting location and trajectory within the two-dimensional coordinate space of the display. In one embodiment, to accommodate for parallax, the origin of words may commence at a location that is spaced 6″ to 12″ in front of a performer. For example, the words may originate 6-12″ further left of a left-facing performer or 6-12″ further right of a right-facing performer. In this way, the words can be positioned such that they do not appear to be commencing on top of (or even behind) the performer's face or facing direction. If facing straight at the audience, in one embodiment, the words may commence 6-12″ above the performer's head. In one embodiment, an imaginary “halo” can be positioned about the performer's head and can represent a continuum of the possible commencement positions for words.

In some embodiments, the controller 1010 implements a display-agnostic rendering pipeline that computes lyric origin and trajectory in a venue-fixed three-dimensional coordinate system based on detected positioning/orientation of the performer and an audience viewpoint model.

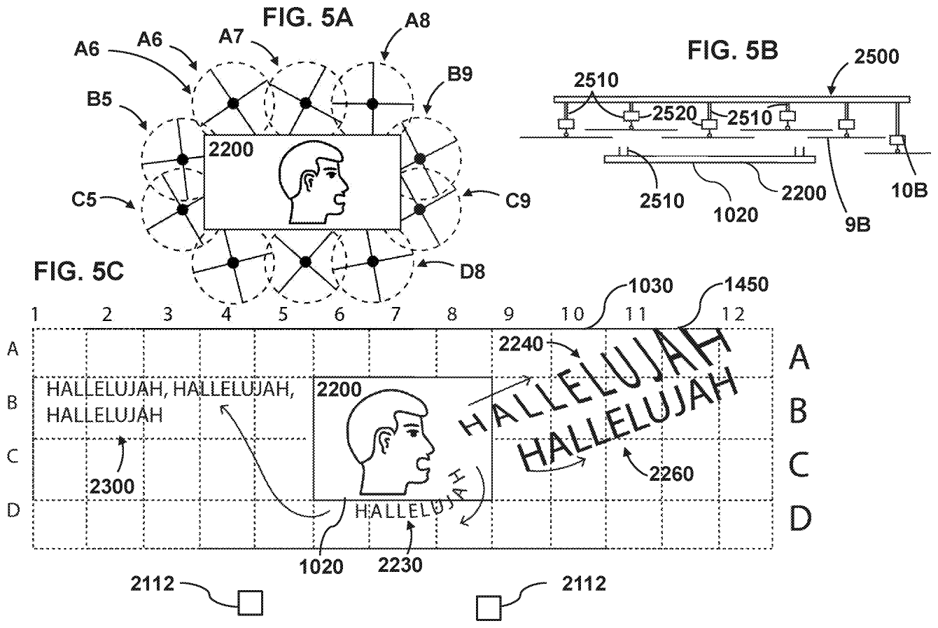

In one embodiment, device mapper software is implemented as a software module within controller 1010 or computer system 1000. The device mapper associates media content (such as lyrics) with the coordinate systems of one or more output devices (e.g., first display 2200, second display 1030, augmented displays, etc.—see FIGS. 5A-5C and related description for example) and can perform tasks such as cropping, scaling, warping, or assigning content windows to the physical displays, thereby ensuring that each display or display region receives the correct portion of the media.

In one embodiment, the device mapper ensures that lyric graphics end up in the right place on whatever kind of display or surface is being used. The controller 1010 determines at what point (e.g., what pixel) on the display the lyrics should originate (for example, lined up with the performer's head direction as seen from the audience).

In one embodiment, if the display is any type of LED display, for example, the device mapper receives normalized spatial data from controller 1010, which may include a position of the performer (as determined by the one or more sensors), an orientation vector representing the performer's facing direction, and optionally a representative audience viewpoint. In one embodiment, using this data, the device mapper computes an intersection point between the orientation vector and the display plane, translates that intersection into the pixel coordinate system of the target display surface, and assigns that point (e.g., a particular pixel on the display) as the lyric origin. In one embodiment, the device mapper may also apply any required geometric warping, cropping, or scaling so that the lyric graphics align correctly with the physical placement of the display in the venue.

In one embodiment, the device mapper applies a profile that matches the characteristics of the target display. For example, for flat displays such as LED displays, the profile can ensure that lyric graphics are correctly placed on the two-dimensional pixel grid and adjusted for brightness and color consistency across panels. In another embodiment, for projector-based displays such as hologauze or scrim, the profile can account for the position and angle of the projector, apply geometric adjustments so that the image does not appear distorted, and compensate for the partial transparency of the material and the effect of ambient lighting. For a fan-type display, the profile can be configured so that the lyric graphics are timed to the fan's rotation and shaped to fit its circular format, with the mapper outputting the graphics in a way that aligns with the fan's persistence-of-vision scanning effect. By separating venue-space control from device-space mapping, the same control signals can drive different display types with only a change of profile.

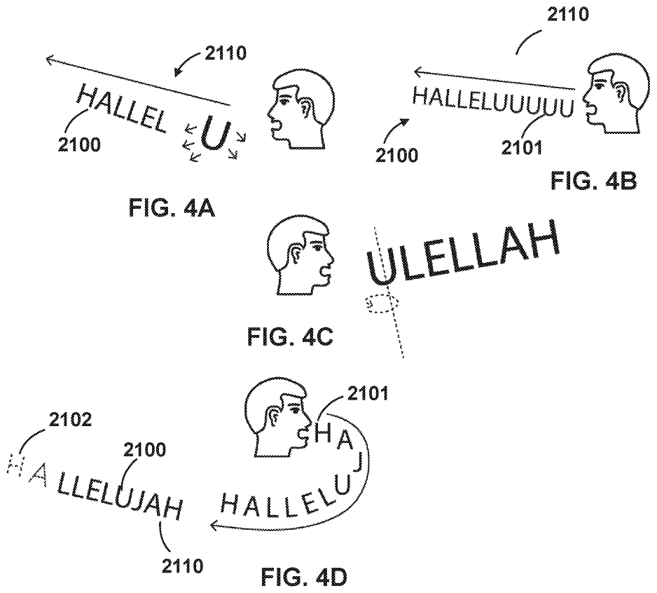

In some embodiments, the controller 1010 or computer system 1000 includes a path-generation software module that defines a word stream trajectory for the lyric graphics. In one embodiment, the subsystem creates a vector path beginning at the origin point determined by the device mapper and extending across the display surface or scene. In one implementation, and as will be described in more detail in connection with FIGS. 4A-4D, each word or glyph is positioned or re-oriented sequentially along a path so that the lyric string is oriented in a readable left-to-right order, applying a curvature to the path where needed so that the words originating to the viewer's right will bend or curve to the left (e.g., see FIG. 4D). In one embodiment, to preserve lyric viewing while accounting for stage presence of a performer, the trajectory can be constrained by a virtual boundary so that lyric elements do not cross in front of or behind the performer's body. For example, if the performer is centered downstage and the origin point lies to the right of the performer (as viewed from the audience), the path may be authored to curve upward and arch over the performer's head, keeping the lyrics visible to the audience while avoiding occlusion, and each successive word follows the curvature smoothly while maintaining correct left-to-right readability.

In some embodiments, the device mapper and path-generation software operate independently of the specific type of sensor used to generate orientation or position data. For example, whether the data originates from a wearable 2050 (such as smart glasses or a head-mounted tag), a stage camera system performing computer vision, or another tracking mechanism, the device mapper receives normalized coordinates or vectors from controller 1010 and maps them into the coordinate system of the output display. Thus, in one embodiment, by remaining agnostic to the sensing technique, the same device mapper software can support multiple input technologies without alteration. In one embodiment, a graphics engine running on a workstation equipped with a high-performance graphics processing unit (GPU) generates the lyric text in real time. The GPU allows the text to be scaled, rotated, and transformed smoothly so that it remains clear and properly aligned from different viewing angles and distances. The rendering software manages how the text is drawn on display, applying adjustments to spacing, weight, and style so that it maintains clarity on large projection surfaces or LED walls. The system may also apply simple visual effects, such as shadows or depth cues, to enhance the perception that the words are floating in space. The rendered output is transmitted through a media server to the projector or LED display hardware. The coordination between the graphics software, the GPU hardware, and the display system provides a visual effect in which the lyrics are integrated into the live performance so that they appear to “float” without interfering or overlapping with (in front of or behind) the performer's image on stage.

In one embodiment, the lyrics will originate at origination point 2101 based on a location of the performer, and take essentially the same path (e.g., upwards and to the right, as one example), irrespective of the direction the performer is facing. In a further simplified version, the lyrics will originate in essentially the same location, and take the same path, irrespective of the performer's location or facing direction.

For large-format audience displays, the system may use high-brightness projectors or modular LED panels depending on the performance environment.

In one embodiment (e.g., see FIG. 1), one or more laser or DLP projectors 2112 of sufficient brightness are used to project visible lyrics onto a holographic mesh (e.g., scrim or hologauze). In one embodiment, multiple projectors 2112 can be combined through edge-blending techniques to produce a seamless image across a wide surface. In some embodiments, projector brightness may range from 5,000 lumens to over 50,000 lumens, with some implementations using about 15,000 to 30,000 lumens. In embodiments using one or more projectors 2112 in combination with a mesh, scrim, or hologauze display, the projectors 2112 and display together constitute the display 2110.

In various embodiments, the projector(s) 2112 may be positioned at varying throw distances depending on the venue scale and gauze placement. For example, projector distances from the gauze may range from 3 meters to over 30 meters, and in some embodiments, distances of about 5 to 15 meters to ensure appropriate image size and brightness without distortion.

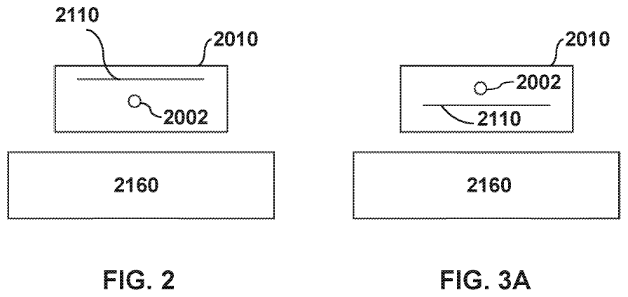

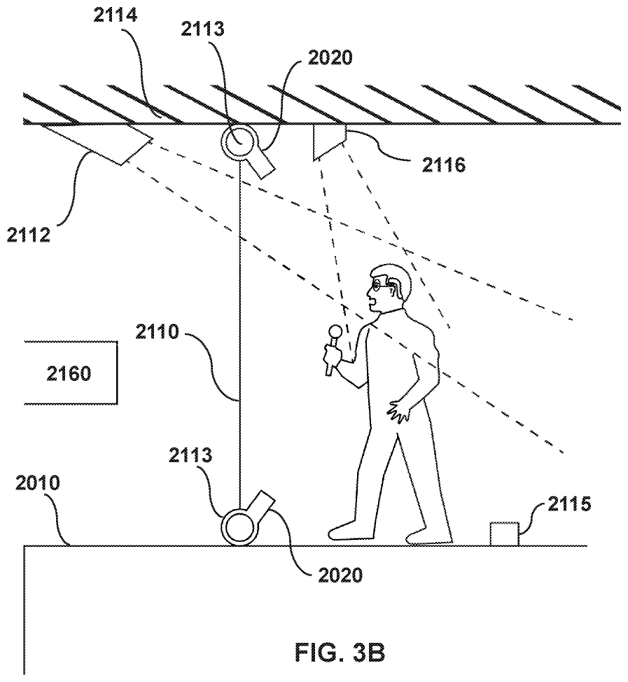

In one embodiment, as can be appreciated from FIGS. 2 and 3 a display 2110 in the form of a holographic mesh (hologauze) may be positioned relative to the performer so that projected lyrics appear to float in front of or behind the performer from the audience's perspective. The gauze surface may be placed at a broad range of distances from approximately 1 meter to 15 meters from the performer, with some implementations using distances of about 3 to 7 meters to balance visibility, projection clarity, and stage design flexibility.

For large gauze surfaces, multiple projectors may be used in combination to provide full coverage of the projection area. These projectors can be arranged with overlapping projection zones to eliminate visible seams and ensure continuous lyric display across the gauze. Overlap regions may comprise about 5% to 30% of each projector's output image, and in some embodiments, overlaps of 10% to 20% can be used for edge blending. The overlapping areas are processed by a blending system that corrects brightness and color, so that the transitions between projectors appear seamless.

In various embodiments, the physical mounting of the projectors may be overhead, front-facing, or rear-facing relative to the gauze, depending on stage layout. In one embodiment, projection-mapping software in the computer system 1000 compensates for projector placement and surface geometry, so that the lyric text maintains its intended shape and perspective. In some embodiments, recalibration routines may be performed periodically using markers or reference points on the gauze to correct for any shift in gauze position, ensuring that alignment between the performer's tracked orientation and the projected lyric text remains accurate.

In one embodiment, the system is designed to maintain low-latency performance from input capture to final display so that the lyrics appear in real time with the performer's voice. To achieve this, the camera feeds and sensor signals may be time-stamped with a common reference clock so that data from different subsystems remains synchronized. The processed tracking information is delivered to the rendering system through a compact telemetry stream that ensures data packets are transmitted in order and with accurate timing. In one embodiment, end-to-end system latency (from the time the performer sings/utters a sound, to the moment the synchronized lyrics appear on the display) may range from about 20 milliseconds to 600 milliseconds, depending on the hardware and venue configuration. In some implementations, latency is between about 50 to 150 milliseconds. In some embodiments, individual processing stages such as capture, vision analysis, fusion, and rendering may each operate on the order of 2 to 50 milliseconds.

With respect to a fixed, non-transparent display (e.g., such as and LED, OLED, LCD, etc.), in one embodiment, the perception of lyrics can be made to appear to be “floating” in space through perspective-correct rendering of the imagery onto the surface. For example, geometric distortion that resolves correctly for the intended audience region can be used. On the other hand, in another embodiment where lyrics are projected onto a semi-transparent medium such as hologauze or scrim, filaments of the material physically scatter the projected light in space so that the content appears suspended within the volume of the stage environment, producing a three-dimensional effect without relying solely on perspective warping

In one embodiment, the controller continues to derive a facing direction from performer tracking, but the renderer anchors the lyrics on the display surface so that they appear to emanate from the performer's head direction while staying stable from the audience's viewpoint. To maintain legibility at varying viewing distances, the system may dynamically adjust text size, weight, and/or stroke thickness based on venue geometry and expected audience viewing positions. In various embodiments, text height is scaled proportionally to viewing distance, such that text intended for closer viewing distances may be rendered at relatively smaller sizes, while text intended for long-range viewing may be rendered at substantially larger sizes. By way of example, text visible at distances on the order of tens of feet may be rendered at heights of a few inches to several inches (e.g., 2″ to 24″), while text intended for viewing at distances of hundreds of feet may be rendered at heights ranging from several feet to tens of feet, depending on display resolution, contrast, and environmental conditions.

In one embodiment, the distance between the performer and the display surface may range from 2 ft to 30 ft, and in another embodiment between 6 ft to 20 ft to maintain the impression that the lyrics are visually tied to the performer. The display may be flat or slightly segmented, and its structural rigidity helps ensure that the lyric text maintains proper alignment.

In various embodiments utilizing display 2110 in the form of an LED wall (e.g., with modular LED panels) the LEDs may have pixel pitch ranging from approximately 0.9 mm to 10 mm, depending on desired scale/resolution (e.g., which may be determined based on viewer distance). For example, for smaller venues where the audience is closer, finer pixel pitches in the range of about 1.5 mm to 3.9 mm may be used to preserve detail, while larger venues such as arenas or stadiums may use pitches of about 4 mm to 8 mm, which remain visually sharp when viewed from greater distances.

Based on the present disclosure, it will be appreciated that one implementation provides an apparatus for generating visual representations of live vocal expression (e.g., such as a song or speech). The apparatus includes at least one display and an audio input module configured to receive vocal expression from a live performer. The audio input module can include a microphone that is coupled with the computer system 1000 and its associated controller, hardware components and/or software as appropriate. The apparatus further includes a position detector for detecting the position of one or more features on the performer's face. The controller is operatively connected to the position detector, audio input module, and the display, and is configured to identify phonetic components of the vocal expression, map each phonetic component to a corresponding visual symbol (e.g., lyrics), and determine a placement and timing of the symbol onto the display based on the position of the performer (or a feature of the performer and the identification of one or more phonetic components.

In the embodiments herein involving a live performer, audio corresponding to the performer's vocal performance is in some embodiments initially captured by one or more wired or wireless microphone(s). In one or more embodiments, the microphone converts the acoustic signal into an electrical signal, which may then be routed to a mixing console, a wireless receiver, or other audio processing equipment. In other embodiments, the computer system may receive the performer's audio from a downstream point in the audio chain, such as from a mixing console output.

In some embodiments, the computer system 1000 may apply noise cancellation or filtering to the received audio signal before further analysis. Noise cancellation may be implemented (e.g., using adaptive algorithms, microphone arrays, subtraction techniques, etc.) to suppress ambient crowd or instrument noise or reverberation. Filtering may include high-pass, low-pass, band-pass, or notch filters to remove unwanted frequency content. By isolating the performer's vocal content from the surrounding audio environment, the system improves the accuracy of downstream processes such as lyric alignment, pitch detection, and phoneme segmentation. The noise-reduced signal may be provided directly to the lyric determination subsystem and may also be archived in memory for post-performance analysis or quality control.

In some embodiments, the computer system may perform pitch detection on the audio to determine the fundamental frequency of the performer's vocal signal (e.g., in real time). Pitch detection algorithms may be implemented using autocorrelation, Fourier analysis, or machine-learning-based estimators. The detected pitch values may be used to refine synchronization between displayed lyrics and the actual vocal delivery, for example by aligning lyric syllables to musical notes. Pitch data may also drive visual effects, such as animating lyrics to rise or fall with the melody, or scaling lyric size with vocal intensity for example.

In some embodiments, the computer system 1000 may perform phoneme detection on the received or filtered audio to segment the vocal performance into constituent speech sounds. Phoneme detection may be carried out using speech recognition models, deep neural networks, or other real-time processing techniques. The output of the phoneme detector may be mapped to corresponding lyric characters, syllables, or words in a stored lyric database. By aligning the displayed text with detected phonemes, the system can present lyrics in temporal alignment with the performer's articulation.

Phoneme detection may also be integrated with other subsystems. For example, when the system estimates the performer's mouth position using a camera or facial landmark detection, the phoneme segmentation data may be used to trigger animation of the lyrics so that they appear to emanate in time with the singer's mouth movements. This cross-integration between phoneme detection and performer tracking (e.g., via one or more sensors as discussed herein) provides an enhanced illusion that the displayed text is directly tied to and based on the physical location and orientation on stage.

It should be appreciated that the terms “near” or in the “vicinity” of the performer's mouth optionally includes arrangements where the lyrics are touching or superimposed on the performer's mouth or spaced from it. In one embodiment, if the performer has a microphone (e.g., that includes a detectable marker on it), the lyrics can optionally commence at or on the microphone, or spaced a predetermined distance from it.

It is contemplated that in the embodiment of FIG. 1, the performer 2002 may be positioned either in front of, behind, or in the same plane as the display 2110. For example, as can be appreciated from the schematic top view of FIG. 2, in one embodiment, display 2110 may be positioned behind the performer on stage 2010 (or within a room), in which case the display 2110 may optionally comprise a non-transparent (or opaque) physical display (such as any of an LED/OLED/LCD display, or may be an augmented display (e.g., transparent or semi-transparent display). For example, in various embodiments a non-transparent display may be an LED or LCD display (whether augmented with directional layer or not) or a solid surface (such as an opaque wall or display) that is projection mapped with a projector. In other embodiments, a transparent/semi-transparent display may comprise as a transparent OLED display, one or more holographic fan(s), and/or a projection mapped hologauze display, or scrim mesh. On the other hand, in an embodiment where the performer is behind the display 2110, as shown in the schematic top view of FIG. 3A, the display would not comprise an opaque or non-transparent display, but would rather be a transparent or semi-transparent or augmented display 2110, such as a transparent OLED display, holographic fan display, hologauze, or scrim mesh, such that the performer can be visible through it by the audience 2160.

In another embodiment, the performer can be positioned essentially in the same plane as the display. In one embodiment, if the intent is to keep the performer in a relatively fixed position relative to the display 2110, a stand-up microphone can serve as an anchor point for that purpose. For example, in one embodiment, a stationary (e.g., stand-up) microphone can be positioned at a location that is provided in the same plane as the display, such that the display surface containing the image presented to the audience is to the left of the performer, to the right of the performer, above the performer, or any combination thereof. In another embodiment, the stand-up microphone can be positioned behind or in front of the display 2110 and positioned at an optimized position to account for viewing parallax relative to the audience 2160. Specifically, for example, in one embodiment the lyrics are graphically rendered in the appropriate location on the display, appearing as though they are emerging from the speaker's mouth and drifting outward as would be viewed by the audience 2160. In one embodiment, the origin position 2101 of the lyrics would be optimized at a location that would be most appropriate when taking into account the location of the performer and the location/perspective of majority of the viewing audience 2160. In one embodiment, the system can continuously map the real-world coordinates of the speaker's head and project letters accordingly in display-space. In one embodiment, the audience is represented by a set of representative viewpoints derived from seat or standing-area locations, optionally weighted by occupancy or section prominence. For each animation frame, the system computes a display-space location on the display plane that minimizes perceptual error across those viewpoints, thereby compensating for parallax introduced by the depth between the performer and the display. In embodiments of a live environment setting (such as The Sphere in Las Vegas), as the singer faces the crowd in different directions, the display behind or in front of the live singer will project song lyrics in different directions, depending on the direction in which the singer is facing. For example, the lyrics can be presented on an LED display positioned behind the singer/speaker, or can be projected onto hologauze or scrim mesh positioned in front of the singer/speaker, as can be appreciated by FIGS. 2 and 3A/3B.

When the display surface is behind the performer (for example, an LED wall or a rear scrim), the system projects the mouth position (or surrogate for such position) into the plane of the rear display for a set of representative audience viewpoints and selects a placement that best aligns across that set. As the performer turns left or right, the placement shifts laterally so that, for the dominant audience region, the lyric origin 2101 remains visually co-located with the mouth. The glyphs may be perspectively corrected so that they remain upright and readable to the audience while still appearing to originate from the performer.

When the display surface 2110 is in front of the performer (for example, a scrim, hologauze, or mesh positioned downstage) as illustrated more specifically in FIG. 3B, the same optimization is performed against the plane of the front display. The controller selects a lyric origin point 2101 on the front surface that, for the weighted audience viewpoints, back-projects to the performer's mouth location, accounting for the performer-to-scrim depth and the performer's facing direction. In one embodiment, where the performer steps closer to or farther from the display surface, the computed origin is adjusted to preserve the illusion of emission from the mouth for the majority of viewers.

In the embodiment of FIG. 3B, the scrim or hologauze 2110 is mounted on or within a frame or mounting structure 2113. The mounting structure 2113 can be supported by or connected to a fixed structure in a facility, such as the stage surface 2010 and/or a ceiling structure 2114, as shown. The scrim or holographic mesh 2110 can be mounted to be pulled taught by the mounting structure or frame 2113. As also shown in FIG. 3B, the mounting structure 2113 can also serve to mount or carry the one or more sensor(s) 2020 for detecting the position/orientation of the performer's head, face and/or mouth. As further shown in FIG. 3B, the projector 2112 can be mounted at a position above the head of the performer, such attached or connected to the ceiling 2114. As shown, the projector projects the image (e.g. of the lyrics) downwardly at an angle (e.g., between 30-60 degrees, for example at approximately 45 degrees). In this manner, projector light that passes through the holes in the mesh, scrim or hologauze will be incident on the stage 2010 at a location “L” behind the performer that makes it largely invisible to the audience 2160. In one embodiment, if desired, the location L can be provided with a light absorbent material (such as a dark felt material) to make any light incident thereon even less visible. Further, if desired, a light block (any non-transparent structure) 2115 can be positioned on the stage 2010 to further hide from the audience 2160 any light that may be incident on the stage surface 2010. As further illustrated in FIG. 3B, in one embodiment, a light 2116 is mounted on a structure (e.g., ceiling 2114) and directed onto the performer. In one embodiment, the light 2116 is a spotlight, and in another embodiment it is a pinpoint light, that illuminates the face of the performer. As shown, the light 2116 is directed so that it is positioned behind the mesh/hologauze 2110 and illuminates only the performer to make the performer clearly visible to the audience behind the mesh/hologauze (while the mesh/hologauze remains largely invisible while clearly reflecting the images projected by the projector 2112). For facial tracking sensor(s) 2020 that benefit from the performer's face being illuminated for position/orientation purposes, the illumination from light 2116 can facilitate this.

In some embodiments, the system maintains temporal smoothness so that lyric placement moves continuously with the performer's head pose rather than jumping between solutions. If tracking confidence drops, the placement of lyrics can revert to a default zone near the performer's onstage position or microphone region and re-attaches when confidence improves. The foregoing applies whether the surface is an LED wall, a scrim, hologauze, or holographic mesh, and whether the surface is located upstage of, or downstage in front of, the performer. Thus, in some embodiments, the optimization selects a display-space origin that best satisfies the audience-weighted projection of the performer's mouth into the chosen display plane.

In one embodiment, as will be appreciated from FIGS. 4A-4D, visual words or lyrics are generated one letter at a time, with each letter being initially rendered or visible at the origination point 2101 and then moving away from the performer. After a word has been completed and travels away from the performer, the controller is configured to output the word such that it remains visible for a specified period of time before it disappears. In one embodiment, the word remains visible for a period of time until (or corresponding to) a full phrase, clause, stanza, chorus, lyric group, or entire song, poem, etc. is sung or uttered. In one embodiment, after the period of time has expired, the oldest letter, word, phrase, lyric group, or chorus, etc. will disappear. The disappearance can take place one letter or word at a time, or can be a group of words at time (of varying length). In one embodiment, earlier letters appear dimmed or faded, while recent ones appear bright and bold, indicating the temporal order of speech visually. The dimming, fading or disappearing can take place at a chosen rate, which may be dictated for example, by the tempo of the song (for faster songs, words may fade or disappear more quickly). In one embodiment, the disappearance of letters or words can appear as a dissipation (disintegration) of letters. In one embodiment, letters that are sung continue to enlarge slowly as they move further away from the singer's mouth as they fade, dim, or dissipate until they disappear. For example, the letters sung can continue to enlarge and continue to become more dim or more dissipated as they move away from the singer until they fade entirely and disappear. In another embodiment, the letters continue to get smaller until they disappear. In one embodiment, the words and letters remain visible for a limited period of time after they are completed and/or after they are sung/spoken (e.g., between 2-10 seconds—this time can be highly dependent upon the particular song). In one embodiment the words or letters sequentially disappear simply by moving or scrolling sequentially off the edge of the display. In one embodiment, whole words disappear at a time, while in another embodiment, one letter at a time disappears (with the oldest word or letter that is displayed disappearing), as can be appreciated from the disappearing or dissolving letter “H” 2102 in FIG. 4D.

In various embodiments, the directionality and orientation of letters and words are addressed, whether for a live singer or a pre-recorded video of a singer singing a song. Specifically, in such embodiment, the visual lyrics generated on the display will move in the direction the mouth would be perceived as projecting the sound. For example, in one embodiment in which a speaker or singer (generically referred to as “performer”) generally facing the viewer (whether live in-person, live-streaming, or pre-recorded) has their head directed to their right (i.e., viewer's left), the lyrics would be projected to the viewer's left, as can be appreciated from FIGS. 1, 4A and 4B. In one embodiment, as the speaker vocalizes/sings a word (e.g., “Hallelujah”), the sound of the first letter “H” is sounded and appears directly at or next to the performer's mouth (e.g., slightly offset from the mouth) at the origin point 2101. The letter “A” is then enunciated and appears between the performer and the previously projected “H”, slightly closer to the mouth. Each subsequent letter continues this sequence: originating nearest the mouth, pushing the earlier letters farther along a path, as can be appreciated from FIGS. 4A and 4B. As a result, from the viewer's perspective, standing opposite the speaker, the letters stretch from left to right across space. This aligns with English reading conventions (left-to-right), allowing the viewer to read the word in correct order.

In another embodiment, were the performer (whether live in-person, broadcast, streaming, pre-recorded, etc.) turns their head to their left (i.e., viewer's right), as shown in FIGS. 4C and 4D, as the performer enunciates a word, such as “Hallelujah,” the first letter “H” initially appears immediately beside the performer's mouth, to the performer's left (viewer's right). As the performer continues, the “H” moves toward the singing direction (the viewer's right), while subsequent letters (e.g., “A,” “L,” “L,” “E,” etc.) sequentially appear closest to the mouth, pushing the earlier letters farther out along the directional path instructed by the direction of the speaker's mouth (e.g., toward the viewer's right in the case of FIGS. 4C and 4D). Thus, in this embodiment, the resulting word is incrementally grown spatially towards the viewer's right.

Because English is read left-to-right, as can be appreciated from FIG. 4C, for a completed word, the viewer will see the last letter (“H”) first and the first letter (“H”) last—making the word appear to be spelled backwards. Thus, the word Hallelujah, will appear as HAJULELLAH (and optionally the letters each individually be shown backwards (a mirror image of itself). In this embodiment, while the spatial logic is consistent (earlier letters further away), the reading direction is inverted, which may make comprehension less intuitive for some individuals.

In one embodiment, to address the directional reversal issue described above, the letters will build towards left, irrespective of the direction the singer/speaker (either live or on a display) is facing. In one embodiment, for example, instead of following the direction of the speaker's mouth, the positioning of the lyrics is independent from the mouth position.

In various embodiment, the movement of lyrics can be directly left (e. g, horizontally), a diagonal upward-left projection, a diagonal downward-left, etc., regardless of the speaker's head orientation. For example, in one embodiment, prior letters are displaced upward and to the performer's right (i.e., viewer's left), whether live or pre-recorded, forming a diagonal trail that moves away from the singer, up and to the left. In one embodiment, a group of lyrics accumulate to the right of the performer (viewer's left), either on a separate display from the display on which the performer appears, or on a region of the same display on which the performer appears.

In one embodiment where the letters are projected upward and to the left, the first letter of the word ends up farthest away to the performer's right, and may also be highest, while the most recently generated letter remains nearest to the mouth and lowest in the diagonal arc.

From the viewer's perspective, as the words and letters move to the left, they also form a left-to-right word path, readable in correct order. In one embodiment, irrespective of whether the performer turns their head left or right, the letter trail always travels leftward from the speaker's mouth, even if the performer in the middle of a phrase or word changes head direction between left and right.

In one embodiment, as shown in FIG. 4D, where the performer is facing to their left (viewer's right), the word formation will initially project in the direction that the performer is facing so that they appears to be projected from the performer (to the performer's left, and viewer's right). As the word continues its formation it will then swirl or twist so that it changes directions so that the word can be read properly from left to right. For example, in one embodiment, as shown in FIG. 4D, if the performer is singing Hallelujah, the first couple, few or several letters (just for example, three letters, as one example, but less or more letters are also contemplated) may appear backwards as the word is formed, such that they appear to the build from left to the right as seen by the viewer as: L A H. In this example, after the first three letters are formed, the first letter “H” begins to move vertically (up or down) such as in a curved path so that the movement of the letters shift so that they no longer move from left to right, but instead move from right to left (as perceived by the viewer). FIG. 4D shows the trailing portion of the word being formed as “H A J” when read left to right, while the first seven letters are displayed in correct left to right reading order as H A L L E L U. Arrows in the figures generally show one option for directionality and movement of letters. For a live performer, depending on the stage set up, when the letters will follow such curved path so that the letters appear in the correct spelling order (read left to right). In one embodiment, the path that the letters will follow is upwards and to the viewer's left, as the display would likely not extend below the performer's feet (or mouth).

In one embodiment, if the singer is directly facing the viewing, the letters can first project direction upwards or downward, and then move to the singer's right (viewer's left).

In one embodiment, the system accommodates changing orientation of the singer's/speaker's mouth. For example, if a singer commences a song facing right (viewer's left), the letters start to push towards the left (in any manner describe above). If then the singer quickly turns to the left (viewer's right), then the letters follow the singer's mouth and start to push towards the viewer's right. Depending on the desired effect, the words initially projected to the viewer's right can then optionally change direction as described above and then start move to the viewer's left.

In addition to the basic spatial projection of letters corresponding to spoken words, in one embodiment the letters encode temporal and expressive features of speech, such as emphasis, volume, duration (elongation), and pitch—particularly applicable in singing or emotive speech. In various embodiments, as the performer sings/says a word, each letter appears to generate directly next to and/or in close proximity to the performer's mouth in synchronization with the audible sound of the word and corresponding visual mouth movement, within acceptable temporal tolerances

In one embodiment, to maintain synchronization between the visual lyrics and the audio signal, information is processed in real time to extract sounds, phonemes and timing information, which can be particularly useful in live performances.

In these embodiments, the system can interpret not only the phonetic content of the speech (i.e., the sequence of letters), but also its prosodic features—including length of time a sound is held, volume, and/or intonation. These features are then visually represented through various methods as described below.

For example, in one embodiment, as can be appreciated from FIG. 4B, the same letter can be generated or rendered multiple times from the speaker's mouth when a particular phoneme, letter or syllable is elongated in time. Each repetition appears as a new visual instance of the same letter, forming a string that represents the extended vocalization. As with the earlier embodiments, each letter appears near the speaker's mouth when first spoken and is pushed farther away as time progresses (to the left and/or to the right as described above in various embodiments). For example, in the singing of the word “Hallelujah,” the sound of letters “luuuuu” are often held by performers over multiple beats. In one embodiment, the system detects this elongation with sound recognitions sensors when sounds are generated in real time such as by a live singer (and optionally coupled with AI models that recognize the song and can anticipate the lyrics and in particular such elongation), or is pre-recorded and pre-programmed with this elongation taken into account) and may emit in one example the letters: H A L L E L U U U U U U U J A H (or H A J U U U U U U U U U L E L L A H), as will be understood from the above disclosure. In one embodiment, the extended “U” sound is visualized through multiple instances of the letter “U”, appearing sequentially, stretching along the path of the projection. In one embodiment, the instances of the letter “U” will continue to repeat (e.g., at a rate that is consistent with or proportional to the song tempo) until the corresponding sound has concluded from the singer (whether live or pre-recorded). In one embodiment, when the elongated sound has concluded, the multiple instances of the letter may collapse into the correct spelling of the word (for example, “halleluuuujah” collapse into “hallelujah” by sequentially removing the one additional “u” at a time. The formation of the words may occur horizontally, vertically, or diagonally, depending on the base projection orientation (as described in previous embodiments).

It should be appreciated that for other languages where the reading direction changes, such as Japanese or Chinese which may be read vertically, the direction of characters may differ (e.g., project generally downwards or upwards after leaving the vicinity of the performer's month), or simply project in whatever direction the performer is facing (not swerve or shift based on the direction the performer is facing). Nevertheless, the characters (e.g., Kanji, Hiragana, Hanzi) can be generated in real time, and made to appear as they are emanating from the performer.

In live implementation embodiments herein, voice or phoneme recognition software may optionally be used to recognize and generate the words in real time. For example, in one embodiment, the system relies on real-time voice or phoneme recognition to generate lyric text. In this configuration, the controller 1010 receives the live microphone signal and applies speech-to-text or phoneme-to-grapheme algorithms to transcribe the words as they are sung or spoken. The recognized words are then rendered immediately as lyric graphics on the display. This embodiment enables fully unscripted performances or improvisational shows where the lyrics are unknown in advance. In some embodiments, the recognition system may provide confidence scores for the detected words, and the controller 1010 may use these scores to determine whether to display the recognized text, hold output until greater certainty is achieved, or substitute placeholder characters (e.g., ellipses) until recognition stabilizes.

In one embodiment, word recognition and synchronization may be enhanced by applying song, recognition, machine learning or AI-based alignment techniques. For example, in one embodiment, lyric recognition accuracy may be assisted by software that identifies the underlying musical work at the start of a performance. For example, the controller 1010 may analyze the introductory audio and apply music recognition techniques (comparable to commercially available services such as SoundHound or Shazam) to detect and match the live performance against a reference library of songs. Once the track is identified, as can be appreciated from FIGS. 12-15, the system can retrieve the corresponding lyric file or timestamp data 1220 from memory 1150 or from a network source. This enables the controller 1010 to anticipate the words that will be sung, improving synchronization, latency, and accuracy even when the lyrics do not begin immediately at the start of the song.

In another embodiment, the system may operate with a predefined setlist of songs provided in advance of the performance. In this configuration, the controller 1010 can preload the lyric content and associated timing maps for each scheduled song. As a result, once the song is selected or cued, the controller 1010 can use the known upcoming lyrics to supplement the results of live phoneme recognition, ensuring that recognized sounds are mapped against an expected vocabulary of words for the current song. This hybrid approach allows real-time recognition to remain adaptive to live variations while being guided by advanced knowledge of the intended lyrics, thereby increasing the robustness of lyric display in live environments.

In some embodiments, the controller 1010 analyzes the incoming live audio performance in real time and compares it to a reference track or pre-recorded audio content 1062. Algorithms such as dynamic time warping or phoneme alignment may be used to adjust lyric presentation dynamically, allowing the visual lyrics to remain aligned with the live vocals or instrumentals even when the performer varies tempo or timing. This alignment can supplement the timestamp data 1220, providing robustness when live performers deviate from a pre-set timing map. In certain embodiments, the controller is further configured to modify the rendering of lyric text based on vocalization characteristics, such that elongation of a sound or syllable during singing causes the corresponding letters to be proportionally prolonged, repeated, or animated on the display. Where the words being sung are previously known, the system may therefore detect only the duration of such elongations from the live audio, without requiring full re-recognition of the lyric content.

In any live performance embodiments, synchronization between the lyric graphics and the musical performance may optionally be achieved by integration with external timing sources, such as digital audio workstations (DAWs) or other master clock devices. For example, controller 1010 may be configured to receive MIDI Timecode (MTC) signals generated by DAW sequencing software, with the MTC providing a continuous reference clock that the system uses to trigger lyric display events in alignment with other aspects of the performance (lighting, video, stage automation etc). In one embodiment, the MTC signal provides a continuous, frame-level timing or sub-second resolution, which is read by timestamp module 1270 and used to trigger lyric events stored in memory 1150.

In embodiments incorporating song recognition and alignment, the system may additionally include an audio fingerprinting module configured to generate compact spectral hashes (e.g., based on constellation maps or chroma features) from the incoming audio. These fingerprints may be matched against a locally cached or remotely hosted database using approximate nearest neighbor (ANN) search techniques. Upon identification of the musical work, the controller 1010 may retrieve structured lyric timing data (e.g., word-or phoneme-level timestamps) and initialize a forced-alignment or dynamic time warping (DTW) process to synchronize the live audio stream with the reference track. Machine learning-based alignment models (e.g., hidden Markov models (HMMs) combined with neural acoustic models, or end-to-end alignment transformers) may be used to continuously correct for tempo variation, performer deviation, or background noise. In some configurations, the system may fuse outputs from both the predictive lyric track and the real-time ASR engine using confidence-weighted arbitration logic, thereby improving robustness in cases of improvisation, lyrical deviation, or partial recognition failure while maintaining tight synchronization between audio and displayed text.

In one embodiment, a separate display visible to the performer singing the lyrics is provided to give the singer an advanced view of the upcoming lyrics, functioning as a teleprompter-like preview similar to what a karaoke singer would see. In one embodiment, the computer system provides such lyrics on the separate display in advance of the corresponding musical cues and in advance of the lyrics being presented to the audience on the first display (in sync with the musical cues and originating and having a trajectory away from the singer based on the position and orientation determined by the one or more sensors). In one embodiment, the separate display (e.g., a small monitor or television display) is a visible only to the singer/performer and not the audience. In one embodiment, controller 1010 may be configured with the aforementioned MTC reference clock so that the system triggers the advanced lyric display presented to the performer, as well as the lyric display presented to the audience.

In one embodiment, the separate display providing the advanced visual lyrics to the live performer takes the form of a pair of smart glasses 2050. The advance preview may be provided on the smart glasses in scrolling form, in highlighted segments, or by presenting full lines of lyrics before the corresponding sounds occur in the music, and in advance of the orientation and direction controlled lyrics being displayed to the audience. In one embodiment, the smart glasses include a local display, such as one or more transparent or semi-transparent optical waveguides, micro-projectors, or micro-OLED panels coupled to lenses, thereby enabling the wearer to view the advanced lyrics while simultaneously maintaining a clear view of the surrounding environment.

In some embodiments, the smart glasses wearable 2050 also serve as the wearable having the directional sensor/transmitter for the system. Thus, in some embodiments, the smart glasses fulfill a dual function of (i) presenting advance visual cues to the performer, and (ii) providing real-time directional data so that the lyric graphics appear to emanate directionally from the performer's orientation on stage.

In one embodiment, the system operates in a game mode in which a performer's vocal delivery is analyzed and scored in real time. Controller 1010 receives a live audio signal from microphone 2120 and, optionally, accesses reference lyric and timing information stored in memory 1150. The system compares the performer's spoken or sung words against expected phoneme and word boundaries, with the primary scoring emphasis placed on whether the correct words are delivered and whether they occur within acceptable timing tolerances.

To achieve this, the controller 1010 processes the live audio signal to detect phoneme boundaries, word starts and ends, and relative syllable timing. The detected events are compared to expected windows stored in timestamp data 1220 or derived from reference audio content 1062. A high score is awarded when the performer's phonemes align with expected cue times and the correct words are articulated in sequence. Penalties may be applied for omissions, substitutions, or words delivered outside the tolerance window. This embodiment is particularly suited for songs with rapid or rhythmically dense lyrics, such as rap or spoken-word pieces, where rhythmic precision and diction are more challenging and more critical than melodic accuracy.

Although phoneme timing and word correctness are the primary basis for scoring, in some embodiments secondary factors may also be considered. These may include pitch accuracy relative to a target melody, sustain duration, or tonal stability, allowing the system to support both melodic and rhythm-driven performance styles. In some embodiments, performers may enable or disable pitch-related scoring to suit the genre of the performance.

In some embodiments, the controller 1010 can apply configurable weighting to the different metrics, with phoneme timing and word correctness given priority. Low-confidence recognition events (e.g., where phoneme detection is ambiguous due to noise) may be down-weighted or ignored. In one embodiment, scores may be normalized over sections of the song (e.g., verses or choruses) and aggregated into a composite score, which may be stored in memory 1150 for leaderboard or session history purposes.

In another embodiment, visual feedback may be presented on any of the displays (e.g., display 2200, augmented display 1030) in real time. Feedback can include indicators of timing accuracy, word correctness, early/late markers, or section scores. In some embodiments, performers may be challenged by not providing advanced lyric cues, requiring them to rely on memory alone, while in other embodiments, smart glasses or similar devices can present lyrics in advance to assist the performer.

In some embodiments, the reference material for scoring does not require a recorded audio track. Instead, the system may use a lyric file that includes expected timing for each word or phoneme. For example, in one embodiment the controller 1010 detects when the performer speaks or sings each phoneme and compares the detected timing to the expected timing in the file. The performer is awarded points when the correct phoneme or word is delivered within an allowed timing window, and points are deducted when the word is omitted, substituted, or delivered outside of the tolerance. Specifically, in one embodiment, the lyric content used as the reference is symbolic or text-based, such as a lyric file with phoneme-level timestamps. The system can align live phoneme detections of the singers performance to this symbolic representation, eliminating the need for an audio track serving as the basis for measurement. This allows the system to score performances directly against a text-based lyric timeline. In other embodiments, the reference is derived by pre-processing a recording to extract lyric timing and cue windows, which are then cached in memory 1150.

Robustness measures may include noise suppression and automatic gain control on live audio signal, as well as fallback scoring behavior when confidence in recognition is low (e.g., freezing the score, applying average section values, or prompting recalibration).

In a further embodiment, the system emphasizes visual interaction between scoring and lyric graphics presented to the audience. When the performer sustains accurate phoneme timing and word correctness over a predetermined interval, the corresponding lyric graphics on display 2200 or augmented display 1030 may be dynamically modified. For example, the lyric text may enlarge, change color, glow, or animate with starbursts or particle trails to signal achievement of sustained accuracy. These visual emphasis effects are triggered by real-time scoring levels achieved, providing immediate audience feedback tied directly to the performer's live vocal precision.

The emphasis effects may be implemented through pre-authored visual templates (e.g., scale, highlight, particle animations) that are dynamically applied at runtime to whichever lyric element is associated with the performer's sustained accuracy. In this way, the lyrics themselves become an expressive scoring feedback mechanism visible to the audience.

In several of the above embodiments, the letter being sung continues to move away from the singer's mouth (whether a live singer or a pre-recorded video of a singer) as its sound is sustained. In other embodiments, the extended letter remains stationary or moves very slowly while the letter is otherwise emphasized. Specifically, for example, in one embodiment, instead of repeating the same letter multiple times, a single instance of the letter grows in size to reflect the extended duration or increased volume of the sound, as illustrated in FIG. 4A. For example, as the speaker or singer continues to sustain a vowel or consonant, the corresponding letter appears near the mouth as usual, but instead of being pushed away or replicated, it visually expands, increasing in size proportionally to the duration of vocalization. When the next sound begins, the letter's growth stops, and the subsequent letter appears near the mouth, continuing the stream. Thus, in the prior example, the “U” in “Hallelujah” can appear larger than the other letters. In one embodiment, the enlarged letter may return to the same size as other letter after it is pushed away in favor of the next letter (“J”), or may remain enlarged. In another embodiment, as the volume of a lyric (or portion of a lyric, such as one or more letters) becomes higher, or alternatively as the length of time the corresponding lyric (or portion thereof) is sounded increases, the size of the lyric will grow larger. In one embodiment, the size of the lyric grows proportionally with volume.

In another embodiment, rather than (or in addition to) enlarging, the letter “U” may pulse, blink, or glow until the next letter is generated.

In yet another embodiment, rotational motion of individual letters is used as a means of visually representing elongated phonetic duration (or increased volume). Rather than (or in addition to) growing in size, repeating, glowing, etc. a letter that corresponds to a sustained vocalization undergoes a spinning or revolving animation to convey the passage of time and musical or emotional emphasis, as can be appreciated from FIG. 4C. For example, the letter (e.g., letter “U”) may rotate about its own vertical axis for the duration of the sound being sung. As before, as the speaker or singer sustains a particular sound, the corresponding letter is projected near the mouth. While the sound continues, the letter remains in position (or moves away slowly), maintaining proximity to the mouth or at the leading edge of the speech trail. It begins to rotate on its axis, typically around its vertical centerline or along the z-axis (facing the viewer). The speed of rotation may be constant or may increase and/or decrease gradually depending on volume, emotional peaks, or vibrato. When the performer transitions to the next sound, the spinning letter stops rotating. The next letter is projected from the speaker's mouth as a new character, continuing the spatial sequence.

In one embodiment, the duration of the formation of a particular lyric or word will be essentially the same in terms of the length of time for the audio sound formation thereof (e.g., emanating from the speaker) and the visual formation thereof formed on a display. In one embodiment, the duration of each will be the same within +/−of 0.1 seconds, and in another embodiment, within +/−0.01 seconds.

As can be appreciated from the disclosures herein, while in some embodiments the timing of lyric display is generated in real-time, in other embodiments visual display is not dependent on real-time analysis of the audio performance or on external master clock signals. Instead, the visual lyrics will be output to the display irrespective of whether the live performer is outputting any sound (or even moving their mouth). For example, in one embodiment, the system may utilize pre-timed lyric subtitle tracks that are associated with or contained in a data file. In one embodiment, word lyrics or subtitle data may be stored as a json file and/or in formats including LRC, CD+G, MP4 overlays, and/or DVD subchannel metadata. In one embodiment the lyric data file provides a predefined sequence of lyric cues that the controller 1010 reads and outputs in synchrony with the corresponding audio track. In some embodiments, lyric presentation can be done without live audio alignment or external timecode. In one embodiment, a live performer may sing the vocal lyrics in synchrony with audio performance of a song, which may comprise a pre-recorded instrumental track or file, with or without background or guide vocals. Specifically, in one embodiment, the computer system 1000 generates visual lyric content output to a display and audio output to an audio output device (e.g., loud speaker) so that lyrics are displayed (e.g., one letter at a time as previously discussed) as visual content in synchronization with the playback of the corresponding audio track on the audio output device. In one embodiment, only visual lyrics are generated and displayed (e.g., as a video or other visually perceptible output) on one or more displays (which can be a conventional display such as an LED display, or an augmented display such as a scrim, hologauze, mesh, holographic fan or transparent OLED panel). In such embodiment, it will be appreciated that visual lyric positioning and direction on the display will take place based on the previously described sensors/detectors that detect position and orientation of the performer's head (as previously described) even if the on-stage participant is silent (not singing the lyrics with the audio/music) because the audio and lyric visuals are pre-recorded. In addition, because in this embodiment the visual lyrics are pre-rendered (not determined based on input from the performer) and fixed/synchronized with respect to the audio, the lyrics will appear correctly as intended on the display in sync with the audio even if the performer sings incorrect lyrics or doesn't sing at all.

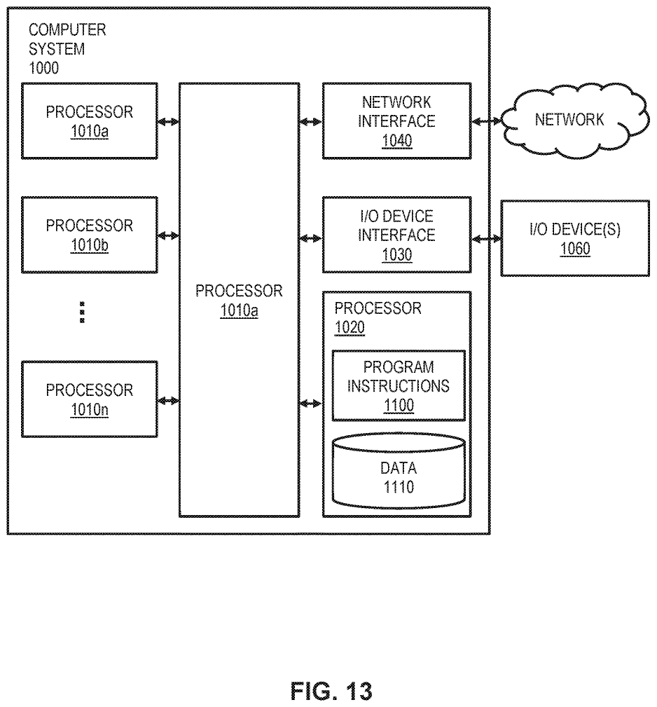

In various embodiments, as can be appreciated from FIGS. 13-15, the audio track or file of the music may be stored in memory 1150 as audio content 1062 or as part of a media file 1200 (e.g., a video file), for example. In some embodiments, the audio file optionally includes background vocals or guide vocals, similar to a karaoke mix. In another embodiment, full volume vocals are provided. However, unlike karaoke systems that reveal pre-timed subtitles (typically entire lines or words shown in advance of the sound), the present system is configured so that lyric graphics on the display appear synchronized at their audio playback times (within reasonable tolerances), either at the phoneme, syllable, word, or beat level, and not before (except perhaps as an auxiliary or additional feature to provide an advance rendering of the lyrics to benefit the performer's knowledge or memory of the lyrics prior to singing them). In one embodiment, the timing/synchronization of lyric display and audio playback can be the same as various other embodiments described throughout this disclosure.

In some embodiments, the controller 1010 uses the lyric timing information to align the display of lyric graphics with playback of the audio, regardless of whether the audio file was newly authored or drawn from an existing recording. In either case, temporal alignment of visual lyrics with the audio track can be achieved such that each lyric element is revealed only as its corresponding sound is generated.

In one embodiment, visual lyric timing information is added to an existing audio recording without modifying the underlying sound file. In this case, the lyric timing data may be (i) embedded directly within the audio file container (e.g., as metadata tracks), (ii) stored in a separate file that is linked to the audio track at playback, or (iii) generated as part of a separate lyric video that is synchronized with the pre-recorded audio.

In another embodiment, lyric timing information is created during original authoring of an audio file, such that timestamps or cue markers are generated at the same time as the audio content and stored together as part of a unified media asset. For example, in one embodiment, a timing map (timestamp data 1220) is pre-computed during audio file authoring and stored in memory 1150. The map specifies the cue times at which each visual lyric element should appear relative to the pre-recorded audio. In one embodiment, at runtime, controller 1010, via timestamp module 1270, reads the timing map and either plays back pre-rendered lyric video or renders vector/text lyric elements using a graphics subsystem, triggering each element at its scheduled cues for output to any one of the displays disclosed herein.

In one embodiment, as described previously, the visual lyrics maybe privately presented to the performer through smart glasses 2050. The lyrics presented the performer may be pre-stored in memory 1150 as part of a lyric video 1420 or as a synchronized lyric file associated with the pre-recorded audio track. In one embodiment, the controller 1010 accesses this stored lyric content and routes it to the local display of the glasses, where it is presented to the performer in advance of its scheduled playback time. In one embodiment, the same underlying lyric content may be used by the system to generate audience-facing lyrics and the private lyrics presented to the performer, with a timing offset applied to allow the performer to view the lyrics earlier than the audience.

In various embodiments, the offset of the timing of the lyrics presented to the performer vs. the audience may be achieved in several ways as will be described in non-limiting examples. In one example, two files are created separately during authoring, with the performer's visual file advanced by the desired lead interval relative to the music track. In another implementation, a single master lyric file is created and the controller 1010 applies a timing offset at playback so that the performer's received lyrics is advanced relative to the audience's received and position-controlled lyrics, effectively creating two synchronized but shifted render streams. In yet another implementation, the same media file is used (both optionally including a music track-which can be unused-if desired), but two playback instances are run in parallel by the controller, one with an applied lead offset for the performer in comparison with the playback for the audience.

In one embodiment, the visual lyrics provided to the performer on the display (whether smart glasses or other display) in advance of the lyrics presented to the audience, can be identical to the lyrics presented to the audience. More specifically, if lyrics presented to the audience are spelled in a unique way (e.g., enlarged, or with repeat and/or spinning letters) to emphasis volume and/or elongation of sounds, phonemes, or letters, such presentation can be provided to the performer's display in that manner as well. In another embodiment, however, the working can be presented without such emphasis and can be plain text, correct spelling, not spinning or enlargement, etc.).

In another embodiment, the system does not project lyrics but instead is adapted so that the live performer interacts with virtual objects or virtual performers rendered on the display surface 2110 (e.g., hologauze, mesh, holographic fan, LED wall, etc.). Because in some embodiments the performer is already tracked through sensors as previously described, the controller can determine the performer's position and orientation in real time. This positional information can then be used to generate, place, and animate interactive visual elements on the display surface that respond to the live performer's movements and actions.

In one embodiment, the display may present a virtual performer (such as a Holographic Human, defined below) rendered on the display such that it appears to share the stage with the live performer. The virtual performer may be programmed to react to the live performer's movements, for example by following, mimicking, or counteracting their gestures. In another embodiment, the virtual performer may be programmed to perform musically with the live performer. For example, the virtual performer may sing a song in synchronization with the live performer, with its lip movements generated in real time or pre-recorded to match either pre-scripted lyrics or dynamically recognized live audio.

As used herein, the term “Holographic Human” (also referred to as “digital human,” “avatar,” “volumetric character,” or “digital surrogate performer”) means a representation of a human or human-like figure that has been digitally synthesized, isolated, composited, rigged, retargeted, or otherwise transformed beyond neutral playback of unmodified footage, for visual presentation in two-dimensional or three-dimensional form. Examples include computer-generated characters; foreground-extracted live-action subjects with the background removed (e.g., by keying, rotoscoping, depth, or segmentation); chroma-keyed live-action subjects composited into a different background or scene; performance-capture-driven or retargeted surrogates; AI-synthesized or identity-modified likenesses; stylized or non-photoreal renderings; and/or hybrid embodiments combining captured and synthetic elements. A Holographic Human may be animated in real time or pre-rendered, may be synchronized with audio or other control signals, and/or may be displayed or projected on conventional or non-traditional media and devices, including augmented displays. Unmodified captured imagery—including footage that has merely undergone editorial or cosmetic adjustments (e.g., cropping, trimming, scaling, color/exposure/white-balance changes, gamma/gain, denoising, sharpening, etc.) does not constitute a Holographic Human as used herein.

In one embodiment, to achieve synchronized audio performance, the system may use multiple audio processing techniques. In one embodiment, the live performer's vocal audio is captured through a microphone and analyzed in real time by the audio subsystem. The analysis may, in various embodiments, include pitch detection, phoneme recognition, and timing alignment to the known lyrics or melody. The audio data is processed to generate cues for the virtual performer's animation and vocal output. For example, the system may use pitch and timing information from the live performer to drive the virtual performer's singing, ensuring that the virtual performer's voice blends musically and temporally with the live performer's voice.

In one embodiment, the virtual performer's voice may be pre-recorded and stored in synchronization with a musical score. The system then aligns the playback of this pre-recorded vocal track with the live performer's position in the song, so that the two voices are synchronized. The alignment may be maintained within a latency range of about 20 to 200 milliseconds, and in some embodiments within 50 to 150 milliseconds, so that the interaction appears natural to the audience.

In another embodiment, the virtual performer's voice may be generated or modified in real time using AI-based voice synthesis. In this implementation, the system uses the live performer's audio input to trigger or condition a generative model that outputs the virtual performer's voice in synchronization with the live performance. This may include generating harmonies, alternating vocal lines, or performing call-and-response singing. The synchronization is maintained through the use of real-time audio alignment algorithms that map the live performer's timing to the virtual performer's vocal output, ensuring that the two remain musically coherent.

In one embodiment, the system is configured so that the virtual performer can be positioned to face the live performer based on the performer's tracked location, giving the impression of a two-way interaction. The virtual performer may be depicted holding its own microphone, or alternatively may be rendered as if singing directly into the live performer's microphone. In another embodiment, the virtual performer may be animated to appear as if exchanging spoken dialogue with the live performer. In this case, the system may include natural language processing components to generate responses for the virtual performer, based either on scripted dialogue or AI-driven conversational models.

The audio subsystem for this embodiment may include multiple channels of live and virtual sound. In one embodiment, the live performer's microphone feed is routed both to the venue's sound system and to the controller for analysis. The virtual performer's audio output, whether pre-recorded, synthesized, or hybrid, is routed through the media server or a dedicated audio engine and mixed into the venue sound system so that the two voices are heard together by the audience. Spatialization techniques, such as panning or localized speaker arrays, may be applied so that the virtual performer's voice appears to originate from the same location on stage as the projected image.

In one embodiment, the system comprises hardware and software components configured to generate and display synchronized textual representations of spoken or sung content for which the text is known in advance. In contrast to conventional automatic speech recognition systems that infer text from audio input in real time, one or more embodiments may use preloaded textual data together with live audio analysis to align, anticipate, and display words in temporal correspondence with the vocalization by the performer.

In one embodiment, the hardware includes an audio capture subsystem comprising one or more microphones, which may be unidirectional or omnidirectional, capable of capturing live speech or singing. In one embodiment, the microphones are connected to a signal conditioning stage and an analog-to-digital conversion stage suitable for capturing high-quality audio. The processing subsystem may include one or more general-purpose processors forming part of the computer system 1000 and may optionally incorporate graphics processors or other specialized hardware to accelerate tasks such as real-time tracking, alignment, and rendering (see FIGS. 12, 13, 14, 15). In one embodiment, the system includes sufficient memory and storage to handle continuous audio and video data streams, store scripts and timing templates, and run the necessary software modules.

In one embodiment, the software contains a script preprocessing module that accepts a predefined text file containing the script, lyrics, or dialogue. In one embodiment, the module processes the text by dividing it into units such as words, subwords, and/or phonemes, and generates corresponding phonetic representations using an appropriate text-to-sound conversion process. In one embodiment, the system may also utilize preexisting timing or alignment information from compatible file formats when available. In one embodiment, an acoustic analysis module processes the incoming audio stream from the capture subsystem, applying signal analysis techniques to extract features useful for aligning the live audio with the prepared text data. Voice activity detection may identify speech segments and excludes background noise.

In one embodiment, a forced alignment engine aligns the known phoneme sequence from the script with phonemes detected in the live audio using suitable alignment techniques. In one embodiment, latency compensation can be applied so that the text is displayed in synchronization (e.g., within 1 to 150 milliseconds) relative to the corresponding sung or spoken words. In one implementation, the lyrics appear on the display exactly as they are performed, without showing them in advance or using progressive highlighting. In alternative configurations, the system may optionally present upcoming words or apply visual emphasis effects for stylistic purposes or accessibility needs.

From the above and below embodiments, it should be appreciated that in one or more embodiments, the computer system outputs the lyrics to the display visually in temporal alignment with the vocal performance, and in one embodiment the lyrics are presented with spatial correspondence to the position of the live performer on the stage. As used herein, the term “temporal alignment” (also referred to as “time alignment,” “synchronization,” or “timing correspondence”) refers broadly to the condition in which displayed lyrics, graphics, or other visual content are presented in a manner that corresponds in time to an associated audio performance, whether that audio is produced live or retrieved from a recording. Temporal alignment encompasses any technique for ensuring that the visual output appears coordinated with the audio output, including but not limited to frame-level synchronization, phoneme-based synchronization, word-level synchronization, beat or rhythm alignment, syllable-by-syllable alignment, or coarse-grained timing such as line-by-line highlighting. Temporal alignment may be achieved by various means, including real-time processing of live audio, pre-processing of stored media, use of timestamps, mapping of lyric files to audio files, or manual or automated synchronization techniques. In one embodiment, audio delay through the system may range from 10 to 300 milliseconds, and in other embodiments latency is maintained within 50 to 150 milliseconds. Temporal alignment may also include embodiments where the visual content leads, lags, or otherwise generally tracks the audio content sufficiently for the audience to perceive the content as being presented “in time” with the performance.

As used herein, the term “spatial correspondence” (also referred to as “spatial alignment,” “spatial association,” or “visual origin”) refers to the condition in which displayed lyrics, graphics, or other visual content are presented in a manner that appears to an audience as being located, originating from, or otherwise visually associated with the position of a live performer, a performer's body part (such as the mouth, face, or hand), an instrument or microphone used by the performer, or any other stage element associated with the performer. Spatial correspondence encompasses direct emanation effects (e.g., lyrics appearing to emerge from the performer's mouth), proximity-based placement (e.g., lyrics appearing adjacent to or above the performer's location on a display), projection-mapping onto physical objects associated with the performer, and computed visual effects that cause the audience to perceive a linkage between the live performer's position and the displayed lyrics. Spatial correspondence may be achieved by tracking the performer with sensors or cameras, by mapping audio input to a location, by predefining a stage position, or by any combination thereof.

Through these features, the system extends beyond lyric placement into a broader platform for live performer interaction with virtual performers and objects. The integration of live tracking, rendering, and audio synthesis or alignment allows for scenarios in which the live performer sings or converses with a virtual entity that reacts in real time, producing a combined live/virtual performance that appears seamless to the audience.

It should be appreciated that unless otherwise indicated, or otherwise would be understood based on context where it would be understood that a particular embodiment could only apply to either a live performer or a recorded performer appearing as a video or otherwise rendered image on a display or screen, the embodiments herein are intended to apply to both applications. In a recorded implementation, the words/lyrics may be provided as an augmented overlay or as a rendered visual effect layered over or around the singer's/speaker's image, and the perceived orientation and visual alignment can be pre-recorded, or mediated through the disclosed computer system, controller, and/or other components.

In various embodiments where a pre-recorded music video or lyric video is used rather than a live performance, the duration of the elongated sound may be previously known, and the wording/lettering is also previously known and generated (e.g., superimposed on, or embedded in the video itself, on the same display as the video, or provided separately from the video adjacent the video on the same display or separately on its own display). In another embodiment, the letter may also or instead, leave behind a size trail, shadow effect, or tail (e.g., as a shooting star) to emphasize the passage of time.

In one embodiment, as illustrated in the views of FIGS. 5A, 5B, and 5C, the present disclosure incorporates a hybrid display system that includes a first display 2200, a second display 1030, and optionally a third display 1450, as described in prior embodiments. For the purposes of the present embodiment, reference numeral 2200 is used to illustrated the first display 2200 and is referred to as a primary video display 2200 (such as an LED display). In the present embodiment of FIGS. 5A-5C, the second display 1030 comprises an augmented display, such as one or more adjacent transparent or semi-transparent displays. In one embodiment, the second display comprises one or more holographic fan display(s) (ten fans labeled A6, A7, A8, B9, C9, D8, D7, D6, C5, B5 being visible in FIG. 5A) capable of rendering content (e.g., video content) via a wireless connection and/or direct HDMI input, for example. In the embodiment shown, each holographic fan has four fan blades FB (although more or less blades can be used).

In some embodiments, the holographic display forming the second display comprises a plurality of synchronized holographic fans that allows the plurality of fans to coordinate their displayed image portions, creating together a single, large composite image. This system utilizes multiple fans with rotating blades FB placed in a partially overlapping configuration. The fans may be arranged on various patterns, such as a rectangular grid pattern, hexagonal pattern, or several other intricate arrangements, where some blades FB are partially positioned in front of others in overlapping fashion to provide visual continuity and eliminate gaps in the image. “Overlapping” fan or blades as used in the context of overlapping fan blades is intended to mean fan blades from two or more holographic display fans that have at least portions thereof one behind the other and hence appear to occupy the same or intersecting visual space (e.g., a lens or lune shaped overlap region generated by the overlap of two virtual circles circumscribed by the blades of the two adjacent fans) when viewed from certain angles (e.g., viewed head on, perpendicular to the fan blade planes (also referred to being a 0° angle) or angles that can be much larger than that (e.g., example, 45°). This can also be explained as the positioning of fan blades such that at least some portions of the blades that generate images that are visually aligned when viewed head-on or within a defined range of viewing angles, as can also be appreciated from the various figures herein and as would be understood by those skilled in the art. This configuration facilitates the integration of light emitted by different fans, enabling portions of images or video displayed on the respective blades to visually combine or “stitch” together, thereby forming a cohesive and continuous composite image as perceived by a viewer. In one embodiment, each fan can be equipped with precise timing and positioning sensors that continuously monitor the blade rotation speed and blade position.

In one embodiment, the motor of each fan is connected to the central controller (see FIGS. 12, 15, 16) that orchestrates their movements based on pre-programmed software instructions or real-time input. The computer system 1000 ensures synchronized movement of the fans to achieve the desired visual effects. The image tiles of the corresponding fans are labeled for convenience of this description by a coordinate system comprising numerals along the horizontal direction and letters along the vertical direction.

In various embodiments, as illustrated in FIGS. 5A-5C, one or multiple augmented displays 1030 (e.g., multiple fan displays) may be positioned along one or more of the side edge(s), top edge, and/or bottom edge(s) of the first display 2200, enabling content to transition to different display types multi-directionally. For example, a flock of birds, for instance, might begin on a first display 2200 (e.g., in the form of an LED display, LCD display or the like) and scatter in multiple directions onto separate augmented displays 1030 (e.g., fan displays). In one embodiment, each fan display receives a different video subregion tailored to its position and synchronization timing. In the embodiments of FIGS. 5A-5C, the augmented display 1030 may comprise one or more holographic fans. In the illustrated embodiment of FIG. 5C, forty-two fans are schematically represented by forty-two squares for simplicity. It should be appreciated that, in one embodiment, each fan displays a circular image tile corresponding to a warped segment of the active portion of a larger composite image that can be formed by all the fans. It should be appreciated that only a subset of fans may be used at any given time, depending on the location and size of the image content within the overall display area. In FIGS. 5A and 5B, a subset of the forty-two fans shown in FIG. 5C are illustrated (for example, ten fans are illustrated in FIG. 5A). It should be appreciated, however, that as few as just one fan can be provided in partially overlapping relationship with the first display 2200 to provide for the hybrid display herein. In various embodiments, the visual output of each of fans (or at least a plurality of adjacent fans) is individually controlled in a coordinated manner with one another to create a single image bridging adjacent and partially overlapping fans as shown, and as also described in PCT/US2026/010088, which is hereby incorporated by reference in its entirety.

In one embodiment, the primary LED display 2200 depicts a performer singing a song in synchronization with the sound recording and/or track of the song. In one embodiment, instead of the lyrics being generated on the first display, the lyrics are instead generated entirely on the holographic fan(s).

As similarly described in the live embodiment of FIG. 1 (e.g., also see FIG. 4D) where the performer is facing to their left (viewer's right), for a pre-rendered audio/video file (or files), the word formation is configured to commence in the direction that it appears to be projected by the performer as appearing on the display (e.g., in FIG. 1, to the performer's left, and viewer's right). As the word continues its formation it will then swirl or twist so that it changes directions so that the word can be read properly from left to right. For example, if the performer is singing Hallelujah, the first couple, few or several letters (just for example, three letters, as one example, but less or more letters are also contemplated) may be rendered to appear in reverse order as the word is formed, such that they appear to the build from left to the right as seen by the viewer as: L A H. In this example, after the first three letters are formed, the first letter “H” begins to move vertically (up or down) such as in a curved path so that the movement of the letters shift so that they no longer move from left to right, but instead move from right to left (as perceived by the viewer). For example, FIG. 5C at word string 2230 shows the trailing portion of the word being formed as “H A J” when read left to right, while the first seven letters are displayed in correct left to right reading order as H A L L E L U. Arrows in the figures generally show one option for directionality and movement of letters.

As also shown in FIG. 5C, in one embodiment, as shown by lyric string 2240, the lyrics can commence near the performer's mouth on the primary display 2299 and move to the right, transitioning to the fan based display(s) (and optionally disappear by moving past the boundary of the fan display image area). As shown in another embodiment of lyric string 2260, the lyrics can commence on the fan display, spaced from the performer's mouth, rather than commencing on the first display, and move further away from the speaker's mouth (and optionally disappear by moving past the boundary of the fan display image area).

In one embodiment, each of the words (or at least several words) previously completed (both sound and letters) is maintained as a visible word “repository” or sidebar (region of accumulated of words) 2300 (see FIG. 5C) at a chosen location of the display or on an ancillary separate display (e.g., typically to the right of the singer) whether live or recorded/streaming), and most recently sung words join at the end previously sung words, whether those words were initially projected left and/or right.

In one option, when the letters start to build from left to right so that they will appear to start spelling the word backwards, the individual letters may also initially be written backwards. For example, the letter “L” may appear as a backwards L. Then, when the word changes directions, the backwards letters will flip to be in the correct orientation. Thus, in a sense, it would appear that the letters would be seen correctly by a different observer/viewer facing the opposite direction as the primary/subject viewer, and that the “backside” of the letters are initially being seen by the primary/subject viewer. This can be envisioned, for example, as the words being printed on a transparent or translucent ribbon when they come out of the performer's mouth, with the backside of the ribbon being seen by the primary/subject observer and the backside of the words being visible through the ribbon (the letters would appear to be facing the wrong direction). Then, when the words change direction by twisting or swirling as previously described (the ribbon flips directions and sides), then the letters will also flip to the correct orientation for the primary viewer.

In one embodiment, as can be appreciated from FIGS. 5A, 5B, and 5C, the first display 2200 and the immediately adjacent holographic fan(s) (e.g., A6, A7, A8, B5, C5, B9, C9, D6, D7, and D8) are physically arranged such that the fans'image region closest to the display 2200 is aligned with and slightly behind the adjacent edge portion of the first display 2200.

In one embodiment, a continuous, visually stitched image is formed between the display 2200, which is at a fixed or known position, and one or more immediately adjacent or overlapping holographic fan(s). In one embodiment, such stitching may be achieved by mapping the image content across both displays using a unified coordinate system that accounts for the fan's circular display area and spatial offset behind the LED panel. In one embodiment, the computer system/controller optionally warps the portion of the image assigned to the fan(s) so that, when rendered through the fan's rotating LED blades FB, it visually aligns with the adjoining image content on the display 2200 from the intended viewer perspective. In one embodiment, depth offset and viewing angle are factored into the transformation to compensate for parallax and ensure geometric continuity. Pixel mapping can be adjusted dynamically or pre-calculated to align edge features and prevent or reduce visible seams at the transition boundary.

Unlike stitching between two adjacent overlapping fan blades, where circular-to-circular edge alignment is performed, stitching of a fan image with another type display (e.g., LED display, LCD display (with or without lenticular enhancements) may optionally involve aligning a curved (circular) fan surface to a planar edge, which may utilize more warping and depth-aware calibration.

In another embodiment, the surfaces adjacent to (e.g. behind, in same plane as, in front of) one or more holographic fans may be projection mapped with a projector, wherein the boundary and/or shape of the image projected by the projector is configured to take generally match the boundary shape of the one or more fans, so as to create a contiguous or slightly overlapping border between the projected image and the fan image.

In one embodiment, the output of content on the fans is managed and synchronized by a computer system 1000 having a central controller (See FIGS. 12, 13 and 14 and related discussion throughout this disclosure) that communicates wirelessly or via wired connections with each individual fan. In one embodiment, the computer system 1000 and central controller use an algorithm to adjust the LEDs' activation timing on each fan blade, so that the images displayed by adjacent fans seamlessly stitch together. For instance, when arranged in a grid pattern, each fan's blades FB can be positioned and configured to partially overlap with neighboring fans. The LEDs on these overlapping blades light up in a coordinated manner, controlled by the computer system and controller, to create a continuous image. In various embodiments, the computer system/controller processes the image data, dividing it into segments corresponding to the display area of each fan, and then synchronizes the timing of the LEDs on each fan so that the edges of the images displayed by adjacent fans are aligned, forming a unified larger image.

It should be understood that, unless indicated otherwise (or as would be understood by a person of ordinary skill in the art, or from context, to mean otherwise) the term LED as used herein is intended to be a generic term in include any type of LED, such as surface mount device LED (SMD LEDs), OLED, transparent OLED, flexible OLED, QLED, QD-LED, mini-LEDS and micro-LEDS, unless the specific context would suggest a different meaning.

In one embodiment, the one or more fan(s) partially behind the rectangular LED display will be positioned such that approximately 10% to 35% of the diameter of the fan's circular display image region overlaps the plane of the adjacent LED panel. The overlapping region forms a circular segment, a portion of the fan's circular image bounded by a chord (the straight LED edge) and the arc of the fan. The height of this segment (constituting the 10-35%) is measured perpendicularly from top of the arc to the chord. For example, for a fan that has blades that circumscribe an approximately 30 inch diameter circle (e.g., 15″ blades), the fan would be positioned such that the overlap would be between 3.0 to 10.5 inches (i.e., this would be the length of the perpendicular line from the arc of the circular image region to the chord formed by the straight edge of the LED display).

In one embodiment, the LED panel (or OLED panel, etc.) thickness from the back surface of the panel to the front LED display surface is equal to or less than 0.5″ thick, at least in the area of the LED panel's overlap with the one or more fans behind it. In another embodiment, this LED panel thickness is equal to or less than 0.3″ thick. In addition, in one embodiment, a gap of between 0.25″ to 2.0″ is provided between the front surface of the fan blades and the rear surface of the LED panel in front of the fan(s). In another embodiment, a gap of between 0.5″ to 1.5″ is provided between the front surface of the fan blade(s) and the rear surface of the LED panel. In another embodiment, a gap of between 0.75″ to 1.25″ is provided between the front surface of the fan blade(s) and the rear surface of the LED panel.

In such various embodiments, it can thus be appreciated that in some embodiments, the fore/aft distance between the image planes of the LED display (first display) and the image plane(s) for the on one or more fan blades behind the LED panel may be less than 0.75″. In another embodiment, this distance may be less than 1.0″. In another embodiment, this distance may be less than 1.25″. In another embodiment, this distance may be less than 1.5″. In another embodiment, this distance may be less than 2.0″. In another embodiment, this distance may be between 0.75″ and 2.5″.

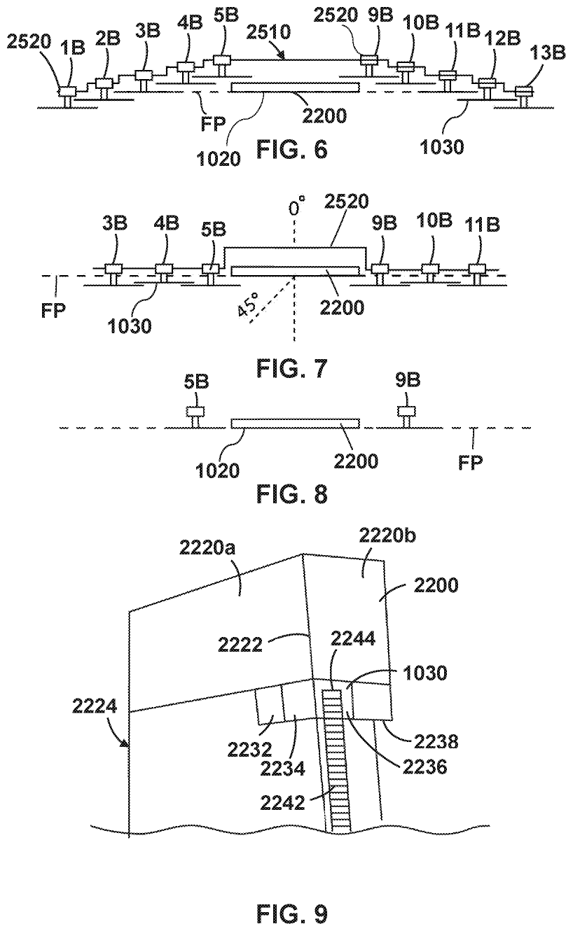

In one embodiment, an integrated mounting frame system 2500 if provided for the fans and the first display 2200. In one embodiment provides for very specifically fixed locations (within tight tolerances—e.g., less than 1mm) for the primary 2200 and one or more adjacent fans such that the spacing therebetween is known by the computer system (SEE FIGS. 6, 15, 16) to provide for accurate stitching of pixel images between the first display 2200 and the one or more adjacent fan(s).

In one embodiment, the frame system 2500 can include precision-adjustable brackets 2510 connected (either directly or indirectly) to fan motors 2520, allowing fine tuning/adjustment of spacing and location of and between the primarily display 2200 and adjacent fans. In one embodiment, the adjustable brackets 2510 permit for adjustment along the x, y, and/or z axes to minimize perceptual offset and achieve a seamless transition between the image regions of the respective displays. In one embodiment, the relative positions of the first display 2200 and fan(s) is determined by position sensors and/or encoders incorporated into the bracket, and such sensors/encoders provide this information to the controller so that the precise location of the displays are known at all times. In one embodiment, the position and location of fans can be adjustable relative to one another based on the previously disclosed embodiment of FIG. 1, just for example, and the first display 2200 (for example, a location at the back of the display 2200) can be fixed relative to the fixed frame, outer housing or track in that embodiment.

In one embodiment, the adjacent fan display(s) receives video input through a direct HDMI interface and is mounted in proximity to the first display 2200 such that its rendered image area can be geometrically aligned to appear as a continuation or extension of the first display surface.

As noted above, in one or more embodiments, one or more of the array of holographic fans of FIGS. 5A-5C can operate as the second display device 1030, and/or the third display 1450. In one or more embodiments, one or more of the array of holographic fans of FIGS. 5A-5C can have the same connectivity as the second display device 1030, and or the third display 1450.

It should be appreciated that in alternate versions of the embodiment of FIGS. 5A-5C, the augmented or second display 1030 is not one or more fans, but can instead be different types of displays, such as other types of augmented displays (e.g., transparent or semi-transparent displays) or may a projection mapped non-transparent surface. For example, in FIG. 5C, the entire display region 1030 can be a mesh, scrim, or hologauze display, comprising one large mesh/scrim/hologauze material, or a plurality of material sections, surrounding or adjacent to the primary display 2200, or alternatively can be an opaque surface, display or wall (rather than a transparent augmented display), in combination with one or more projectors 2112 is used to illuminate or projection map that type of screen or surface. In one embodiment, images (e.g., a particular character or individual) can initially appear on the primary display 2200 and transition to this different type of augmented display or display wall/surface 1030. In this embodiment, the image source will change from, for example, LEDs on the primary display, to projected images coming from one or more projector(s) 2112. In this embodiment, the scrim, mesh, or hologauze can be positioned adjacent to, touching, and/or overlapping (in front of or behind) the surface of the primary display.

In one embodiment, an animated or otherwise generated element, graphic or lyrics as described herein is rendered such that it moves continuously across both display types (e.g., from the first or primary display 2200 to the second or augmented display 1030. In one embodiment, the content is authored and rendered with spatial and temporal continuity, ensuring that the motion of the object is largely perceptually continuous (or near continuous) as it moves from the first display 2200 into the image region of the second display 1030.

In one embodiment, the aforementioned frame 2500 and brackets 2510 can be configured to position the immediately adjacent fans'image area of display 1030 to be offset behind and adjacent to the image area of the first display 2200. As such, in one embodiment, from the viewer's perspective, the rendered content can be configured to appear to flow from the first display 2200 to the one or more fans 1030 (wherein the image can appear to be floating in free space). In one embodiment, to enhance the illusion, the video frames rendered on the fan display may incorporate parallax shifts, lighting changes, or scale variations that simulate three-dimensionality, taking advantage of the fan's capability to present floating images through high-speed rotation.

It should also be appreciated that any number of fans can be accommodated with this system. For example, in one embodiment, a composite image canvas with a defined pixel width and height of 3840×1080 pixels may be segmented into multiple display regions, including a first region allocated to the first display 2200 (e.g., flat-panel LED display) and one or more subsequent regions allocated to one or more holographic fan displays 1030. In one embodiment, each fan display receives image content from a corresponding square region (e.g., 800×800 pixels), which is preprocessed to conform to a particular fan's circular display area and radial rendering method through masking, coordinate remapping, and/or geometric warping. The number of fan regions may vary depending on the desired configuration, ranging from a single fan to an array of multiple fans. This structure allows for flexible display combinations while preserving seamless visual continuity across different display types. In one embodiment, each fan receives its respective region via a dedicated HDMI output from a media processor or media server.

As another example, in the illustrated embodiment of FIG. 5C, a 12-column by 4-row grid of display regions are provided, where each region corresponds to an 800×800 pixel area allocated either to a fan display or to a portion of the first display 2200. A total of 48 grid positions (12×4) are available. The first display 2200 occupies six contiguous positions—specifically, columns 6 through 8 and rows B and C—thereby replacing the fan display regions at those locations. This results in a rectangular first display area measuring 2400 pixels in width (3 columns×800 pixels) and 1600 pixels in height (2 rows×800 pixels), generally centrally located (although a bit to the right) within the overall canvas. The remaining 42 grid positions are assigned to individual holographic fan displays, each receiving an 800×800 pixel image region that is preprocessed to conform to the fan's circular display area through masking, radial coordinate remapping, and geometric warping. The full composite canvas therefore measures 9600 pixels in width (12 columns×800) and 3200 pixels in height (4 rows×800), and it serves as a unified rendering space for synchronizing image content across both the first display and fan display zones.

In one embodiment, the configuration of FIG. 5C comprises modular, pixel-addressable LED panel or tiles connected together, enabling the overall LED area to match the 2400×1600 pixel resolution corresponding to the six-tile rectangular region within the grid. The modular construction permits flexible physical deployment and serviceability, while maintaining compatibility with the fan-driven content zones rendered in the adjacent positions of the grid.

In one embodiment, the display system comprises a substantially bezel-free or minimal-bezel design, integrated alongside one or more holographic fan displays to form a composite visual output.

In one embodiment, the first display 2200 comprises a modular LED panels (e.g., of the type used in LED video walls), and composed of edge-to-edge, bezel-free display tiles. The LED panel is formed from a matrix of high-resolution display modules joined seamlessly to create a continuous front-facing image surface with effectively zero bezel between tiles. Each module may include sub-millimeter interconnect seams (e.g., <1 mm gap) and a uniform front plane to enable precision visual alignment with adjacent content zones. The modular construction supports variable resolution and aspect ratios and allows the LED display area to be customized to match predefined pixel dimensions—such as a 2400×1600 pixel region—aligned within a unified composite canvas shared with the surrounding fan displays. In another embodiment, however, the first display 2200 comprises a LED display with bezels (e.g., a retail television).

In some embodiments, the physical thickness of the primary display 2200 may introduce some additional depth offset between the first display 2200 and adjacent (overlapped) fan(s) of a second display 1030 (e.g., see FIG. 5B). In other words, in some embodiments, the depth offset (depth spacing) may be greater between the viewing surface of the first display 2200 and the fan display 1030 than the depth variation encountered between two overlapping fans with stitched images, where spinning blade planes may be closer to being coplanar. To account for this increased depth differential, if desired, the computer system can use a software-based rendering engine that applies depth-aware image transformations to the fan content. These transformations may include perspective warping, scale adjustment, and/or spatial foreshortening, calibrated based on the known physical offset between the LED and fan display surfaces and the viewer's expected vantage point. As a result, the transition of character or graphics moving between the primary (non-fan) display 2200 and the one or more adjacent fan displays of the second display can be made to be visually more smooth, despite differences in physical depth and display technology.

In another example, an array of one or more holographic fan displays of the secondary display 1030 are arranged vertically only along the left edge of the first display 2200. In one embodiment, each fan occupies a defined (800×800, for example) pixel square region within the composite image canvas, and displays content via radial rendering within a circular display area inscribed within that square region. In one embodiment, the fan array may consist of two or three vertically stacked fans, depending on the height of the primary display 2200 (e.g., and LED display) and the desired coverage. In one embodiment, the leftmost regions of the canvas are assigned to the fan displays, with each receiving a warped and masked segment of the image content designed to align visually and geometrically with the adjacent edge of the primary display 2200, thereby creating the appearance of a seamless image across the two disparate display technologies.

In an alternative embodiment, the first display 2200 comprises an off-the-shelf flat-panel LED or LCD display (e.g., with fixed dimensions) serving as the central visual element, surrounded on one or more sides by a configurable array of holographic fan displays. For example, the first display may comprise a commercially available model, such as a 4K UHD display with a native resolution of 3840×2160 pixels, or other standardized formats including 2560×1440, 1920×1080, or 5120×2880 pixels. Based on the physical dimensions and pixel resolution of the selected primary display 2200, one or more adjacent fans may be configured so that the image it generates is aligned with one or more edges of the panel. In one embodiment, one or more fans is assigned a square display region (e.g., 800×800 pixels in resolution) and receives a warped and masked portion of the overall image canvas adapted to its radial display geometry. In one embodiment, the number of fan display regions and their placement are determined based on the aspect ratio and size of the primary display, allowing for symmetric or asymmetric arrangements, including top, bottom, side, or full-border configurations. In one embodiment, the fan regions are logically mapped within an expanded composite image canvas that includes the primary display 2200 resolution, plus sufficient space for each fan region, enabling seamless visual transitions and synchronization between the primary display 2200 and the adjacent circular fan displays 1030.

For example, when using a 4K LED panel measuring 3840×2160 pixels, an array of holographic fans may be positioned along the top and bottom edges, each fan occupying an 800×800 pixel square. In such a configuration, four fans may be positioned across the top (4×800=3200 pixels) and four across the bottom, with their positions logically offset within the composite canvas to align with the LED panel's pixel geometry. Additional fans may be positioned along the left and right edges if space permits, forming a U-shaped or fully enclosed surround display architecture.

In one embodiment, the first display 2200 may be implemented using an ultra-thin commercial OLED or micro LED panel with a front bezel width of less than 6 mm, and an overall panel depth of less than 11 mm. In one embodiment, the bezel may have a depth thickness in the range of 2 mm to 10 mm. For example, displays such as the LG Gallery OLED (G-series), Samsung OLED S95 series, or Sony Bravia A95L offer front-facing bezel trims between approximately 4 mm and 6 mm and total panel depths in the range of 9 mm to 11 mm. These thin-edge configurations are selected to minimize visual discontinuity and to reduce the physical offset between the flat display and adjacent fan displays.

In one embodiment, the aforementioned frame 2500 and brackets 2510 can be used to precisely position the image surfaces of the first display 2200 and image surface of one or more adjacent fans forming the second display 1030. Controlling the relative depth positions between display surfaces can be used to reduce the perception of a gap by minimizing any discontinuity visible to the viewer and supports smoother transitions.

In one embodiment, before an object, character, letters/lyrics, etc. leaves the first display 2200, it will be rendered such that it appears to start coming toward the viewer (out of the display) and then when it first appears on the fans(s), it will appear to be coming from the direction of viewer into the fan(s). Thus, the object will appear to have “jumped” from the first display to the fan(s), thus skipping over the bezel. For example, this can be achieved using anamorphic or forced perspective animation of the object. Similarly, in an opposite implementation, the image of the object can be made to appear that it is going into the display (away from the user) as it approaches the edge of the first display, and then can appear on the fan(s) adjacent the first display 2200 in a manner that makes it appear that it emerges from the depths of the fan display, towards the viewer, before it continues along its projected path.

In another embodiment, the physical bezel 2227 itself can be modified or covered using optical treatments to reduce its perceptual prominence. A non-reflective, matte black masking layer or other light absorbing material or modification to the bezel can be applied to the bezel or on top of the bezel to suppress light reflections from ambient light or from any of the displays.

In one embodiment, a light-scattering film may be placed over both the bezel and adjacent display surface of the first display to diffuse edge boundaries and visually blur the transition, thereby masking the physical gap from the viewer's perspective. In one embodiment, a light-scattering or waveguiding film is applied over the bezel region, configured to capture and laterally propagate light from adjacent display areas thereby reducing the perceptual discontinuity between adjacent display surfaces.

In various embodiments, to achieve frame-accurate synchronization between different display types, different approaches may be used. In one embodiment, a multi-output video processor with genlock capability is employed, so that all HDMI output channels are synchronized to a common timing signal. In another variation, synchronization is achieved using network-based protocols such as NDI with frame locking, or through software platforms like TouchDesigner or Resolume Arena which support synchronized multi-display output. In one embodiment, the fan display(s) is configured to include support (e.g., through its controller or firmware) for genlock or vertical sync, they can be tied to the same reference source as the LED panel to reduce or eliminate temporal drift. In one embodiment, to maintain temporal synchronization, the system includes a media processor (e.g., video processor) or media server that delivers synchronized video signals to both displays from a unified timeline and/or via hardware genlock. In one embodiment, the fan display(s) receive its frame-accurate content in parallel with the first display, so that each animation frame presented on the LED display transitions at the correct time into the corresponding frame on the fan. In one embodiment, this is achieved using synchronized playback engines, NDI streams with timecode locking, or SMPTE-based genlock synchronization that is supported by the fan's control hardware.

In one embodiment the computer system and/or controller of FIGS. 12, 13, 14 and/or 15 include the video processor and genlock synchronization hardware/software. device. The system controller is configured to manage video content and control signals, and coordinates the output of video content across the different multiple display devices. It should be understood and appreciate that the individual devices disclosed herein may also have their own hardware and controllers that interface with the computer system 1000 and/or controller(s)/processors of FIGS. 12, 13, 14 and/or 15. Just for example, in one embodiment, each fan display includes its own dedicated controller responsible for managing local playback, synchronization, and device-specific functions. In one embodiment, this fan-level controller communicates with the main system controller to receive timing signals, content updates, or synchronization commands, ensuring coordinated operation across all display elements.

In one embodiment, as will be described further below, the computer system 1000 and/or controller(s)/processor(s) are configured to divide or route the video or other content into multiple output streams corresponding to separate display zones. In some embodiments, the video processor and/or genlock may be an external device operatively connected to the controller rather than being integrated into the system controller.

In one embodiment, a genlock signal source provides a master synchronization signal to maintain temporal alignment among the system content and components. The genlock signal may be distributed to the video processor and/or the system controller (1000), and in some embodiments directly to the fan or other augmented display. In one embodiment, the genlock signal facilitate all displays rendering content in temporal alignment. For example, in one embodiment a graphical object, such as an image of a Holographic Human, animal, lyric, or combination thereof may originate within the content area of the first display and move across its edge and continue into the display area of an adjacent augmented display, such as a holographic fan display, where it is rendered with a volumetric or three-dimensional appearance.

Although various embodiments illustrate the application of holographic fans as the second display in the hybrid display approach, it should be appreciated that in other embodiments other augmented displays can be used for the second display.

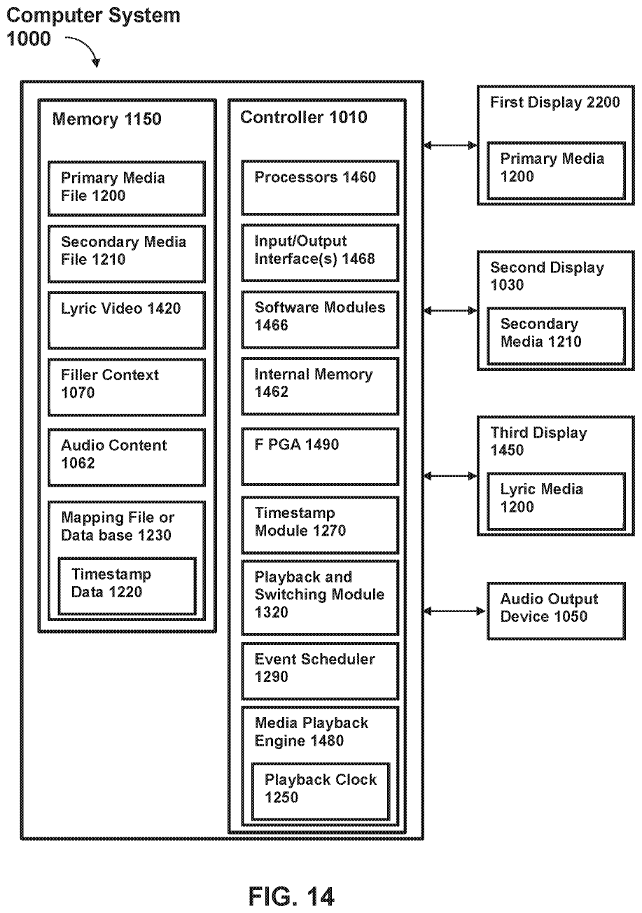

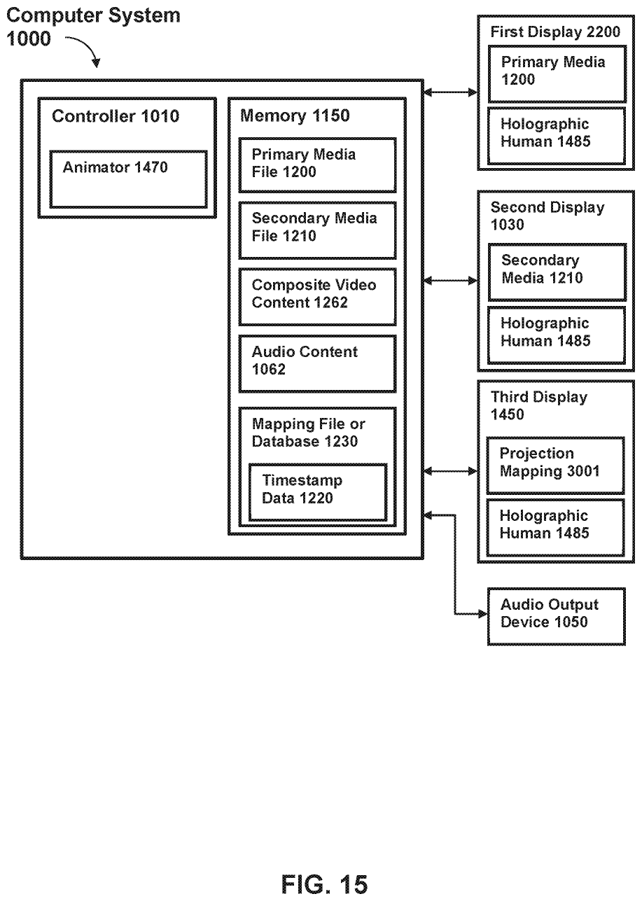

In various other embodiments, different media files of different types can be used together to create unique audio/visual display arrangements. For example, in one embodiment, a primary media file 1200, a secondary media file 1210, and/or a lyrics media or file 1420 (e.g., as illustrated in FIGS. 14 and 15) may be provided. In some embodiments, the primary media file 1200 and secondary media file 1210 can be used to identify the roles of media presented on first display 2200 (e.g., FIGS. 5A-5C) and second (augmented) display 1030, respectively. The same can be true for lyrics media 1420. In some embodiments, the primary media file 1200, second media file 1210, and/or lyrics file 1420 are different regions, crops, or mapped views of a single media asset or file that is processed and windowed to separate outputs under control of controller 1010. Thus, it should be appreciated that in some implementations, as used herein the term “files” in the figures is functional and non-limiting, so as to refer to a single file in some contexts. In other embodiments, 1200, 1210, and 1420 are distinct files that are synchronized by a common timeline or timecode. The same applies to rendered composite video 1262, which may be routed as a single content canvas spanning multiple display types.

In one embodiment, as shown in FIG. 9, the first display 2200 comprises two LED walls 2200a and 2200b disposed at right angles to one another at a corner 2222 (e.g., of a mounting frame, building, or other structure 2224. In the illustrated embodiment, one or more augmented displays are positioned adjacent the first display (2200a, 2200b). In the illustrated embodiment, the augmented displays can be any of the transparent or semi-transparent displays mentioned herein (e.g., holographic fans, projectors/mesh/hologauze, LED mesh, etc.). These augmented displays are schematically represented by rectangular image regions 2232, 2233, 2236, and 2238. In one embodiment, the images generated by the augmented displays are adjacent to or contiguous with the first display so that images can appear to leave the first display and appear to be floating in air. In one embodiment, a structure or image can be formed on the mount 2224 such that the image generated by the one or more fans can appear to be interacting with it. In one example, a building can serve as the mount 2224 for the display system of the first display (2200a, 2200b) and augmented displays 2232, 2234, 2236, 2238), and a physical ladder (or any object) 2242 is provided on the side of the building. In the illustrated embodiment, the ladder 2242 can be visible behind the augmented display(s) (e.g., behind augmented display 2236 in the illustrated embodiment) particularly when there is no image generated by the augmented display. The ladder 2242 can be optionally slightly illuminated by an optional light source 2244, which can be spaced from the ladder, or can be integrated into one or more of the rungs of the ladder (the ladder need not be functional as a ladders). In one embodiment, in operation, a figure (e.g., monster or King Kong) can start on the anamorphic display/billboard (2200a, 2200b), and then appear to jump or move to the augmented display 2236 and be illustrated or depicted to appear to be engaging with and climbing down the ladder 2242. One or more additional augmented displays can optionally be provided below the display 2236 in overlapping relationship with more rungs of the ladder 2242.

In one embodiment, in operation, the computer system 1000 selects the content (for example, a Primary Media File 1200, a Secondary Media File 1210, a pre-rendered composite 1262, etc.) and associates it with the two different displays (e.g., primary display 2200 (opaque)) and one or more augmented displays 1030/2232/2234/2236/2238 (transparent or semi-transparent). For anamorphic sequences, the software generates the imagery on both surfaces in a way that keeps its apparent size and position consistent for the intended audience region.

The controller 1010 then executes a simple handoff. As the sequence reaches the transition moment between display types, the object may overlap so that part of the object appears on the primary display 2200 and another part or portion of the object appears on the augmented display. During this overlap, the software gradually adjusts placement so the audience perceives the object as leaving the primary display and arriving on the augmented surface without a jump. In another embodiment, a more sudden jump occurs, such that the anamorphic image is made to appear to jump out of the primary display and then land or appear on the augmented display.

As illustrated in FIG. 6 illustrating an embodiment where the augmented display comprises one or more holographic fans, the fans immediately adjacent to the first display 2200 are positioned behind the display, and the fans that are further away from the first display can be progressively closer to the viewer, such that the front plane of the fan blades immediately adjacent the primary display are behind the front plane FP of the first display, but fans that are spaced further way can have the front plane of the blades in the same plane as the first display (see fans 11B and 3B in FIG. 6) and/or can be positioned forwardly of the front plane FP of the first display 2200. In the embodiments of FIG. 6-9, fans can have the motors 2510 of one or more fans(s) mounted on an adjustable bracket 2510 for adjustable positioning of the fans along multiple directions (e.g. parallel to the front plane PF, or perpendicular to the front plane FP). The same can optionally be done in any of the embodiments herein utilizing one or more fan(s) (such as FIG. 5A-5C).

In one embodiment, the one or more fans displaying the lyrics are positioned in front of the first display that displays a video of the performer that sings a song. For example, in one embodiment a first display (i.e., not one with rotating fan blades) will contain and project a video of an artist playing a song, with the sound of the song being synchronously played through one or more speakers (as may optionally be the case with any of the present embodiments that involve songs or music videos). In this embodiment, one or more holographic fans displaying the lyrics is positioned forwardly of the primary LED display.

The term “forwardly” in this sense is intended to mean the image plane of one display being positioned in front of another image plane when viewed from a top plan view. For example, in FIG. 6, fan 12B and 13B are forward of the image plane (front plane FP) of the first display 2200, while fans 9B and 10B are behind it. In one embodiment, the LEDs on the fans are positioned forwardly of the plane in which the LED's of the LED display are disposed (or in front of a “curved plane” in the event a curved LED display is used). In addition to being forward of the LED display, the one or more holographic fan(s) can be to the left of the LED display, to the right of the LED display, entirely in front (fully overlapping with the LED display), or partially overlapping with the LED display (with portions of the fan extending to the left, right, above and/or below the dimensions of the LED display.

It should be appreciated that the arrangement of fans in FIGS. 6-8 are optional and can be arranged in other configurations. Just for example, in FIG. 6, while fans 9B to 13B move forwardly of the front plane FP of the first display 2200, in another arrangement, just for example, the front plane of fan 11B can be positioned behind the front plane of fan 10B, and can alternate forwards and rearwards such that each of the front planes of the fans remain behind the front plane FP.

It should be understood that, in one embodiment, the LED display's or panels contemplated by this disclosure (e.g., such as that of first display 2200) can optionally include a plurality of smaller modular LED panels that are connected together (e.g., wired together with power and data cables), and that the controller (which can include a video processor component) can split the full video signal into smaller sections, and control what each panel within the matrix will display so that the multi-panel LED display operates as a large video “wall.”

In one embodiment, the system enables seamless visual transitions of images (such as, but not limited to lyrics) across the physical boundaries of disparate display types (e.g., the first display in the form of an LED display, and a fan-based holographic display) by aligning video content geometrically, temporally, and optically.

In one or more embodiments, the fan-based displays are configured to accept video input in a square aspect ratio, such as 800×800 or 1024×1024 pixels. The content authoring process provides that the portion of the video designated for fan output is centered within the square frame and occupies a circular region to match the fan's optical characteristics.

As disclosed previously, in one or more embodiments, the lyrics are projected or moved in a particular direction. In one embodiment, the lyrics are first generated on the first display (e.g., an LED display, LED wall, transparent OLED display, etc.) at a position corresponding to or adjacent to the singer's mouth and are pushed or moved onto the adjacent fan-based display, which may be positioned in adjacent, overlapping, or partially overlapping relationship with the first display. In one embodiment the lyrics will disappear (from the fans) after a predetermined amount of time, as discussed previously.

In one embodiment, the system supports both pre-rendered content and real-time generative content. In the case of dynamic media, an interactive application can be configured to output live video frames to each display using software-based mapping and synchronization. In one embodiment, for pre-rendered content, each video segment is encoded at its target resolution and played back via a multi-head media player or synchronized playback system.

In one embodiment, instead of being disposed behind the front plane FP of the first display 2200, in another embodiment, the front plane of the fan blades immediately adjacent the first display 2200 (e.g., fans 5B and 9B in the second row of fans) can lie in the same plane as the front plane FP of the first display (in which case there would be no overlap between the front plane of the blades and the front plane of the first display), as illustrated in FIG. 8. In various embodiments, the next fans over (away from the first display, e.g., 10B and 4B) can have their front planes either in front of or behind the front planes of 9B and 5B, respectively.

In another embodiment, as can be appreciated from FIG. 7, the front plane of the fan blades can be configured to at least partially overlap in front of the front plane FP of the first display 2200. The term “overlapping” as used in this paragraph means that or more fan(s) that have the front plane of at least some blade portions thereof positioned in front of the front plane FP of another display behind it (e.g., the first display 2200) when viewed from certain angles (e.g., viewed at a center plane that bisects the first display perpendicularly to the front plane FP of the first display (also referred to being a 0° angle)), or angles that can be much larger than that shown (e.g., example, 45° or more) that would still be within an acceptable viewing angle for the displays. In one embodiment, one or more fan blade(s) immediately adjacent the first display 2200 are positioned such that the front plane thereof is positioned in front of (forwardly of—e.g., closer to the viewer) and overlapping the primary display 2200 such that at least some portions of the blades are positioned to generate images (e.g., words or lyrics) that are superimposed or visually generally coincident (when viewed head-on or within a defined range of viewing angles) with portions of a display behind it (e.g., depicting a video of a singer or speaker). In one embodiment, lyrics generated by the one or more fan(s) are made to appear as they are emanating from an image or video on the first display of a performer (e.g., emanating from the vicinity of the singer's mouth). In one embodiment, the video or graphics generated by the rearward display (e.g., first display 2200) are programmed such that the fan(s) at least partially in front of it are located in dark (black) areas of the image behind it to reduce the visibility of the spinning fan blades themselves, which could be more visible if positioned in bright regions of the display in front of it.

In one embodiment, the lyrics again commence in the vicinity of the performer's mouth, and in embodiments where the lyrics are shown only on the fan display(s) and do not start on the first display, the proximity of the lyrics to the singer's mouth can be adjusted/determined in a number of ways. For example, in one embodiment, one or more fan(s) are positioned to the left and/or to the right of the first display (and either behind, in front of, or in the same plane as one another). The fans may also, or instead, be positioned above and/or below the first display. In one embodiment, the closer the singer's mouth is to the edge of the first display, the closer to the singer's mouth an adjacent fan can provide graphics/lyrics to the performer's mouth.

In the embodiment of FIG. 7, fans 5B and 9B are shown in partially overlapping relationship in front of the primary panel 2200, such that a portion of the fan's circular image region overlaps a defined area of the LED display. In one embodiment, to provide a more visually continuous transition between the fan-generated and LED-generated image content, the LED display can be configured to display video content only within a reduced active image area that preserves the original aspect ratio (e.g., 9:16), while blacking out a designated region of the display that corresponds to the spatial area behind the fan(s) rotating blade sweep. The blacked region on the LED display can be used to accommodate the fan's presence and reduce light conflict or visual ghosting of the fan in front of the first display 2200. In one embodiment, the active image area can be centered within the first display 2200. In another embodiment, the fan(s) one side are eliminated, and a larger blacked out area is provided on the opposite side to provide a larger overlap area with the other fan on the opposite side.

For example, in one embodiment, fan 9B would be eliminated, and the active image area of the display 2200 is resized and repositioned to occupy the upper right-hand portion of the display, while a remaining L-shaped blackout region spans the left and lower edges of the display. The fan 5B would have its overlapping portions thereof be overlapping in regions of the display 2200 in withing the L-shaped blackout region.

In one embodiment, for example, 30″ diameter fan blades can have the fan's circular image region overlapping the LED display by approximately 4.0 to 6.0 inches horizontally, measured from the left edge of the LED display inward. Accordingly, the vertical (upright) portion of the L-shaped blackout region can be a rectangular area extending between 4.0 to 6.0 inches in width. This configuration provides that the region of the LED display occluded by the fan remains visually neutral (black), reducing interference between the two display planes for a smoother visual transition therebetween.

To further enhance visual continuity between the LED and fan displays, an optical blending element may be introduced either between the LED display and the holographic fan, or in front of both displays in the region where the two image surfaces visually overlap.

The blending material can be one or more of (i) a neutral density film or tinted material that attenuates brightness behind or in front of the fan to reduce contrast and ghosting of the moving blades in front of the first display 2200, and/or (ii) a diffusion or light-scattering film or layer to overlay the overlap region to that provide directional light scattering and/or a smooth luminance gradient between the primary panel and one or more fans. In one embodiment, the blending material can be a thin, transparent or translucent panel mounted in front of both the first display 2200 and fan(s), and/or between them.

In one embodiment, these materials may be selectively applied in the L-shaped blackout zone, or only in the areas of overlap. In another embodiment, these materials may be positioned across the entire display system. For example, in one embodiment, the first display 2200 and fan(s) can be positioned behind any one of the front panels disclosed in the embodiments herein, and the blending material can form the material (or part of the material) of the front panel.

In one embodiment, as noted in prior embodiments, the lyrics can be rendered by the controller (as in FIGS. 12, 13, 14 and/or 15) at a location and direction corresponding based upon the location and direction of the singer's mouth (i.e., the apparent direction that a singer of the lyrics is projecting their voice).

In one embodiment, an LED fan and its blades can optionally be positioned either entirely to the left or right of the LED display (no visual overlap when viewed head on at a 0 degree viewing angle from a central display position and at a recommended distance), positioned in overlapping relation with the one or more holographic fans positioned in front of the first display, or with the holographic fans partially overlapping with LED display (either partially in front of or partially behind the LED display).

In one embodiment, a composite video is rendered to include a performer and synchronized lyric animations, wherein the lyrics originate from the vicinity of the performer's mouth and travel along a defined path across the frame. The animation is designed such that the performer and the initial portion of the lyric trajectory appear within a first display zone, corresponding to a standard LED display or other opaque flat-panel display, and the latter portion of the lyrics' motion path extends beyond the LED display into a second display zone, corresponding to a transparent or semi-transparent display, such as a holographic fan, LED mesh, scrim mesh, hologauze, or transparent OLED display.

In one embodiment, to achieve correct playback across these spatially separated displays, the system utilizes a multi-display computer setup in which the operating system is configured to extend the desktop canvas across two or more physical outputs. The full video content, rendered as a stitched panoramic frame, is then displayed in a window or full-display mode that spans both display surfaces. For example, the primary display may render the left portion of the frame containing the performer and the start of the lyric animation, while the secondary display displays the right portion, which contains the continuation of the lyrics as they transition into a volumetric or floating image format.

The system may employ OBS Studio or other display mapping and broadcasting software to manage the windowed playback, positional alignment, and video routing across the extended displays. OBS Studio allows for dynamic positioning of a pre-rendered video file or live video source across multiple displays, while maintaining correct aspect ratio, frame timing, and visual alignment. This setup enables precise control over where and how each portion of the video appears, and supports the seamless visual migration of lyric content from the primary LED display to the secondary transparent display without requiring internal media playback synchronization between disparate hardware types. This method supports flexible testing and rapid prototyping of hybrid display sequences using commercially available display systems and open-source software.

In another embodiment, the lyrics will move in a direction in which they appear to be projected by the singer's mouth as previously described. As also previously described, it should be appreciated, therefore, that in some embodiments where the first display depicting a singer (a display different from the LED fan(s)), is displaying a music video in which the singer is facing left for part of a song and right for another part of a song, then the lyrics will correspondingly move towards the left for part of the song and right for the other part of the song.

In one embodiment, the fan(s) displaying the lyrics (whether the lyrics are moving or stationary on the image tile) are on a stationary frame. In another embodiment, the frame(s) carrying the fan(s) are movable (as described in numerous embodiments herein).

Based on the present disclosure, it can be appreciated that various embodiments, video content is rendered such that a portion of the content appears on the first display and a visually continuous portion of the content appears on the second display, and that the computer system (e.g., a controller or video processing unit thereof) can divide the video content into subregions, including a first subregion positioned on the first display and a second region positioned on the second display. In various embodiments, the computer system comprises synchronization logic configured to the video content presented on the first display and the content presented on the second display.

In one embodiment, the first display comprises an opaque or non-transparent display (such as a traditional opaque LED display, LED wall, LCD display, for example) with a rectangular display area, and the second display comprises a holographic fan having a circular display area, wherein the rectangular display area and circular display area are partially overlapping, and wherein the computer system applies depth-aware warping in or adjacent to the overlapping region to produce an undistorted image across both displays.

In one embodiment, the second display is positioned such that its image area aligns optically or geometrically with an edge or boundary of the first display, such that the content appears to transition seamlessly between displays.

In one embodiment, content (such as video content) is rendered such that a portion of the content first appears on the first display and subsequently appears on the second display.

In one embodiment, the first display and the second display are synchronized using a timing signal, a shared clock, and/or a frame-aligned rendering system.

In one embodiment, the content includes at least one visual element that moves from the first display to the second display in a temporally continuous manner, wherein the visual element on the second display comprises an animated visual element with a volumetric or three-dimensional appearance. As used herein, the term “visual element” in the context of the present disclosure refers to a visual identity that is recognizable across different display types (e.g., LED and holographic fan display types) and does not require that the element be rendered identically in both segments. A shared visual identity may be established through shared visual attributes (e.g., the same hair color, same tattoo, same clothing, same letter or word, just for example), shared narrative context, shared naming or labeling, shared positional continuity within a scene, or any other association that identifies the depictions as representing the same visual element.

In various embodiments, the transition between the first display region and the overlapping fan display region (where the fans are partially overlapping, either in front or behind the first display) is visually aligned such that the motion, color, or graphical elements appear essentially continuous across the two surfaces. As used herein, “aligned” or “continuous” refers to a perceptual continuity rather than a mathematically exact spatial or pixel-perfect correspondence. In certain cases, deviations or imperfect alignment may enhance the viewer's perception of depth or dynamic motion, and are sufficient to achieve a visually pleasing blended (stitched) output.

In another embodiment, a transparent LED mesh display is used as the second display surface in place of a holographic fan. The transparent LED mesh comprises a grid of spaced light-emitting diodes (LEDs) mounted on a thin, lightweight substrate, such as a clear polycarbonate frame or structural scaffold. The spacing between the LEDs provides a partial transparency that allows viewers to see through the display when content is not being shown, enabling floating or augmented visuals overlaid onto real-world scenes or physical structures. These displays are commonly referred to as LED mesh panels or transparent LED displays, and are manufactured by various companies, including Absen as an example.

In one embodiment, the LED mesh display may be configured with a horizontal pixel pitch of approximately 3.9 mm and a vertical pitch of 7.8 mm, supporting high-resolution text or motion graphics in installations where visual continuity with a primary opaque display is desired. In certain configurations, the transparency may exceed 30 percent, allowing the display to blend into its environment while still projecting vibrant, full-color video content. Advanced models may achieve transparency levels above 80 percent using fine-pitch layouts with ultra-slim profiles, including panel thicknesses of less than 10 mm and brightness levels exceeding 4,000 to 7,000 nits, suitable for high-ambient-light conditions such as retail windows, event stages, or showroom installations.

In the context of the present application, the transparent LED mesh is positioned adjacent to (e.g., in the same plane as), or overlapping with, the first display surface (such as an LED video panel), and is used to render projected lyric content or other visual elements that appear to travel from the performer (or in another embodiment, a Holographic Human) on the main display and extend outward onto the mesh display. Because the mesh is partially transparent, the lyric elements appear to float or hover in space, maintaining visual continuity with the primary display while introducing a spatial layering effect. The transparency also allows for behind-display visibility, making the display suitable for immersive or architectural applications where physical or visual depth is beneficial.

Unlike fan-based displays, which rely on spinning blades and require physical clearance to avoid mechanical interference, the LED mesh is a fully static, planar structure composed of fixed LED nodes mounted on a transparent grid or scaffold. Because it contains no moving or rotating parts, the mesh display can be mounted in direct contact with the adjacent edge of the first display surface, eliminating the need for an air gap or spacing/buffer. Additionally, the mesh display has a flat, rectilinear edge profile, to facilitate geometric alignment with the edge of the first display, including shared borders or overlapping content zones, to also facilitate visual stitching and seamless transitions of content between the two displays, and without radial rendering constraints.

It should be appreciated that any of the embodiments disclosed throughout this application that discuss the use of a holographic fan, which provides a transparent or partially transparent display for an image, such fan can be substituted with a different transparent or semi-transparent display type, such as an LED mesh, hologauze, scrim mesh, transparent OLED display or particle (e.g., water) display type. Such other displays either have light generating elements (e.g., LEDs) disposed thereon (as with LED fans), such as in the case of LED mesh or transparent OLED displays, or comprises surfaces or materials that are configured to reflect projected light incident thereon, such as in the case of hologauze, scrim mesh, or particle display types. Thus, it should be appreciated that each of the descriptions pertaining to these other types of transparent/semi-transparent display types is hereby incorporated by reference into the descriptions and embodiments in which holographic fans are used herein.

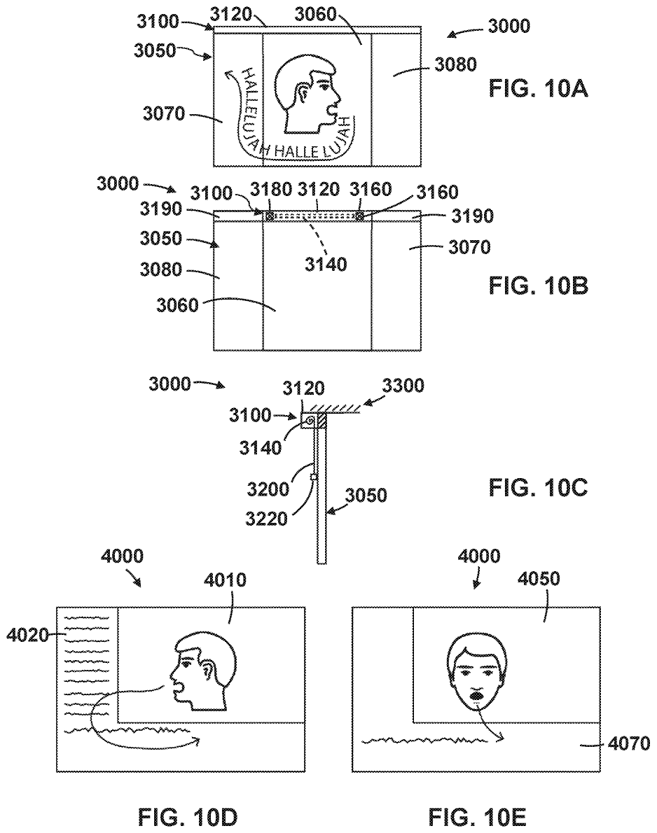

In another embodiment, as shown in FIGS. 10A, 10B, and 10C, a transparent OLED display system 3000 is used without any holographic fans. In this embodiment, the OLED display 3050 will receive media input (such as a music video), via an HDMI input or via media playback through onboard software (webOS, for example). Transparent OLED panels use organic light-emitting diodes that are deposited on a transparent substrate. The self-emissive nature of OLEDs allows each pixel to emit light independently, enabling transparency when the pixels are turned off. OLED panels comprise organic materials that emit light when an electric current passes through. In transparent mode, the OLED pixels are either turned off or emit minimal light, allowing light to pass through the substrate.

In this embodiment, a black or dark backing structure 3100, such as a solid matte board (e.g., velvet material mounted on a stiff board and secured permanently or removably to the back of the OLED display behind the desired portion (s)), a motorized roll-up display that deploys a screen that is rolled up at the top of the display behind it and can go up or down based on motor control, or smart glass (SPD panel or layer) or electrochromic layer that can be made dark or black, will positioned behind the OLED display, and can be sized to cover only a portion of the back of the OLED display. The term “backing” is intended to broadly refer to any material, layer, device and/or mechanism (which can be separate from the OLED display or integrated into it) that can be used to make a portion of the OLED display more opaque (increase opacity) and/or to allow less than at least 50% of visible light to pass therethrough. In one embodiment, the portion of the display with backing comprises between 50% to 70% of the total width of the display, while the non-backed portions total between 50% to 30% of the total width. In one embodiment, the backed portion will be entirely contiguous, while the non-backed portion can be either contiguous or divided into different areas. For example, in one embodiment, the dark backing covers only the middle portion of the OLED display, leaving opposite sides on the left and right without any backing.

For example, as shown in the front view of FIG. 10A and the rear view of FIG. 10B, in one embodiment, the backing in the middle portion 3060 of the display comprises 50% of the total width, while areas on the left portion 3070 of the display and right portion 3080 of the display (from the viewer's perspective) have no backing and comprise 25% each of the total width. These proportions are non-limiting examples and can vary greatly. In addition, in one embodiment, the display can be divided into only two regions. For example, in one embodiment, the right 65% of the display (from the viewer's perspective) can be backed while the left 35% of the display can remain unbacked. In this way a greater percentage of the display remains available for lyrics to be accumulated or placed to the left of the performer (either initially, or moved from the back region to the unbacked region as can be appreciated from the prior discussions). In the illustrated embodiment, the backing structure 3100 comprises a housing 3120 that carries within it an elongated spindle 3140. The spindle 3140 is operatively connected on at least one end thereof to a bi-directional motor 3160, while an opposite end thereof can be rotationally mounted (e.g., via bearings 3180) to be freely rotatable in either direction. In one embodiment, as shown in FIG. 10C, a dark (light absorbing) backing material 3200, such as fabric or composite for example, can rolled-up on the spindle 3140 or unrolled from the spindle 3140, as desired, by operating the motor 3160. In one embodiment the backing material 3200 is kept taut by a tensioning element, such as via a weight 3220 attached along a bottom of the backing material 3200.

It should be noted that the non-backed areas can be backed if or when desired, meaning that these areas can optionally be provided with backing as well (e.g., with separate backing displays or boards) at select times, but the system is configured to be left without backing at specific regions when the desired effect is intended, as will be understood. In other words, the regions 3190 can optionally be entirely empty with no structure, can contain an empty housing for aesthetic purposes to match the housing 3120 at the central portion, or can have two separate backing mechanisms similar to that at the central portion to enable the side portions to be backed if/when desired. If provided, the backings for the left and right portion can operate together or independently. In another embodiment, the backing is provided or lowered on only the side portions, and the central portion may be left unbacked. In one embodiment, a video feed is provided to the transparent OLED input. The video feed can be, for example, a music video. In one embodiment the video is masked or cropped so that it will display only in the central portion of the OLED display. For example, in one embodiment, the video is masked or cropped to occupy a central 1920×800 inside a 3840×1080 canvas. In one embodiment the video is edited with a non-linear editing tool (such as Adobe After Effects, for example) to occupy only part of the display that will have backing (e.g., the central part). The other portions of the video (which will be aligned with area without backing) can be left black to remain transparent on the OLED display. In one embodiment, the video is cropped such that it is the same size and shape as the backing and assumes the same borders or boundary as the backing, or such that it is smaller than the backing and is peripherally within or contained by borders defined by the backing so that the non-black (or dark) portion of the video feed (e. g, the main video content, excluding the lyrics, and generally brighter than the black portion) has backing behind it. In another embodiment, portions of the cropped video can extend outside the backing area so that portions of the non-black portions of the video are transparent. In one embodiment, the video is cropped into a rectangular shape, and the backing is of a rectangular shape.

In one embodiment, lyrics are animated and added to the video feed. For example, in various embodiments, the lyrics words are synched with the corresponding audio of the music video. To synchronize lyrics with the music video for animated display on the transparent OLED display, an audio track or music file (of the music video) is used as the source for phonetic segmentation and timing. In one or more embodiments, one or more software tools such as Audacity, Sonic Visualiser, and/or Aegisub can be employed to analyze the waveform and mark the start and end times of individual words or syllables, either manually or semi-automatically. These timestamps are then encoded into a structured lyric file that associates each lyrical element with its precise moment in the audio timeline.

In one embodiment, after the lyrics are time-coded, the video content (e.g., masked, centrally positioned music video) can be composited with animated lyric elements. In one embodiment, the masked (or cropped) music video and animated lyrics are composited into one full-frame video file. In one embodiment, the lyrics are imported into a motion graphics environment (such as Cinema 4D or Adobe After Effects) where each word or syllable is instantiated as a text object. In one embodiment, using the embedded timestamps, the system animates each object in synchrony with the original audio playback. In one embodiment, the animation parameters (e.g., entry point, trajectory, timing curve) are defined such that the lyric elements appear to emerge from a specific region of the video (e.g., at or adjacent to the singer's mouth) in the area of the display with backing. As in several of the previous embodiments, the animated lyrics will then project outwards into portions of the transparent display zones (to the left and/or to the right) without backing so as to appear floating in air, maintaining temporal alignment with the vocal content throughout the duration of the track. In another embodiment, the lyrics can be animated to initially emerge on the transparent portions (without the backing) so that they always appear to be in the transparent zone, and need not commence at or near the performer's mouth. In one embodiment, the center will show the masked video while the sides will have only animated text on a black or transparent background image.

It should be appreciated that the video feed provided to the transparent OLED comprises a single composite video signal in which the original source video is embedded as a subregion within a larger video frame, and adjacent to one or more dark (non-illuminated) regions. These dark regions will not contain visual data from the original video source but are instead used to render additional dynamic content, such as time-synchronized textual elements (e. g, lyrics), that are derived from or associated with the source video and extend spatially from it into the dark regions (or, optionally, solely in the dark regions.

In one embodiment, the transparent OLED display is mounted on a suspended or upright frame 3300, or can be wall mounted. The lighting and materials behind the non-backed region(s) can optionally be configured to be dark, to give more prominence to the lyrics.

As noted above, in one embodiment, the system allows for precise control over the trajectory, directionality, and spelling orientation of each lyric segment, such that the words or letters may initially be projected in a direction corresponding to the performer's facing angle (e.g., to the viewer's right), but are then rotated or mirrored in motion so that they spell out correctly from left to right as they migrate toward the second display. The animator (e.g., using Cinema 4D0 defines a custom path or motion spline along which the lyrics travel, and applies keyframed or procedural motion parameters such as speed, rotation, scale, and opacity to choreograph the desired visual flow. This enables a continuous and visually coherent transition of the lyric content from the first display (e.g., an LED display) onto an adjacent or overlapping second display (e.g., an augmented display), while maintaining semantic readability and alignment with the audio performance.

As shown in FIGS. 10D and 10E, in various embodiments, the source video is cropped such that it maintains the same aspect ratio before and after it is cropped. For example, in FIG. 10D (performer facing left), and 10E (performer facing straight on), both the original video and the cropped video may have a 16:9 aspect ratio. In FIG. 10D, the transparent OLED display 4000 is illustrated. In FIG. 10D, the original video is cropped to appear positioned in the upper right region 4010 of the display, as illustrated. In one embodiment, backing of generally the same shape and aspect ratio as region 4010 are provided behind the image within this region 4010. In this embodiment, it can be appreciated that the dark (transparent) region will have somewhat of an “L-shaped” configuration 4020. In FIG. 10E, the original video is cropped to appear positioned in the upper central region 4050 of the display, as illustrated. In one embodiment, backing of generally the same shape and aspect ratio are provided behind the image within this region 4050. In this embodiment, it can be appreciated that the dark (transparent) region will have somewhat of an “U-shaped” configuration 4070.

In any of the embodiments herein, and as illustrated for example in FIG. 10D, the entirety of lyrics is retained to remain visible throughout a song. The lyrics continue to build to capture this, optionally using any of the methods for generating and/or placing lyrics mentioned herein. In FIG. 10D, the lyrics can optionally fill all available portions of the transparent region 4020 (e.g., without backing). In other embodiments, such as in 10E, a subsection of the transparent region 4070 may be used for lyrics.

It should be appreciated from previous embodiment, other characters or figures (other than lyrics) may be used. For example, in FIGS. 10A-10E, in some embodiments, a flock of birds-e.g., sitting in a tree-may be seen in the original video and presented in the area with backing. With or without an accompanying sound (e. g, a large bang that would startle the birds), the birds can be shown to leave the video region with backing (e.g., region 4050 in FIG. 10E) and fly or flock to the transparent regions 4070 and appear to be flying through air. In other embodiments, as describe previously, a human or Holographic Human (e.g., a singer in a band), can leave the video region with backing and then move to the transparent region.

In any of the embodiments, the lyrics can optionally appear as sequential chunks, synchronized such that the lyrics being sung appears in advance or at least in sync with the sound of the lyrics. In one embodiment, the chunks of lyrics may remain essentially stationary from the time in which they first appear until the time they disappear and a new lyric chunk appears.

It should be appreciated that in any of the embodiments disclosed herein, lyrics can be generated on any of the displays in chunks, one letter at a time, or one word at a time. Where one word or letter is output at a time, they are output at generally the same time (synchronously, within acceptable tolerances) as the sound of that particular letter or word is being sung by the singer (or spoken by a speaker) on the other display (e.g. LED display). It should be appreciated that when it is stated that letters may be generated (or made to disappear) one letter at a time, or one word at a time, this doesn't mean that the formation of the letter or word must be completed prior to the next letter or word can start to be generated and visualized. In other words, for example, if a first letter or word commences formation by slowly starting to appear and/or becoming brighter, the second letter or word may commence formation (and be visible) prior to the first word being fully formed or achieving its full brightness. Similarly, as words or letters start to disappear (e.g., by disintegrating), the next letter in line for disappearing may also start to disappear before the prior disappearing word is completely gone.

In one embodiment, after each word is visually generated, it continues to move away from the singer/speaker until it disappears as described herein. Thus, with a sequence of words, the most recent word being sung/spoken is closest to the singer/speaker's mouth, while an older word that was previously sung/spoken is disappearing as previously described. In the various embodiments herein, the number of words remaining on the fan(s) at a given time can vary greatly. For example, as few as one (or even zero) words can be displayed (especially for slower paced songs), and at the high end, any number of words can be displayed before they disappear.

In one embodiment, and keeping with other principles of the embodiments above, the first display and a physically second display can be provided, wherein the first display comprises an LED panel, and the second display is positioned in proximity to the first display and is configured to render supplementary content such as synchronized lyrics or visual effects. In one embodiment, the second display may take the form of an LED display, ticker display, a light panel, a holographic fan, or any other display capable of rendering animated or textual content. In one embodiment, the primary and second displays are not physically joined into a single seamless display surface, but rather are treated as separate image planes with distinct coordinate spaces and display characteristics. In one configuration, the second display is physically distinct from the first display but positioned in close adjacency (e.g., below, beside, partially in front of, or partially behind the first display), such that it visually appears to extend the primary image space. The viewer perceives a directional flow of lyric content from the main display toward the secondary surface. Although the displays are housed separately, their spatial relationship is fixed, allowing for coordinated animation of lyrics that move fluidly between display boundaries. In one embodiment, the second display is structurally independent—not mechanically coupled to the primary display—but is visually aligned in such a way that projected text appears to follow a continuous path across both surfaces. The lyric animation is rendered with transitional motion graphics, such as blur, trailing particles, light rays, or motion scaling, that create the illusion of uninterrupted movement even though the lyric passes from one image plane to another.

In one embodiment, although the displays are not part of a shared coordinate space or image surface, they are nevertheless synchronized in time and logic via software. The lyric content is divided into segments, with one portion rendered on the LED display and a corresponding continuation rendered on the second display, such that the viewer perceives a continuous semantic and temporal flow of the lyrics across the two surfaces. The software controller applies timing adjustments, visual warping, scaling, and animation cues to ensure a perceptually smooth transition, even in the presence of gaps, bezel boundaries, or display misalignment.

In one embodiment, visual continuity can be achieved not through perfect geometric alignment, but through perceptual design principles—such as blinking of images, rhythmic timing, distortion effects, and controlled motion—that allow minor discontinuities to be visually pleasing.

In any of the above embodiments where lyrics are generated to be at or in proximity to the performer's mouth or emanating from the performer's mouth, the system may instead include a superimposed graphic of a loudspeaker—such as a stylized loudspeaker or amplifier—placed within or composited on top of the video scene. The loudspeaker graphic is positioned to correspond to a natural sound-emitting location within the video frame, and may appear mounted on the stage, floating in the foreground, or embedded in the background. Lyric content is rendered as if it emanates directionally from the visible speaker element, instead of or in addition to the performer's mouth along a path that corresponds to the orientation of the speaker cone or projected axis of sound. From the various embodiments, it can thus be appreciated that the performer's mouth, an image of a loudspeaker on a display, or a physical loudspeaker, can be configured by the computer system to be the visual original of the lyrics, and the lyrics can be shown on a display as originating from, emanating from and/or be directionally projected from such visual origin (e.g., in the direction that the visual origin appears to be pointing or directed). It should thus be appreciated that the “visual origin” can be the performer's mouth, face, microphone, or loudspeaker, whether these elements are physical or rendered/represented on a display.

In one embodiment, the lyrics may appear to pulse, project, or burst outward from the speaker graphic in rhythm with the music, and are animated to move toward and across the first display area. In one embodiment, as with some of the previous embodiments, the lyric elements can continue their animation onto a second display surface, where they may persist, animate, disappear, etc., as discussed previously. The use of a speaker graphic as the origin of lyric projection allows the system to decouple the visual source of lyrics from the artist's mouth.

In another embodiment, the physical audio speaker used to project the audio portion of a music video, on just an audio song playback without a music video, is coupled with a physically adjacent display surface—such as a small LED panel, segmented display strip, etc. configured to display lyric content in synchronization with the audio output of the speaker. The lyric display is mounted directly beside, above, or surrounding the speaker housing, such that it appears to emit lyrics from the speaker in tandem with the audible music, creating a localized and immersive audio-visual effect.

The system synchronizes the timing of the displayed lyrics with the audible lyrics produced by the speaker using a timing controller, audio waveform analysis, or predefined lyric timestamp metadata. The displayed lyrics may appear to pulse, scroll, or project outward in rhythmic alignment with the audio, and may follow a path or style corresponding to the direction of the speaker's sound output (e.g., forward, upward, or radial from the speaker cone). The lyric display may be independent from the primary video display (in one embodiment, no primary video display is provided), and may optionally be coordinated with additional display surfaces to create a multi-point lyric visualization environment. Such configuration allows the lyric display to serve as a visual extension of the sound source, providing a coupled, localized expression of lyrics that aligns with human perception of spatialized sound coming from physical speakers forming part of an audio system 1520.

In another embodiment, the audio system 1520 comprises multiple discrete speaker units, each responsible for projecting different components of a song's audio mix. One speaker is configured to play an isolated vocal track or a vocals-emphasized audio channel, while one or more additional speakers project the instrumental tracks or the complete stereo mix of the song, which may optionally include background or faint lead vocals. The separation of the vocal audio allows for improved clarity, spatial differentiation, and dynamic emphasis on the lyrical content. In one embodiment, a lyric display is physically or visually adjacent to the vocal-isolated speaker, and is synchronized to display lyrics in alignment with the audible vocal performance. The system provides for the displayed lyrics to be temporally aligned with the vocal output, either through pre-timed recording or metadata, or real-time audio processing. In one embodiment, the lyric display may be located adjacent to the vocal speaker so as to match the origin and directionality of the audible lyrics based on the acoustic source with the origin and direction of the visual lyrics projected by the display lyrics. This configuration allows for a directional projection of lyrics that matches the acoustic presence of the vocals, enabling a listener to intuitively associate the text with the sound source. It should be appreciated that all the teachings of the various embodiments that are relative to this embodiment apply equally to this embodiment as well.

It should thus be appreciated, therefore, that this embodiment with the physical speaker also applies to live performances as discussed with respect to embodiments where a display is configured to display lyrics dynamically in a live environment (e.g, as in FIG. 1, for example). In this embodiment, however, as one or more speakers may be stationary, there may not be a need to dynamically track the audio source as might be done by tracking the location of a live performer's mouth. Thus, in one embodiment, a live performer can perform without being tracked, and the lyrics display will appear to generate lyrics as emanating from one or more speakers. For example, in FIG. 1, a loudspeaker can be positioned in front of the display 2110, and the computer system (of FIGS. 13-15) can be configured to display the lyrics 2100 such that they originate at a position of the display 2110 such that they appear to emanate from the speaker. The computer system can be configured to synchronize the audio output from the speaker with the visual lyrics being output on the display 2110 to move or project the lyrics on the display in a direction in which the speaker appears to be directed.

In any of the embodiments herein, the lyrics 1420 can optionally be presented in a white, red, yellow, or green font, for example. Where a holographic fan or transparent OLED is used for the lyrics 1420, the lyrics will have no background color generated by the display (for example a transparent or black), and thus, the regions surrounding the lyrics on the holographic fan or transparent portions of a transparent OLED display will be essentially invisible on the display, making the lyrics 1420 appear to be floating in air as they are presented (e.g., as they scroll or otherwise display in chunks) on the display. In one embodiment, the lyrics or wording/lettering of a song will be the only image displayed on a display. For example, in one embodiment, the lyrics (letters and words) are the only thing that are presented by the image generated by the one or more fan(s), with no other pictures, depictions or graphics accompanying it. In another embodiment, the words/lyrics displayed on transparent portions of a transparent OLED display can be the only image generated within these portions, with no other pictures, depiction or graphics accompanying it. The effect makes the lyrics appear to be floating in air.

In one embodiment, for a fan display, the entirety of the lyrics are presented on the fans, without any of the lyrics being positioned on the first display 2200. In one embodiment, for a transparent OLED display, the entirety of the lyrics are presented on the transparent portions of the display, without lyrics positioned on the backed portions of the display.

In one embodiment, the lyrics are displayed in white color against a black or transparent background. In another embodiment, they are displayed in yellow. In another embodiment, they are displayed in red. In another embodiment, they are displayed in green. In one embodiment, the lyrics displayed on the display will correspond to the sound of lyrics from the song. In other words, when the sound of a lyrics is played, that lyric will be synchronously visible on the display. The lyrics displayed will change so that it is visible in advance of any lyric sound (word) being played. This can be done by scrolling the lyrics, or presenting them in sequential chunks. In one embodiment, the particular word or phrases being sung in the song will be sequentially highlighted into a different color within the visible lyrics displayed on the display, whether the words are being scrolled or chunked. In one embodiment the lyrics start out as one color and changes to another as it is played in the audio file. For example, in one embodiment, just for example, the lyrics start out white and change to red as the lyrics in the audio file are played. In another embodiment, the displayed lyrics start red and change to white. In one embodiment, all synchronization is controlled by the controller (e.g., the computer system).

It should be appreciated that any of the embodiments herein can optionally employ the synchronization and deployment strategies discussed above, such as described in connection with the FIGS. 12-15 and its associated components. In one or more embodiments, the controller 1010, which may include one or more processors 1460, internal (volatile and/non-volatile) memory 1462, input/output/network interfaces 1468, and software modules 1466, is responsible for managing the synchronized playback of primary and secondary videos along with lyric presentation across multiple display devices. In one embodiment, the controller 1010 orchestrates data retrieval, processing, synchronization, and rendering across interconnected hardware components to ensure seamless playback and accurate timing.

In an embodiment according to a method, a display (e.g., one or more LED, transparent OLED and/or fan displays) are placed in an environment or setting that is illuminated with ambient lighting, such as ceiling lights in an indoor commercial setting, room, or venue, and the blades commence rotating with no image thereon, either with no image being transmitted to the LEDs or a transparent or black image being transmitted to the display. The lights within the room are configured to provide the room or environment with an illumination level of up to 500 lux. In one embodiment, the lighting in the room commences at a level of between 10 lux to 200 lux). In one embodiment, the room commences at an illumination level of between 15 lux to 50 lux. As a next step, the ambient lights are switched off or dimmed by a light switch. In one embodiment, they are turned off instantly, while in another embodiment they are slowly dimmed until they are turned off or lowered to a low illumination level within the environment. In one embodiment, the lights within the setting or venue are coordinated with the environmental setting (e.g., distance from the controlled lights, any stray light (not controlled), etc., such that illumination within the environment is lowered to an illumination level that is between 1 to 30 lux. In another embodiment, the lights are lowered to an illumination level between 1 lux to 10 lux. In another embodiment, the lights are lowered to an illumination level between 1 lux to 5 lux. After the lowering of the illumination level commences, or after the lowering of the illumination level is completed, the controller will commence a song. In one embodiment, the sounds of the song will commence before anything visual will appear on the display. In one embodiment, the first word appears in sync with the performer appearing in the video to be vocally expressing it. In one embodiment, the initial words of a song will appear on the display momentarily before the first words of the song are played. In one embodiment, the words will appear no more than 3 seconds before the first words of the song is played. In one embodiment, the lyrics are presented on a display in the form of one or more holographic fan(s). In one embodiment, the lyrics are presented on a non-backed portion of a transparent OLED display. In one embodiment, each word being sung will be displayed synchronously (withing +/−0.2 seconds) with it being generated by the performer. In one embodiment, multiple fans will create a larger display size of the lyrics by stitching different visual portions of the lyrics together as will be understood by other portions of this disclosure.

In one embodiment, different portions of the lyrics (e.g., whether chunked or scrolling) appear on different fans that are separated initially with no overlap between fan blades, and the fans are then moved closer together as described elsewhere in this specification so that the lyric portions are stitched to be readable together as a full chunk or scrolling lyric display. In any case, in one embodiment, the lyrics of the song will play throughout the song, and at the conclusion of the song, the lyrics will discontinue being displayed and the ambient lights will be turned back up to their original illumination level.

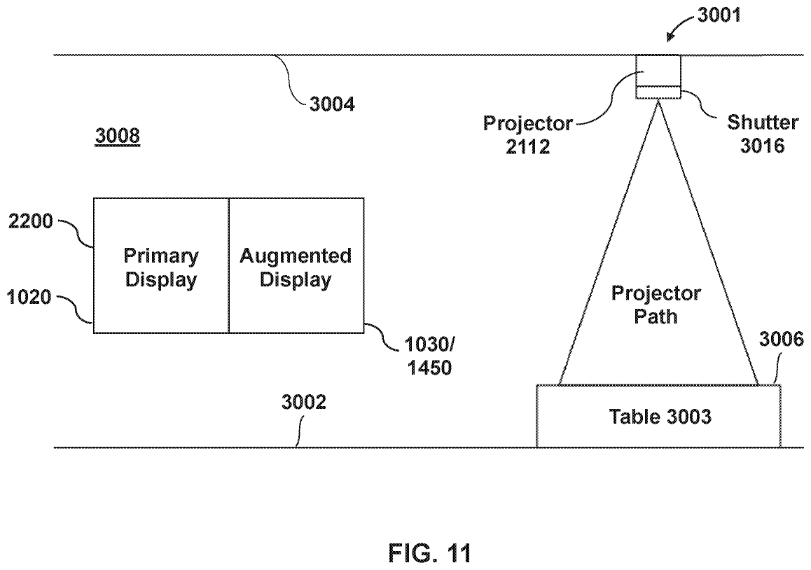

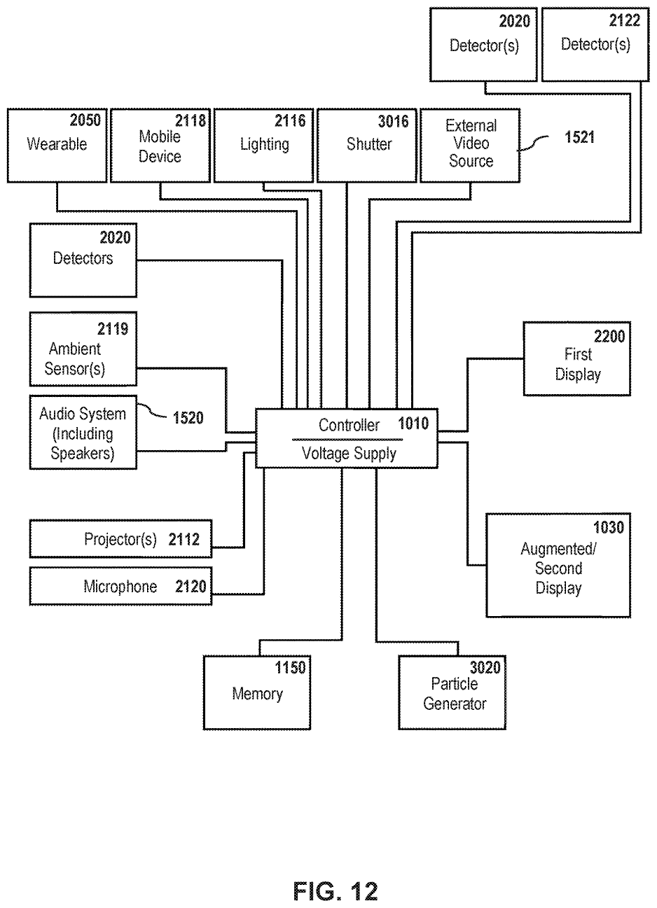

In another embodiment, as shown in FIG. 11, a projection-mapping system 3001 is provided that enables visual content (e.g., image, video, etc) to appear as though it appears on a table 3003 in a venue. In one embodiment, the content transitions from a first display 2200, such as an LED video wall, to one or more auxiliary or augmented displays 1030, 1450, and then onto a top surface (e.g., horizontal surface) 3006 of a table 3003 (or multiple tables via multiple projectors) within a venue. The image may be anamorphic or non-anamorphic, and in one embodiment may be a Holographic Human 1485, lyrics, or other animated object. For example, the image can be rendered on the first display 2200 and then made to appear to move from (or jump off) that display onto an augmented display, such as a holographic fan, transparent OLED panel, or LED mesh (e.g., 1030 and/or 1450). The first display 2200 and augmented display 1030 may be mounted on a vertical wall 3008 in the venue. In one embodiment, from there, the image can appear to leave the augmented display 1030 and land on one or more physical tables 3000 sitting on the floor 3002. The table projections are accomplished through one or more ceiling-mounted projectors 2112 configured to projection-map the image onto the top surfaces 3006 of designated tables (which can be considered part of the projector “display”). Thus, for example, the embodiment of FIG. 11 can be an enhancement of the embodiment of FIGS. 5A-5C and/or the embodiment of FIGS. 6-9, wherein after a character moves from the first display 2200 to the augmented display 1030, it can then transition to the projection mapping system 3001 and appear on the table top 3006.

In one embodiment, the projectors 2112 are structurally mounted above the tables 3000, such as attached to a venue ceiling 3004, and are operatively connected to the computer system 1000 and/or system controller or processor 1010. The controller or processor 1010 coordinates the rendering pipeline so that as the image leaves the augmented display 1030, 1450, the projectors 2112 illuminate the upper table surface 3006. A projection mapping module implemented in software within or in communication with the controller 1010, precomputes or dynamically calculates the geometry of the tables 3000, including surface dimensions and orientation, and warps the projected imagery to align precisely with the physical table top. As a result, the image appears to have physically jumped from the augmented display and landed on the table.

In another embodiment, the image may then be animated to jump from the table 3003 back to an augmented display 1030, 1450, and from there to the primary LED display 2200. In yet another embodiment, the image may transition directly between the first display 2200 and the table surface 3000 without appearing first on an augmented display. In this way, the image appears to move back and forth between different physical and digital surfaces within the environment, creating a continuous and immersive sequence of motion across the first display 2200, augmented displays 1030, 1450, and the table surfaces 3000.

The projection-mapping system includes both hardware and software components. In one embodiment, on the hardware side, the system comprises one or more high-brightness projectors 2112 mounted to the ceiling or overhead structures in the venue. In some embodiments, each projector 2112 is provided with a dedicated lens system capable of short-throw or ultra-short-throw projection to substantially cover individual tables without projecting onto surrounding floor. In another embodiment, a shutter 3016 or other optical gate may be positioned within the projector or externally to control when light reaches the table surface. Each projector 2112 is connected to the controller 1010 through wired or wireless connections (e.g., HDMI, DisplayPort, or IP-based networked streaming). On the software side, the projection mapping module computes the correspondence between digital content and the three-dimensional geometry of the tables 3000. This may be accomplished by scanning or pre-measuring table positions, or by using depth-sensing cameras to detect the table geometry in real time. The module generates a warping transform for each projector so that the rendered image aligns seamlessly with the table surface 3000 when displayed.

The timing and sequencing of the table projection are managed by the controller 1010 in synchronization with the first display 2200 and augmented displays 1030, 1450. In one embodiment, the projector 2112 may already be illuminating the table surface 3000 prior to the image transition, with a faint ambient projection that makes the table appear active before the image arrives. In another embodiment, the projector 2112 output is blocked until the moment of transition, such that the table remains unlit until the character appears on it. This may be accomplished by the shutter 3016, an electro-optical filter, or by electronically gating the projector output under control of the controller 1010. By controlling when the projection light is permitted to reach the table 3003, the system can emphasize the illusion of the image jumping from one display surface to another.

In one embodiment, the controller 1010 maintains a shared synchronization clock across the first display 2200, augmented displays 1030, 1450, and the projectors 2112. As the image reaches the boundary of the primary or augmented display, the controller 1010 triggers the projector 2112 output to commence, such that the image appears on the table 3003 at precisely the right moment in time. In another embodiment, the system may preload frames of the projected image into a buffer 3022 within the projector 2112 so that the imagery can be presented with minimal latency once the shutter 3016 opens or once the controller 1010 issues a timing command.

In some embodiments, the image presented on the table 3003 is animated to interact with the table surface itself, such as walking across the table, bouncing, or appearing to hide behind physical objects placed on the table. In such cases, the projection mapping module 3012 may incorporate object detection to dynamically adapt the image to the environment. After such interaction, the controller 1010 may then animate the image to jump back to the first display 2200 or to an augmented display 1030, 1450, maintaining temporal continuity across all display devices. In one embodiment, the projection mapping system (including components thereof) can be considered to be the third display 1450 (separate from the augmented display).

In one embodiment, when transitioning a visual character from the primary or secondary display to a table top display, or between any physically separate displays for that matter, a further enhancement can optionally be included in which a projection mapped image of the character appears on a particle background during the transition. To aid in the illusion that the character is moving from one display to a physically separated one a particle “bridge” display can be used to create the illusion that the character is moving from one display to the spatially separated other display. Specifically, particles may comprise water vapor, or other vaporized particles such as glycol-based, glycerine-based, oil or mineral oil based, resin-based, and/or carbon-dioxide based vapor or haze that is generated by smoke, haze, and/or fog machines, generically referred to herein as a particle generator 3020. In one embodiment, the particle generator can be activated by the controller 1010 at an appropriate time or timestamp (e.g., as determined by MIDI Timecode (MTC) signals generated by DAW sequencing software). For such bridge display, a video or image projector may be mounted in any location (ceiling, wall, etc.) so that the light projecting therefrom impinges upon the particles at a desired angle such that light reflected by the particles (which act as a display display) are visible to the audience in a manner that bridges the gap between displays (although the bridge need not be continuous, in some embodiments it can be). In various embodiments, the particle bridge display can be located between two or more vertically mounted displays, two horizontal displays (e.g., table tops), or a combination thereof (e.g., between a vertical display and horizontal display of any of the various types of displays disclosed herein.

In the embodiments described herein, different types of control and power systems can be used, is shown and described for managing all functional units within the system. These functional units include, but are not limited to, displays, light sensors, voltage controllers, power sources, and any additional components such as motors or actuators, for example.

In one embodiment, the computer system 1000 and/or controller includes hardware capable of rendering any holographic content (e.g., holographic video content) for the holographic display forming part of the system, any non-holographic content (e.g., video content), and capable of operating software to manage data communication, decoding, and display of video streams to the various devices. The system may include one or more wireless network interface card(s) that allow the display device to connect to a wi-fi network and may include a transceiver for sending/receiving data packets and an antenna for wireless communication. In another embodiment, one or more of these display devices includes an ethernet port to enable wired networking. In one embodiment, the controller of the system (see FIG. 12) includes a low-power processor that manages communication protocols, interprets commands, and processes data. In one embodiment, the memory (see FIG. 12), includes memory (e.g., RAM) that provides temporary storage for processing incoming and outgoing data packets as well as rendering content, and also include flash storage (e.g., eMMC or NAND) that stores the operating system and/or configurations for network communication.

In one or more embodiments, the memory (see FIG. 12) also comprises non-volatile storage (e.g., eMMC, SSD, and/or flash memory) to store content persistently (e.g., even when the device is powered off). The storage is managed by the device's operating system or firmware. When the device streams or downloads content, it temporarily stores/buffers the data in RAM. The content is then written to the device's internal storage if caching or saving is enabled. In one embodiment, along with the content, the device saves metadata (e.g., file name, format, playback position, encoding details), which allows the system to identify and retrieve the content efficiently during subsequent use.

In one embodiment, a mobile device 2118 (see FIG. 12) can be downloaded with a software program (e.g., a mobile app) to provide a user interface for controlling and managing one or more of the display devices. The software can include features for accessing content stored locally on the mobile device, or from cloud-based servers via an internet connection, or can be used to access content stored locally in non-volatile memory on the display devices.

In one embodiment, if content from a mobile device is cast to the display device(s), the software on the mobile device uses the local file path and encodes the video data (if necessary) in a compatible format. In one embodiment, the software can stream the video to the display using various protocols. If content stored in the cloud is cast to the display device(s), the software on the mobile device communicates with the cloud server over the internet using APIs to fetch video metadata and URLs, and content is streamed either directly from the cloud server to the display (e.g., holographic device) or via the mobile device acting as an intermediary.

In one or more embodiments, the computer system 1000 and controller 1010 (FIGS. 12, 13, and 14) may include various types of processors, including central processing units (CPUs), graphics processing units (GPUs), field-programmable gate arrays (FPGAs), and/or application-specific integrated circuits (ASICs). These processors can be configured to manage computational tasks such as rendering 2D or 3D content, synchronizing multimedia elements, and/or processing environmental inputs. In various embodiments, the memory (and storage) components can include volatile memory for fast processing and/or non-volatile memory such as NAND flash or solid-state drives (SSDs) for long-term content storage. These memory resources can be distributed across multiple subsystems, allowing for local caching and/or cloud-based content retrieval. It should be appreciated that the system illustrated in FIGS. 12, 13, 14, and/or 15 are depicted and described herein as a single, cohesive unit for simplicity and clarity of explanation, although it should be appreciated that the various individual components will be omitted, depending on the application and the intended viewing/listening experience.

In some embodiments, the system features both wired and wireless networking options, including, for example, Ethernet, Wi-Fi, 5G, Bluetooth, UWB and/or Zigbee, enabling seamless communication between system components, remote management, and/or cloud integration. The control processing can be centralized or distributed, where some subsystems perform localized control, such as adjusting lighting intensity or fan speed, while others can rely on cloud-based orchestration for complex decision-making, such as AI-driven content adaptation.

In some embodiments, peripheral interfaces connect with motorized actuators for fan speed and orientation control, power management circuits, and/or environmental sensors that monitor ambient conditions such as light levels, temperature, audience movement, and acoustic feedback. The architecture can be configured to allow all components to communicate dynamically, with input and output synchronization that can be selectively enabled or disabled based on the environment, preprogrammed content rules, or real-time sensor feedback. This enables adaptive multimedia experiences where holographic projections, audio, lighting, and/or other display elements react to user interaction or changing ambient conditions.

In one or more embodiments, the software framework manages content generation, device control, and/or real-time synchronization across various hardware subsystems. The system may include distributed processing and/or control logic that may be executed locally on embedded processors within individual components or in remote cloud-based servers that manage content distribution, synchronization, and/or real-time analytics.

In some embodiments, the controller facilitates communication between hardware components, managing fan speed, LED display parameters, audio playback, and/or environmental response mechanisms. A rendering engine forming part of the controller can be used for a high-performance graphics pipeline optimized for real-time 3D content rendering, supporting both pre-rendered assets and/or AI-assisted generative visuals.

In various embodiments, cloud-based and/or on-premises content management system (CMS) allows operators to update, schedule, and orchestrate multimedia playback remotely (e.g., with edge computing nodes available for low-latency response). The system may employ machine learning models to optimize visual and audio outputs, adjusting parameters such as frame rate, brightness, and/or audio spatialization based on real-world conditions.

In some embodiments herein, a synchronization engine can be used to enable precise timing mechanisms to align content playback across multiple devices, maintaining frame-accurate coordination between holographic displays, LED displays, augmented displays, OLED panels, lighting systems, and/or spatial audio. Synchronization may be achieved through network time protocol (NTP), GPS-based timing, and/or proprietary time-code algorithms for example.

In one or more embodiments, the system may include a web-based or mobile-accessible user interface that allows for manual control, real-time monitoring, and/or content scheduling, enabling direct manipulation of display parameters and/or system diagnostics. The control system allows for fully automated, semi-automated, or manual operation, meaning that content output can be preprogrammed, dynamically generated based on environmental feedback, and/or manually adjusted by an operator in real time.

In one or more embodiments, all or selected components within the system are configured to communicate bidirectionally, enabling synchronized or independent operation based on environmental conditions and content strategy. The system can operate in a fully synchronized mode, where all elements, including holographic fans, OLED displays, speakers, lighting, and sensors, work in tandem. Alternatively, it can operate in a modular mode, where certain elements function independently or in response to specific triggers.

Sensor data from one or more ambient sensors 2119 configured to measure crowd movement, audio levels, and/or ambient lighting, can be processed in real time to adjust display parameters dynamically. For example, brightness of any one of the components that are capable of illumination, or holographic fan speed, may be adjusted based on any environmental conditions (noise, sound, lighting, temperature, etc.).

In various embodiments, some decision-making processes and data processing can occur on local devices (e.g., the controller or on any of the components in communication with the controller) for low-latency responses, while other higher-order processing, such as AI-based content adaptation or predictive analytics, can be handled in the cloud or an edge computing node that can communicate wirelessly or in wired fashion with the controller. In some embodiments, when multiple holographic displays, transparent OLEDs, and/or audio systems 1520 are deployed in a venue, the system can ensure frame-perfect synchronization across all devices or allow each unit to operate autonomously based on its local sensor inputs.

In various embodiments, the system architecture supports different deployment models to accommodate various use cases and scalability requirements. An on-premises standalone deployment may consist of individual or networked devices running on local controllers with real-time processing. In other arrangements, a cloud-based deployment can be used to process and manage content remotely on cloud servers, enabling remote control, and content scheduling. In some embodiments, a hybrid deployment combines local edge computing and cloud-based orchestration to optimize performance, responsiveness, and centralized control.

In some embodiments, such as FIG. 12, and the herein descriptions with respect to the various software, hardware, functionality, communication, and interoperability, can be further or alternatively be understood with respect to the alternate embodiments discussed later in this disclosure in connection with the computer system 1000, illustrated in FIG. 13.

It should specifically be appreciated that for some embodiments, each of the described holographic displays and/or holographic fans can be substituted with other transparent or semi-transparent augmented displays as will be described herein.

FIG. 13 illustrates a computing system 1000 that, in one or more embodiments, can optionally be used as the controller illustrated in FIG. 12, be used in place of the controller illustrated in FIG. 12, or can incorporate the controller of FIG. 12, and should be appreciated as such when these elements are referred to throughout this disclosure. In various embodiments, the computing system 1000 may include one or more controllers or processors 1010 (e.g., processors 1010a-1010n) coupled to system memory 1150, an input/output I/O device interface 1032, and a network interface 1040 via an input/output interface. A processor may include a single processor or a plurality of processors (e.g., distributed processors). A processor may be any suitable processor capable of executing or otherwise performing instructions. A processor may include a central processing unit (CPU) that conducts program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1150). Computing system 1000 may be a uni-processor system including one processor (e.g., processor 1010), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1032 may provide an interface for connection of one or more I/O devices 1060 to computer system 1000. I/O devices may include any devices disclosed herein that receive input (e.g., from a component and/or a user) or generate output (e.g., to a component and/or a user). I/O devices 1060 may include, for example, graphical user interface presented on any type of user interface display, pointing devices (e.g., a computer mouse or trackball), keyboards, keypads, touchpads, scanning devices, voice recognition devices, gesture recognition devices, printers, audio speakers, sensors, motors, display panels, holographic displays, video or image projectors (also considered a type of display), content sources, microphones, cameras, vacuums, or the like as described in connection with any of the embodiments in this disclosure. Thus, the I/O devices can be any one or more of the I/O devices or systems shown in FIG. 12 and/or otherwise described herein. The I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1150 (multiple different types, numbers, and locations of memories may be provided) may be configured to store program instructions 1100 or data 1110. Program instructions 1100 may be executable by a processor 1010 (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1150 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1150 may include a non-transitory computer readable storage medium that may have program instructions stored thereon that are executable by a computer processor 1010 (e.g., one or more of processors 1010a-1010n) to cause the subject matter and the functional operations described herein. A memory (e.g., system memory 1150) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

An internal I/O interface may be configured to coordinate I/O traffic between one or more 1010 (e.g., processors 1010a-1010n), system memory 1150, network interface 1040, I/O devices 1060, and/or other peripheral devices. Such internal I/O interface may perform protocol, timing, or other data transformations to convert data signals from one component (e.g., system memory 1150) into a format suitable for use by another component (e.g., processors 1010a-1010n). The I/O interface may include support for devices attached through various types of peripheral buses, such as a variant of the Peripheral Component Interconnect (PCI) bus standard or the Universal Serial Bus (USB) standard.

In other embodiments, the computer system 1000 of FIG. 13 can further incorporate the additional devices and/or software described with respect to FIG. 14. The computer system 1000 of FIG. 15/16 can be used in conjunction with any of the above-mentioned display types for synchronized audiovisual playback across multiple output devices. In one embodiment, the controller 1010 of the computer system 1000 has an internal memory 1462 and can interface with an external memory 1150 (e.g., see the embodiment of FIG. 14).

As shown in FIG. 14, in one embodiment the system comprises a first display device 2200 configured to present a media file or media content comprising an audiovisual performance depicting an artist performing a musical work. In such embodiment, the system further comprises a second display 1030 configured to present lyrics corresponding to audio content associated with the audiovisual performance, and an audio output device configured to render the audio content. The system may also include one or more storage devices 1150 storing (i) the media file, (ii) lyrics content, and (iii) the audio content; and a controller 1010 comprising at least one processor and memory storing instructions that, when executed by the at least one processor, cause the controller to (a) retrieve the media file, the lyrics content, and the audio content from the one or more storage devices, (b) initiate synchronized playback of the media file on the first display device, the lyrics content on the second display device, and/or the audio content on the audio output device, and (c) render the lyrics content on the second display device in time-alignment with the playback of the media file or the audio content.

In some embodiments, the controller shown in FIG. 12 corresponds to the same control structure described with respect to computer system 1000 of FIG. 13 and the processor 1010 of FIG. 14. For example, the functions attributed to the controller in FIG. 12 may be executed by one or more processor 10101 (or processors 1010a-1010n) of the computer system 1000, operating in conjunction with memory, program instructions, and other components as illustrated in FIGS. 15 and 16. Thus, the controller of FIG. 12 may be embodied in the same underlying hardware and software resources as the processors and controller described in FIGS. 15 and 16.

It should also be noted that the block of FIG. 12 is labeled “Controller/Voltage Supply” to reflect that, in some implementations, the control electronics and the power supply for the visual display system may be packaged together or otherwise co-located. In other implementations, however, the voltage supply is a distinct subsystem, and the controller corresponds only to the processing and control functionality described with reference to FIGS. 15 and 16. Accordingly, references to the controller in FIG. 12 should be understood as encompassing the controller 1010 and its associated processors as shown in FIGS. 15 and 16, while the voltage supply represents a different component that may be integrated or standalone depending on the embodiment.

In one embodiment, the computer system 1000 will generate a primary video on a first display, the primary video being a video depicting an artist playing a song, and a secondary video on a second display, the secondary video depicting the lyrics of the song. The system further provides audio output (e.g., via a speaker), wherein the primary video of the first display, the secondary video on the second display, and the audio output are synchronized such that system enables the user to consume the audio file while optionally viewing the first display presenting the artist playing the audio file and/or the second display presenting the lyrics of the audio file.

In another embodiment, the computer system 1000 provides for synchronized audiovisual playback across multiple output devices is provided and comprises a first display device configured to present a media file comprising an audiovisual performance depicting an artist performing a musical work, and a second display device configured to present a secondary video corresponding to audio content associated with the audiovisual performance. The system further comprises an audio output device configured to render the audio content, and one or more storage devices storing (i) the media file, (ii) the secondary video, and (iii) the audio content. The system further comprises a controller comprising at least one processor and memory storing instructions that, when executed by the at least one processor, cause the controller to (a) retrieve the media file, the secondary video, and the audio content from the one or more storage devices, (b) initiate synchronized playback of the media file on the first display device, the secondary video on the second display device, and the audio content on the audio output device, and (c) render the secondary video on the second display device in time-alignment with the playback of the media file or the audio content.

In one embodiment, the computer system 1000 enables the continuous playback of a full-length primary video 1200 while dynamically switching the second display 1030 between rendering filler content 1070 and playing a secondary video 1210 at predefined time intervals corresponding to specific song segments within the primary video 1200, as will be described. It should be appreciated that any one or more of the displays disclosed in this embodiment (e.g., displays 2200, 1030, and/or 1450) can optionally be any one of the different displays previously described above or below.

In one embodiment of FIG. 14, the computer system 1000 does not utilize real-time audio analysis or dynamic detection. Instead, it operates using predefined timestamp mapping 1220, where the timing of key musical segments (e.g., chorus, hook) is pre-identified and stored in a database or configuration file 1230. These predefined timestamps 1220 determine when the secondary video 1210 is triggered for playback, ensuring precise synchronization between the primary video 1200 and the secondary video 1210 without computational overhead from real-time audio analysis. As used herein, the primary video 1200 can also be considered primary media 1200, media content 1200, or a primary media file 1200, and the secondary video can likewise be considered secondary media 1210 or secondary media file 1210.

The system 1000 includes a media playback engine 1480. In one embodiment, the playback engine 1480 is responsible for one or more of the following: Loading and playing a full-length audiovisual media file (primary video 1200) without interruption on a first display device 2200, extracting metadata from the primary video 1200, and/or maintaining an internal playback clock 1250 that continuously tracks the current presentation timestamp (PTS) of the primary video 1200.

In one embodiment, the primary video 1200 is played without modification or interruption on the first display 2200. In one embodiment, the Playback Module 1320 can be used for the secondary video and is responsible for storing, loading, and playing secondary videos 1210 at predefined timestamps 1220, and/or ensuring seamless synchronization between the secondary video 1210 and the primary video 1200.

In another embodiment, the secondary video 1210 is an independent video or audiovisual file that is of the same length as the primary video and plays alongside it. For example, the secondary video 1210 can comprise lyrics content 1420 and can be a lyrics video.

In one embodiment, the secondary video 1210 is an independent video or audiovisual file (e.g., 5 to 30 seconds long) that corresponds to a specific predefined segment (hook, chorus, or repeat pattern) in the primary video 1200. In one embodiment, the secondary videos 1210 are pre-mapped to one or more timestamps 1220 within the primary video 1200 before playback begins. In one embodiment, the entire secondary video 1210 is played each time the corresponding timestamp 1220 is reached. In one embodiment, the system 1000 supports multiple playback modes for repeated segments. For example, in a Fixed secondary video Mode, the same secondary video 1210 plays every time the segment occurs. In a Rotational Mode, the system 1000 cycles through different secondary videos 1210 assigned to the same segment (e.g., the same hook or chorus of the audio file that may be embedded in the primary video 1200). In a Manual Pre-Selection mode, the user can pre-assign specific secondary videos 1210 to each occurrence of the predefined segment.

In one embodiment, the media playback engine 1480 ensures that all secondary videos 1210 are preloaded into memory 1150 before the corresponding timestamp 1220 is reached to minimize buffer delays. In one embodiment, a Timestamp Mapping Module 1270 is provided and is responsible for defining and managing the pre-identified timestamps 1220 in the timestamp module that determine when secondary videos 1210 should be played.

In one embodiment, the storage device or memory 1150 can be RAM, flash, SDD, and/or buffer device, which is configured to contain a predefined mapping file or database 1230 that contains timestamp data 1220 for each primary video 1200. In one embodiment, the mapping file or database 1230 can include a primary video ID (unique identifier for the primary video 1200), a timestamp list (list of predefined timestamps 1220 where a secondary video 1210 should play), and associated secondary video(s) 1210 for each timestamp 1220. In one example, a timestamp mapping file is in JSON format.

In one embodiment, timestamp preloading and event scheduling is performed. Specifically, upon loading the primary video 1200, the computer system 1000 preloads the timestamp mapping data 1220 into an event scheduler 1290. In addition, in one embodiment, the event scheduler 1290 queues up playback events and preloads the corresponding secondary videos 1210 a preset time period (e.g., 5 to 15 seconds) before the timestamp 1220 occurs to prevent latency issues.

In one embodiment, the mapping file or database 1230 is stored in external memory 1150 or memory 1462, internal to the controller. For simplicity purposes, the figures illustrate it in external memory 1150. The mapping database 1230 may include timestamp data 1220 associated with one or more primary videos, where each timestamp is mapped to one or more secondary videos or synchronization events. The timestamp data 1220 may be structured within the mapping database 1230 and accessed by the controller during playback. An event scheduler 1290 may be implemented within the controller, for example, as a software module executed by one or more controller processors or as part of the controller's firmware. The event scheduler 1290 may initialize and manage a real-time event loop, using a playback clock internal to the controller, to compare current playback timestamps with the stored timestamp data 1220 in the mapping database 1230 and trigger corresponding synchronization actions. While the mapping database 1230 and timestamp data 1220 reside in memory accessible by the controller, the event scheduler 1290 operates within the controller to process the data and initiate playback events with low latency and precise timing.

In one embodiment, the media playback engine 1480 controls the real-time playback and switching between filler content 1070 and secondary videos 1210 on the second display 1030.

In one embodiment, the primary video 1200 may be stored in memory 1150 and rendered for visual playback on first display 2200. The secondary video 1210 may likewise be stored in memory and rendered on a second display 1030. In some embodiments, a lyric video 1420 may be separately stored and displayed on a third display 1450 (or optionally on the second display 1030). Each of these video elements—primary video 1200, secondary video 1210, and lyric video 1420—may be represented within memory as distinct video files and rendered on their respective display devices for synchronized or coordinated playback. To illustrate this, reference numerals 1200, 1210, and 1420 may be shown in association with both the memory components and the corresponding displays, indicating that each media file may exist in memory as stored data and may also appear as a rendered visual output on a display device. Additionally, audio content 1062 may be stored in memory, either independently or as part of one or more of the video files (1200, 1210, 1420), and may be decoded and output through an audio output device (e.g., one or more loudspeakers) 1050. Reference numeral 1062 denotes audio content, whether stored in memory 1150 as an audio file or retrieved for playback as an audio signa. In various embodiments, reference numeral 1062 refers to the same logical audio content across storage, transmission, and playback contexts. may likewise be used in both the memory representation and the audio output path to indicate its presence in storage and its use during playback.

It is important to note that, in some embodiments, as will become more apparent later in this disclosure, the primary media file and the secondary media file 1210 may be the same file. As used herein, the “primary media file 1200” and “secondary media file 1210” identify the roles of media presented. This will be described in more detail later.

It should be appreciated that in some embodiments the computer system 1000 will incorporate the controller of FIG. 12 (e.g., as a controller and/or processor) and any one (or all) of the connected components.

The term “lyrics” or lyric “chunk(s)” as used herein should be understood to encompass even a single word. For example, in the song Hallelujah, it may be just the word Hallelujah that is being shown on a display. It should also be appreciated that the term “lyrics” as used herein is also intended to refer to words that need not be sung. For example, in one embodiment, the system can use the fan(s) to project words of a famous speech (such as Martin Luther King's “I Have a Dream,” synchronized with the sound recording while another display (such as an LED display) provides a video of the speech.

The term “lyrics” or “lyrics content” should also be understood to refer to the textual and/or visually perceptible representation of words, phrases, or vocal utterances that correspond to spoken or sung portions of a musical or audio work. The lyrics may include actual words, phonetic approximations, repeated syllables, or expressive utterances (e.g., “la-la-la,” “uh-huh,” “ooh”). Lyrics may be stored or presented in any suitable form, including as a separate file, structured text files, caption streams, rendered video, and/or pre-recorded or dynamically generated visual overlays. Lyrics can also be generated in real time by a performer.

The term “lyric video” may be used as an example of lyric content output; however, it should be understood that lyrics may be stored, rendered, and presented through various technical implementations beyond a pre-rendered video. In the figures and detailed description, reference numeral 1420 is used for simplicity to denote both lyric content stored in memory (e.g., lyric “content”) and the output or display of that content (e.g., lyric content “output”). Lyric content output may include, for example, dynamically rendered text, real-time synchronized subtitles or captions, scrolling lyrics, highlighted or stylized text, or other forms of synchronized on-display lyric presentation. These outputs may be generated by a text rendering engine, markup interpreter, video, or other device-specific display logic. Accordingly, the terms “lyrics,” “lyric video,” and “lyric content output,” as used in this specification, should be interpreted broadly to include any such implementations of displaying lyric content, whether pre-rendered or dynamically generated. It should also be understood that the terms “lyrics” and/or “lyric video” can broadly refer to such media either as stored in memory or as rendered on a display.

For purposes of simplicity in the figures and description, the same reference numerals are sometimes used to represent both the stored and rendered versions of certain media content, as context will make apparent. Specifically, for example, reference numeral 1200 is used to denote primary media content (e.g., a primary video) as stored in memory, as well as primary media as rendered and output to a first display device 2200. Similarly, reference numeral 1210 is used to refer to secondary media content (e.g., secondary video) stored in memory 1150, and to secondary media 1210 as rendered on a second display 1030. It should be understood that while the same reference numerals are used for both stored and rendered instances, the context in which it used distinguishes whether the media is being described as data stored in memory or as audiovisual content being presented on an output device (or both). This convention is intended to streamline the drawings and description and does not imply that the stored and rendered instances are physically or functionally identical.

In some embodiments, lyrics content 1420 may also be presented as part of the filler content 1070 described herein. However, unless explicitly stated otherwise, filler content 1070 is generally distinct from short-form media clips and may include mirrored visuals of the primary video, ambient displays, or lyric-only renderings. In one embodiment, a bouncing cursor or highlighted text effect follows the currently sung words. In one embodiment, transition effects between words or phrases of the lyrics can be used, such as fade-ins, wipes, or animated text can be used to improve readability.

In one embodiment, the first display 2200 plays the primary video 1200 without modification or interruption. In one embodiment, the second display 1030 can optionally function in different ways or modes. For example, in one embodiment, the second display 1030 has a default state that comprises a Filler Mode. In this Filler Mode, the second display 1030 displays either a blank display, a lyrics video (corresponding lyrics to the video on the first display, or a mirrored rendering of the primary video 1200. Then, when a predefined timestamp 1220 is reached, the secondary video Playback Module 1320 is activated to overlay the secondary video 1210 onto the second display 1030. Then, after the secondary video 1210 finishes, the second display 1030 reverts to Filler Mode.

It should be appreciated that, as used herein, the term “filler content” or “filler video” 1070 refers to any content that may be displayed on the second display 1030 other than a short-form media clip (e.g., a TikTok or Reels clip). Thus, for example, the filler video 1070 can be a synchronized lyrics video, a mirror image of the primary video 1200, or any video other than the short-form media clip.

In one embodiment, to achieve smooth transitions, the system 1000 uses a layer-based video rendering pipeline. Specifically, for example, for layer 1, the primary video 1200 is always visible on the first display 2200, for layer 2, the secondary video 1210 is rendered on the second display 1030 only at specific timestamps 1220; and for layer 3, filler content 1070 is shown on the second display 1030 when no secondary video 1210 is active.

In one embodiment, a Playback and Switching Logic Module 1320 controls the execution of playback events based on the Timestamp Mapping Module's 1270 data 1220. Specifically, in one embodiment, an Event Scheduling System 1290 initializes a real-time event loop that monitors the primary video's 1200 playback timestamp using the internal playback clock 1250 and compares it with the preloaded timestamp mapping data 1220. When the playback timestamp reaches a predefined secondary video 1210 trigger point, the system 1000 instantly switches the second display 1030 from Filler Mode to secondary video 1210 playback mode. In one embodiment, the system 1000 ensures frame-accurate synchronization by aligning the secondary video 1210 start time with the primary video 1200 timestamp. In one embodiment, the system 1000 then allows the secondary video 1210 to play in full before reverting back to Filler Mode. Although the playback and switching module 1320 and the media playback engine 1480 are illustrated and described as separate components within the controller 1010, it should be understood that these elements may be implemented as a single, integrated unit. In certain embodiments, the functionality of the playback and switching module 1320—such as routing media content, selecting display outputs, or managing transitions—may be performed by the media playback engine 1480. Conversely, the media playback engine 1480, including its decoding operations and playback clock functionality, may be incorporated into or managed by the playback and switching module 1320. In another embodiment, playback engine 1480, playback clock 1250, playback switching module 1320, event scheduler 1290, and/or timestamp module 1270 may reside in a hardware device that is different or separate from the controller 1010, but operatively connected to the controller 1010, and hence can be considered to be part of the controller 1010 (and the computer system 1000) for the purposes of this application. Thus, any functionality attributed to one of these components may, in alternative implementations, be executed by the other, or by a combined component that performs the roles of both. Such variations in architecture remain within the scope and spirit of the present disclosure.

In one embodiment, the system 1000 supports predefined transition effects between filler content 1070 and the secondary video 1210. For example, in one embodiment, a crossfade transition is deployed wherein the secondary video 1210 gradually fades in over 500 ms-2 s. In another embodiment, the filler content 1070 slides out in any direction (up, down, left, right, etc.) while the secondary video 1210 slides in. In yet another embodiment, an instant cut is used, wherein the system 1000 immediately switches to the secondary video 1210 without visible lag.

In one embodiment, the system 1000 logs all playback events and synchronization accuracy metrics in a playback log database, which stores playback timestamps of the primary video 1200, trigger events for each secondary video 1210, and playback latency measurements to provide accurate synchronization.

In one or more embodiments, synchronization of the secondary video 1210 to the primary video 1200 is primarily guided by the underlying audio content (e.g., audio file or audio track), rather than frame rate matching. The goal is to ensure that both videos remain in sync with the song's audio, preserving the timing of dance movements, lip sync, and other performance elements across multiple displays.

To achieve this, the system 1000 uses the audio track from the primary video 1200 as the timing reference and aligns the secondary video 1210 based on its own corresponding audio markers, beat structure, or waveform patterns. Various synchronization techniques may be employed to ensure that any timing deviations, playback drift, or misalignment are corrected dynamically.

In one or more embodiments, synchronization is based on audio time stamps. In such embodiments, the system 1000 extracts and analyzes the audio track from both the primary video 1200 and the secondary video 1210 and ensures that their timing is aligned using time stamps derived from their respective waveforms. In one embodiment, technical implementation can be done as follows. First, extract audio from both videos. The audio tracks from the primary video and the secondary video are extracted and processed.

In one embodiment, playback timing for the secondary video 1210 may be adjusted to align with the timing of the primary video 1200. For example, in one embodiment, a DTW (Dynamic Time Warping) algorithm may be applied to audio features extracted from both videos (such as spectral fingerprints) to calculate how the secondary video's timing differs from the primary video 1200. In one embodiment, if there is any difference (e.g., latency offset or drift), the computer system 1000 adjusts the playback rate or framing timing of the secondary video 1210 correct the difference. In one embodiment, playback speed can be slightly increased or decreased (e.g., ±1%) if needed to compensate for micro-timing deviations. In one embodiment, once synchronization is achieved, the secondary video 1210 is triggered at the exact moment its corresponding section begins in the primary video 1200.

In another embodiment, beat detection algorithms are used to align the rhythm and tempo of the secondary video 1210 to the primary video 1200. Instead of analyzing full audio fingerprints, this approach focuses on identifying major beats and percussive elements to keep the videos in sync. In such embodiment, the system 1000 detects tempo (BPM) and beat locations in both the primary video and secondary.

In a next step, the secondary video 1210 is aligned to the primary video's beat map. In one embodiment, the system 1000 matches beats between the primary and secondary video. If the beats are slightly off, the playback start time of the secondary video is adjusted.

In one embodiment, the system 1000 continuously monitors beat synchronization and adjusts the playback if drift occurs. Minor speed corrections can be applied if necessary.

In yet another embodiment, lyrics are used as the synchronization anchor, ensuring that both videos follow the same vocal track timing. This method is particularly useful when both videos feature performers singing along with the music, and/or when one of the videos displays the lyrics of the song. In such embodiment, the system 1000 retrieves lyric timestamps from an external database or closed captions. Alternatively, in another approach, an AI-based speech-to-text engine is used to align lyrics with the audio waveform.

In one embodiment, lyrics are then matched across videos. For example, the system 1000 can match word-level timestamps between primary and secondary. In one embodiment, the secondary video 1210 is time-shifted to align the first sung word. However, in other embodiments, the primary video can be time-shifted. In another embodiment, the alignment occurs at the first sound of the song, or other location. In one embodiment, if the secondary video starts too early or too late, it is adjusted accordingly before playback begins.

In one embodiment, if the primary video 1200 and secondary video 1210 have vastly different frame rates, interpolation can be applied to ensure smooth motion transitions. However, this is only desired if the framerate mismatch causes visible jitter or artifacting. The priority remains on synchronizing audio timing rather than frame rate matching.

One or more embodiments provide a system 1000 for displaying synchronized song lyrics 1420 alongside (e.g., on a second display 1030, or a third display 1450) the primary video 1200 while ensuring that the full-length primary video 1200, which includes the artist's performance, remains visible on the first display 2200. Unlike existing lyric videos that often replace the artist's performance with simple text or animations (e.g., such as those used for karaoke), these embodiments allow for simultaneous presentation of the artist's musical performance or musical video while also delivering synchronized lyrics to the display (1030 and/or 1450) in real time.

In one or more embodiments, the lyrics are not superimposed on or interfere with the visual display or imagery presented by the primary video 1200. In one embodiment, the lyrics video 1420 is presented on a physically different display device (e.g., on the second display 1030 and/or on the third display 1450) than the primary video 1200. In one embodiment, the physically different display device is a holographic display device. In one embodiment, the holographic display device is a holographic fan. In another embodiment, the holographic display device for displaying the lyrics video 1420 comprises a plurality of holographic fans that provide a stitched image of the lyrics. In one embodiment, only words or lyrics of a song are displayed on the second display or third display, with the surrounding background being black/transparent (e.g., by having LEDs on the fan blades not illuminated if they are not part of the LEDs that are forming lyrics/letters at a given time).

In one embodiment, the lyrics 1420 presented on the second display 1030 and/or third display 1450 are scrolled upwards or scrolled sideways. In another embodiment, the lyrics 1420 are presented one section at a time, and then transition into the next section. In one embodiment, the transition can be instantaneous, while in another embodiment, it can be a fade-in/fade-out transition. In one embodiment, the relevant portion of the lyrics 1420 corresponding to the words in the audio file are synchronously highlighted as the lyrics 1420 from the audio file are being output by an audio output device 1050 (e.g., one or more speakers).

In another embodiment, both the primary and secondary videos 1200, 1210 are presented on the same display device 2200 or 1030, but on a physically different portion of the device such that there is no physical overlap between the borders of the primary video 1200 and secondary video 1210.

In one embodiment, the primary video 1200 and/or secondary video 1210 is displayed on one or more of an LED, OLED, Micro LED, or LCD display. In another embodiment, the primary video 1200 is displayed with a digital projector, such as a DLP, LCD, or laser-based projector. In one embodiment, the primary video 1200 is displayed on a non-transparent display, and the secondary video is displayed on a transparent or semi-transparent display will be appreciated from further embodiments below.

In one embodiment, the system 1000 includes a lyrics processing and synchronization module 1440 that enables accurate timing and presentation of song lyrics 1420 in synchronization with the primary video 1200. This module 1440 processes predefined lyric timing data 1220 to ensure that the displayed lyrics 1420 match the corresponding words being sung in the primary video 1200.

In one embodiment, lyrics 1420 are stored in a structured format, such as a JSON, XML, or LRC file, where each line or word is assigned a specific timestamp 1220 corresponding to the primary video's 1200 timeline. In one embodiment, the system 1000 can retrieve time-coded lyrics from third-party databases, closed caption files, or manually prepared lyric timing files prepared in advance. These time-aligned lyrics enable synchronized rendering across one or more displays in coordination with the audiovisual content of the primary video.

In one embodiment, each lyric segment (e.g., one or more words or lines of lyrical text) is linked to a specific timestamp 1220 to enable synchronization with the primary video 1200. In one embodiment, lyric timing data 1220 can be manually created, retrieved from karaoke databases, third-party databases, or automatically generated using speech-to-text processing with time alignment.

In one embodiment, controller 1010 of the computer system continuously monitors the presentation timestamp of the primary video 1200 and dynamically updates the displayed lyrics 1420 based on the closest matching lyric timestamp 1220. In one embodiment, the computer system 1000 generates smooth scrolling or fade-in/fade-out effects of lyrics 1420 to enhance readability.

In another embodiment, a separate third display device 1450 is dedicated to showing lyrics 1420 in real-time synchronization with a first display device 2200 showing the primary video 1200 and a second display device 1030 showing a secondary video 1210 (e.g., short-format video and any filler video 1070 as described above). For example, in this embodiment, the primary video 1200 remains on the first display 2200, the secondary video 1210 plays on the second display 1030 during predefined song segments, and a third display 1450 continuously displays the lyrics 1420, updating them in real-time as the song progresses. In one embodiment, the third display can be contiguous with the first display 2200 and/or second display 1030, and in another embodiment it is physically separated from both of them.

In one embodiment, the third display 1450 renders lyrics 1420 using large, high-contrast fonts for readability, and automatic scrolling ensures that the displayed lyrics 1420 stay aligned with the song's progression. In one embodiment, a bouncing cursor effect highlights the currently sung word.

In one embodiment, lyrics 1420 can be stitched offline directly into the primary video 1200 before playback. In one embodiment, this approach permanently integrates the lyrics 1420 as part of the video content itself. In one embodiment, lyrics 1420 are pre-rendered into the video file using a text-to-video compositing system. In this embodiment, synchronization accuracy is achieved as a result of the lyrics 1420 being embedded at the correct timestamps 1220 during video encoding. In one embodiment, video processing software (such as FFmpeg) is used to generate lyric-embedded versions of the primary video 1200. In one embodiment, lyrics 1420 are rendered frame by frame, ensuring no delay between the displayed text and the corresponding audio. In one embodiment, hardware acceleration, such as GPU-based rendering, can be used for efficient encoding and high-quality rendering of the final lyric-enhanced video.

In one embodiment, frame-accurate synchronization of lyrics 1420 with the primary video 1200 is enhanced by one or more of the following. In one embodiment, the controller 1010 accounts for playback delays by applying a 50-200 millisecond (ms) buffer offset to ensure that lyrics 1420 appear at the correct moment (and the playback engine 1480 restarting and/or delaying each video to ensure proper synchronization). In one embodiment, if the primary video 1200 is paused, the lyric display 1420 is also paused, ensuring lyrics 1420 remain in sync even after user interaction.

In one or more embodiments, the controller 1010, which may include one or more processors 1460, internal (volatile and/non-volatile) memory 1462, input/output/network interfaces 1468, and software modules 1466, is responsible for managing the synchronized playback of primary and secondary videos along with lyric presentation across multiple display devices. In one embodiment, the controller 1010 orchestrates data retrieval, processing, synchronization, and rendering across interconnected hardware components to ensure seamless playback and accurate timing.

In one embodiment, the controller 1010 functions as the central processing unit for managing the presentation of primary videos, secondary videos, and lyrics across a system of devices.

In one or more embodiments, the system 1000 operates in a pre-recorded playback environment in which music videos, secondary visual content, and lyrics are fully composed and synchronized in advance. Rather than dynamically switching media streams based on timestamps or real-time metadata parsing, this embodiment simplifies execution by having all output media streams authored to a common timeline and then played back in a coordinated fashion under the control of controller 1010.

In one embodiment, the controller 1010 may be implemented as a general-purpose computing device, embedded processor, dedicated media server, or mobile device. In one embodiment, the controller 1010 comprises at least one processor 1460, memory 1462, and a set of instructions from software modules 1466 configured to initiate and manage synchronized playback of the various pre-recorded media elements across multiple output devices.

In one embodiment, prior to playback, distinct media components are prepared and stored in one or more storage devices (e.g., memory) 1150 accessible to the controller 1010, including several video files, and audio tracks (e.g., embedded in one or more of the video files) and/or audio files. For example, memory 1150 may include one more primary media files 1200, which may contain a full-length video showing a visual performance by an artist. File(s) 1200 may include an embedded audio track or may be presented as a silent video aligned to a separate audio reference. Further, memory 1150 may include one or more secondary full-length media files 1210, which may be of equal duration to the primary media file, and containing pre-rendered visual content synchronized to the same underlying audio track. In one embodiment, the second full-length video may be the lyrics to the music video. This file may include an embedded audio track or may be presented as a silent video aligned to a separate audio reference. In another embodiment, the secondary media file or video 1210 includes a combination of filler segments 1070 (e.g., mirrored visuals of the music video, lyrics to the music video, ambient content, etc.) and inserted media clips (e.g., user-generated performance clips) positioned to align with specific portions of the song. In one embodiment, the entire secondary video or media file is rendered as a single, continuous video, obviating the need for runtime compositing or switching logic for synchronization with the primary video. In some embodiments, the lyrics 1420 may be stored as a time-coded subtitle file or as structured metadata (e.g., JSON or XML with timing fields). In other embodiments, the lyrics 1420 are rendered into a full-length video in advance (e.g., via a text-to-video compositing system). The lyrics file or video is structured to match the timing of the underlying audio track and may include line-by-line highlighting, scrolling text, or visual animations aligned to the music. In one embodiment, memory 1150 also include audio content 1062, which can be embedded track(s) and/or stand-alone file(s).

In one embodiment, each of these media components is authored using a common audio track reference and is aligned to a shared timeline during production, such that their playback can be executed in parallel without further synchronization adjustment.

In one embodiment, at runtime, the controller 1010 retrieves the music video, secondary video, and lyrics file or video from one or more storage devices or memory 1150. As used herein, the term “storage device” and “memory” broadly refer to include local memory, attached storage volumes, network file shares, and/or remote cloud-based content repositories. In one embodiment, the controller 1010 then initiates playback of each media stream on its corresponding output device. In one embodiment, the primary video (e.g., music video) is routed to a first display device 2200, such as a stage-facing display or video wall (e.g., LED display). In one embodiment, the secondary video is routed to a second display device 1030, such as an audience-facing display, a holographic fan display, or other video display device. In one embodiment, a third display device 1450 is also optionally provided. In one embodiment, the lyrics 1420 are rendered on the third display device 1450 or embedded within the secondary video, depending on implementation.

In one embodiment, the audio track is stored as a standalone media file, in which case the controller 1010 also routes this file to an audio output device, such as a PA system, loudspeaker array, or distributed sound network. Alternatively, if the audio is embedded within the music video or secondary video, the controller 1010 mutes one video stream (if the video stream contains an audio file) and designates the appropriate device as the source of the audio output.

In one embodiment, to maintain alignment, the controller 1010 launches each media stream simultaneously, using a shared playback clock 1250 or system timer. In embodiments where all media files are of equal duration and encoded to start at time zero, initiating playback concurrently ensures that all visual and audio elements remain in sync throughout execution without requiring dynamic timing corrections.

In one embodiment, the controller 1010 may utilize system media player APIs, scripting interfaces (e.g., VLC, for example), or custom playback software to assign each stream to the appropriate output device and manage playback state. In some embodiments, the controller 1010 supports monitoring and logging functionality to verify that all outputs remain active and time-aligned. However, in this embodiment, no dynamic timestamp parsing, conditional branching, or real-time triggering logic is used once playback has commenced.

In one embodiment, the controller 1010 may be physically integrated into one of the displays, audio devices, or it may reside on a separate computing node connected via a local network. Communication between the controller 1010 and the output devices may occur over wired or wireless configurations, including (for example) direct AV interfaces such as HDMI, DisplayPort, or USB-C, or IP-based protocols such as RTP or RTSP for media streaming, and use WebSocket, or OSC for control signaling.

In another embodiment, the controller 1010 processes playback timing for primary videos 1200 and ensures continuous rendering on the first display 2200, and also monitors timestamps and triggers the playback of secondary videos 1210 on a second display 1030 at predefined moments. In this embodiment, the controller 1010 retrieves and synchronizes lyric timing data 1220 with the audio track of the primary video 1200 to ensure accurate word presentation, and may also manage communication between multiple displays (2200, 1030, 1450). In this embodiment, the controller 1010 may provide real-time adjustments to playback speed, buffering, and transitions to compensate for delays and maintain seamless synchronization.

In any of the embodiments, the controller 1010 may be implemented as a single processing unit or distributed across multiple interconnected processing nodes, depending on the complexity of the playback system.

In one or more embodiments, the controller 1010 configured to manage the coordinated playback of a music video, audio track, and time-aligned lyric content 1420 across multiple output devices. The controller 1010 comprises one or more hardware and software components, which may reside in a standalone processing device, a distributed system, or be integrated into one or more of the display devices (2200, 1030, 1450) or media servers.

In one or more embodiments, the controller 1010 includes at least one processor 1460, volatile and/or non-volatile memory 1462, and a set of software modules or firmware instructions 1466 that collectively manage the retrieval, decoding, synchronization, and rendering of audiovisual content across devices.

The controller 1010 may include or be communicatively connected to one or more of the following components: a processor or controller (e.g., CPU, SoC, GPU, microcontroller, etc.) 1460 responsible for executing control logic for media synchronization, device coordination, and user interface interactions, memory (e. g,, RAM, flash, SSD) 1462 that stores runtime data, buffered media content, and executable software modules, input/output and/or network Interfaces 1468 that may include wired (Ethernet) and/or wireless (Wi-Fi, Bluetooth, 5G) communication hardware for interacting with storage devices, display devices, and audio output devices, and interfaces for HDMI, DisplayPort, USB, audio jack, or proprietary protocols to communicate with internal and/or external displays or audio systems 1520.

Various coding methodologies may be implemented for the predefined timestamp mapping 1220 approach for synchronizing primary video 1200 playback with secondary videos 1210 on a multi-display setup. In one embodiment, a script initializes video playback for both displays, checks timestamps 1220, and dynamically switches the secondary video 1210. In one embodiment, a timestamp file stores the predefined mapping of secondary videos 1210 to primary videos 1200.

In one embodiment, this will play out as follows. The first display 2200 plays the full-length primary video 1200. The system 1000 checks timestamps 1220 and plays the appropriate secondary video 1210 at the right time. When no secondary video 1210 is active, the second display 1030 defaults to filler mode (a blank display, alternative content, or mirrored primary video 1200). A user selects the next primary video 1200 manually. If manual mode isn't selected, the system 1000 automatically cycles through primary videos 1200 in a playlist.

In various embodiments, frame buffering and preloading protocols are deployed. In one embodiment, the system 1000 preloads upcoming secondary videos 1210 into GPU memory (1462) several seconds (e.g., 3-15 seconds) before the trigger timestamp 1220. In one embodiment, the preloaded frames are stored in a circular buffer to ensure instant rendering upon switching events. In one embodiment, zero-copy memory sharing between the decoder and renderer reduces latency, ensuring frame-exact playback synchronization.

In one or more embodiments, the system 1000 is configured to operate in a pre-authored playback mode. In this mode, all media elements—including the music video 1200, secondary video 1210, and lyric display 1420—are authored in advance to share a common timeline. Rather than relying on real-time switching, timestamp detection, or synchronization logic during playback, each media file is prepared to begin and end in alignment, allowing seamless, parallel output without runtime coordination.

This pre-authored approach offers a simplified and robust playback method where deterministic timing and minimal latency are desired. Because all synchronization is resolved prior to playback, there is no need for dynamic event scheduling, timestamp matching, or drift correction during execution.

In one embodiment, each media component is created using a shared audio reference track and aligned during production to match that timing. For instance, in one embodiment a music video 1200 contains a full audiovisual performance with embedded or associated audio. In one embodiment, the secondary video 1210 may include visual inserts, mirrored content, or filler material 1070 structured to align with key song segments. In one embodiment, the lyrics 1420 may be encoded as a rendered video or synchronized subtitle file aligned to the same audio.

In one embodiment, during playback, the system 1000 loads each media stream from memory or storage 1150 and initiates simultaneous playback. In one embodiment, the controller 1010 may include a media playback engine 1480 configured to send each stream of media to a separate output device (2200, 1030, 1450). The media playback engine may be implemented as an internal component of the controller (as illustrated in the figures), such as a software module executed by one or more processors of the controller. In this configuration, the playback engine operates directly within the controller to decode and render media content based on timing signals or playback instructions. Alternatively, the media playback engine may be external to the controller and communicatively coupled via one or more interfaces (e.g., wired, wireless, or bus-based). In either case, the playback engine is configured to receive playback instructions from the controller and perform decoding and rendering of music video content in accordance with the desired timing control.

In one embodiment, the playback engine does not parse timestamps or trigger transitions dynamically.

In one embodiment, playback begins only when all media files are ready. In another embodiment, playback is initiated via a timed script or synchronization signal. Because each file shares the same duration and temporal structure, no correction is required to maintain alignment once playback begins. This embodiment is particularly effective where frame-exact synchronization is necessary, and where latency, jitter, or runtime variance should be minimized.

In yet another embodiment, pre-authored media files are encoded with a silent start or buffer region to allow all devices to achieve readiness before beginning playback. A cue or command is then used to simultaneously start all output streams from time zero. This approach contrasts with dynamically coordinated playback, where real-time event detection, buffering windows, and synchronization adjustments are continuously monitored and applied.

In other embodiments, different synchronization reference models may be employed depending on system configuration, performance goals, or playback environment. These models define which media stream serves as the “master clock”—the timeline against which all other outputs are synchronized.

In one embodiment, the audio track is used as the master clock. This model is particularly well suited for live performance contexts or environments where lip sync and beat accuracy are critical. The video 1200 and lyric content 1420 are aligned to the timing of the audio waveform. Any timing adjustments to video or text rendering are made with reference to the audio playback timeline.

In another embodiment, the video stream—typically the primary video 1200—is designated as the master clock. This model is useful in cases where the visual presentation is central, such as when the artist's movements, choreography, or on-display visuals should remain fixed. Audio and lyric rendering are aligned accordingly.

In yet another embodiment, synchronization is governed by an independent playback timeline that is not tied to any particular media stream. This timeline may be derived from system time, user input, or a pre-authored master control file. All media elements—audio, video, and lyrics—are aligned to this common timeline using presentation timestamps or event triggers.

The playback engine 1480 is configured to operate flexibly under each of these reference models. For example, in audio-anchored mode, it may monitor real-time audio playback positions and dynamically adjust video/lyric streams. In video-anchored mode, the engine may track frame-level video playback progress and synchronize other outputs accordingly. In timeline-driven mode, it may function as the master clock itself, managing all outputs based on a unified schedule.

These models can be selected manually, configured automatically based on content type, or toggled dynamically in response to runtime conditions such as playback drift, buffering status, or user input.

The controller 1010 described in the foregoing embodiments may, in various implementations, function as or incorporate the aforementioned media playback engine 1480. The media playback engine 1480 comprises a combination of hardware and software components responsible for initiating, coordinating, and maintaining synchronized playback of media content across multiple output devices (2200, 1030, 1450). This includes playback of primary video 1200, secondary video 1210, and lyrics content 1420, as well as corresponding audio.

In one or more embodiments, the media playback engine 1480 is responsible for maintaining a common playback timeline across output devices. For example, the playback engine 1480 may manage the initial clock alignment between video, audio, and lyric display devices. Playback may then be initiated concurrently from a common timeline reference point, and the engine 1480 may subsequently monitor drift or latency between streams. Where drift is detected, the playback engine 1480 applies adjustments such as frame skipping, frame repetition, or slight speed modulation to ensure that synchronization remains within a target threshold.

In one embodiment, the playback engine 1480 communicates with media decoders, renderers, and audio outputs to ensure frame-accurate or sub-second synchronization. For example, video content may be delivered to one or more display devices (2200, 1030), while audio is streamed to an external speaker system. Lyrics may be rendered as a dynamic overlay or as a separate synchronized visual stream. The playback engine 1480 manages each output device's playback position to ensure they remain in phase.

The playback engine 1480 also provides unified state control across devices. When a user issues a command, such as play, pause, resume, or seek, the engine 1480 propagates the command to all devices in a time-aligned fashion. In one embodiment, a seek command adjusts the current position of all playback streams and ensures that resumption occurs at a precisely aligned point. Similarly, pause and resume operations are executed across devices such that the media playback experience remains coherent to the viewer or listener.

In one embodiment, buffering and preload logic are integrated into the playback engine 1480. Prior to initiating playback, the engine 1480 loads a portion of each media stream (e.g., primary video, secondary video, lyrics, audio) into memory 1150 to confirm readiness. Playback begins only after all relevant buffers have reached a predefined threshold. During playback, the engine 1480 may maintain progressive buffering windows to prevent underrun conditions. When a stall or timing anomaly is detected, the playback engine 1480 can pause all streams, allow buffers to refill, and then resume in sync.

In one or more embodiments, the controller 1010 may be a dedicated media controller appliance located on-premises, software application running on a laptop or tablet, a cloud-based service managing playback across network-connected endpoints, and/or an embedded module integrated into the same chassis as the display or audio device (e.g., smart display with built-in synchronization software).

In some embodiments, the controller 1010 may be implemented using a Field-Programmable Gate Array (FPGA) 1490 to enable low-latency, hardware-level synchronization and parallel media stream management. In some embodiments, the FPGA may be integrated with the controller, while in other embodiment, the FPGA may be a separate component communicatively connected to the controller (for example, via one or more interfaces). The FPGA 1490 can be configured to process video frames, audio streams, and subtitle or metadata inputs in real time, using dedicated logic blocks to decode, buffer, and route media data to the appropriate output interfaces. Frame alignment between the music video 1200 and lyrics 1420 can be achieved by embedding timing logic directly into the hardware design, allowing precise synchronization without dependence on a general-purpose processor or operating system.

In one or more embodiments, the controller 1010 may be implemented as a mobile application executing on a smartphone or tablet. In one embodiment, the mobile device retrieves the music video 1200, lyrics 1420, and audio track from local or cloud-based storage 1150, and coordinates synchronized playback across connected devices using built-in input/output and/or network interfaces 1468 such as Wi-Fi, Bluetooth, or USB-C. The mobile controller may render lyrics 1420 directly on the device's display or cast them wirelessly to a second display 1030 (e.g., using AirPlay, Chromecast, Miracast), while concurrently sending the music video 1200 and audio stream to other output devices. Timing synchronization is managed using the device's system clock or internal media player state, and latency compensation features are optionally provided to maintain accurate alignment across all outputs.

Throughout this specification, various synchronization mechanisms, timing references, timestamp mappings 1220, playback engines 1480, shared clocks 1250, buffering techniques, and alignment strategies have been described in connection with coordinating media across multiple output devices (e.g., displays 2200, 1030, 1450 and audio output device 1050). It should be appreciated that such disclosures are not limited to a single timing architecture. Rather, in one or more embodiments, computer system 1000 and/or controller 1010 may implement different synchronization models depending on the capabilities of the respective content playback devices.

In one embodiment, synchronization is achieved through distributed cue-based triggering under control of controller 1010. In this embodiment, one or more content playback devices—such as appliance-based media player boxes, including closed or partially closed systems having limited external timeline control—store or buffer media in memory 1150 or internal device memory and initiate playback upon receipt of a control instruction generated by controller 1010. The instruction may comprise a network message transmitted via interface 1468, a command signal, or other execution cue issued by processor 1460. Each device begins playback using its own internal clock upon receipt of the cue. In such embodiment, no shared time reference between devices is required. Temporal coordination is achieved by substantially simultaneous triggering from controller 1010, and acceptable synchronization tolerances may be maintained through calibrated delay offsets managed by playback engine 1480. This embodiment is particularly suitable for self-contained appliance boxes that do not expose frame-level control, external clock inputs, timestamp module access 1270, or programmable rendering pipelines.

In another embodiment, synchronization is achieved using a shared time reference distributed among multiple devices under management of controller 1010. In one embodiment, devices synchronize their internal clocks to a common master clock 1250 maintained by computer system 1000, and playback is scheduled to occur at an absolute timestamp 1220 stored in memory 1150. In such embodiment, media is preloaded or buffered in advance by playback engine 1480, and each device initiates playback when its synchronized local clock reaches the designated execution time. Event scheduler 1290 may monitor presentation timestamps and coordinate initiation events across devices. In this configuration, alignment is derived from a shared time base rather than from command arrival time, thereby reducing variability associated with network latency. This embodiment may be implemented across a mixture of appliance-based playback boxes and host-driven systems, provided that each device supports clock discipline, scheduled execution, or timestamp interpretation under control of controller 1010.

In another embodiment, synchronization is achieved through time-derived playback control executed by computer system 1000. In this embodiment, playback position is continuously computed as a function of elapsed time relative to a shared master timeline maintained by playback clock 1250. In one embodiment, host-driven systems—such as display devices controlled by external computing platforms capable of executing custom rendering software under direction of controller 1010—calculate current media position based on elapsed time and playback parameters, and render frames or content states accordingly. Rather than relying solely on an initial trigger or scheduled start time, each rendering node derives its playback state from the master temporal reference provided by controller 1010. In such embodiment, frame-consistent output may be achieved without requiring hardware genlock, and drift may be corrected through periodic recalculation of timeline position, buffer adjustment, or playback rate correction executed by playback engine 1480.

In one embodiment, different synchronization architectures may coexist within the same integrated system managed by computer system 1000. For example, certain appliance-based content player boxes may operate under cue-based triggering, while host-driven systems execute time-derived rendering based on shared clock 1250, and other devices execute scheduled playback at predefined timestamps 1220 using event scheduler 1290. Controller 1010 may coordinate these differing synchronization strategies concurrently, selecting the appropriate timing model based on device capability, network topology, or system configuration.

It should therefore be appreciated that references throughout this specification to synchronization, temporal alignment, timestamp control, frame coordination, shared clocks, playback engines 1480, timestamp modules 1270, event schedulers 1290, or timing modules implemented within controller 1010 or computer system 1000 are intended to encompass any of the foregoing embodiments unless expressly limited by context. The disclosed systems are not restricted to a particular timing mechanism, but instead support multiple alternative synchronization models for coordinating heterogeneous content playback devices—including closed appliance boxes and programmable host-driven systems—within a unified playout environment controlled by computer system 1000.

It should be appreciated that the illustrated controller 1010 is illustrated as including multiple functional blocks or components within a single unit, it should be understood that any one or more of these components may be implemented externally and operatively coupled to the controller. In various embodiments, one or more of the illustrated components such as the media playback engine, memory, interface circuitry, synchronization hardware (e.g., FPGA), or other processing elements may be provided as discrete devices, modules, or chips that communicate with the controller via one or more wired or wireless communication interfaces. The internal representation in the figures is provided for illustrative purposes and does not limit the physical or logical arrangement of the components.

As previously noted, the controller 1010 interfaces with multiple hardware components to facilitate video playback, lyric display, audio playback, as well as synchronization across multiple displays. The hardware components may be directly connected via wired interfaces (e.g., HDMI, DisplayPort, USB-C, Ethernet) or indirectly connected via wireless communication protocols (e.g., Wi-Fi, Bluetooth, 5G, Zigbee, for example).

In one embodiment, the controller 1010 synchronizes the lyrics display 1420 with the primary video's 1200 audio track, ensuring accurate timing.

In one embodiment, the controller 1010 retrieves time-coded playback information from a media database 1230 or local storage device 1150.

In one embodiment, the controller 1010 manages real-time buffering to ensure video frames and audio streams remain in sync. For example, the controller 1010 can manage synchronization through one or more of the following: initial pre-buffering to align start times, progressive buffering to avoid mid-playback stalls, and/or deployment clock-based alignment to detect and correct timing drift. In some embodiments, when needed, resynchronization controls such as brief pauses or playback corrections can be implemented.

Specifically, in one embodiment, before playback begins, the controller 1010 performs initial buffering for each media stream. For example, the controller 1010 loads the first portion (e.g., several seconds) of the primary video 1200, secondary video 1210, and audio track into memory 1150. If lyrics 1420 are being rendered dynamically (e.g., from a time-coded text file), the controller 1010 parses and buffers the first few lyric entries based on the upcoming timestamps 1220.

In one embodiment, the controller 1010 waits until all streams are buffered and ready before triggering the playback start event. This ensures that no stream lags behind at launch, all output devices begin playback from time zero, and time-aligned execution is maintained across streams.

In one embodiment, once playback begins, the controller 1010 monitors playback progress using a shared media clock, system time, or the reported playback positions from the respective media players (e.g., via presentation timestamps). If any output device (e.g., the lyrics renderer) is ahead or behind, the controller 1010 can pause and resume briefly to resynchronize, drop or skip a lyric entry, or rely on video frame drop compensation.

In one embodiment, while initial buffering handles startup, progressive buffering ensures continued smooth playback. For example, for video files, this may happen automatically in the media player's decoding pipeline. For lyrics 1420, the controller 1010 may maintain a small sliding window buffer (e.g., keeping the next 5-10 seconds of lyric entries preloaded and ready). If any component begins to stall or under-run, the controller 1010 can raise a flag, pause all streams, or issue a warning.

In some implementations, the controller 1010 treats the audio track as the master clock, and the video 1200 and lyric 1420 components are forced to stay in sync. In others, the video 1200 timeline serves as the timing anchor. The controller 1010 compares actual playback positions across the streams and ensures tolerance thresholds are not exceeded (for example, all media would stay within 30-100 milliseconds of each other).

In one or more embodiments, the system 1000 operates without dynamic media switching, timestamp parsing, or real-time synchronization corrections. Instead, in one embodiment, all media content is pre-rendered and aligned in advance, enabling straightforward, parallel playback execution under minimal controller 1010 supervision.

In one embodiment, as mentioned above, the audio track is embedded within the same file as the music video 1200, forming a single audiovisual file that serves as the primary output to a first display device 2200. In one embodiment, a separate video file containing the full lyrics 1420 is authored to be of equal duration and temporal alignment with the music video 1200. This lyrics video 1420 may include static or animated text representations of the lyrics, scrolling lines, karaoke-style highlights, or any other visual presentation, rendered and encoded at the authoring stage. In such embodiment, the controller 1010 may be configured to retrieve both the music video file 1200 and the full-length lyrics video 1420 from one or more storage devices 1150. During playback, the controller 1010 causes both video files to be loaded, and then initiates synchronous playback such that the music video 1200 is rendered on the first display device 2200, and the lyrics video 1420 is rendered on the second display device 1030, with both starting from the beginning of their timelines simultaneously.

In one embodiment, no separate audio routing or decoding is used, as the audio is played directly from the music video file 1200. In one embodiment, no lyric timing data is parsed or interpreted at runtime, as all synchronization has already been encoded into the video assets. This eliminates the need for runtime beat detection, timestamp mapping 1220, or buffering coordination beyond what is inherently handled by standard video playback systems. The system 1000 may rely on standard media players, media server APIs, or scripting-based launch sequences to initiate playback across multiple displays with minimal processing.

In some embodiments, the controller allows for manual intervention by a system operator to adjust playback behavior dynamically. For example, in one embodiment, a system operator can select the next primary video, and the controller automatically retrieves the corresponding secondary video (including any timestamps and/or lyric timing data).

As used in this specification, the term “media file” refers to any digital file (or other form of saved digital content) content containing audiovisual or visual content, including but not limited to video content, audio-visual performances, synchronized audio and video recordings, or animation content. A media file may include one or more streams such as video tracks, audio tracks, subtitle tracks, metadata, or embedded control signals. The media file may be encoded using any suitable format or container (e.g., MP4, MKV, MOV, AVI, FLV, WebM) and may be stored locally, streamed over a network, or accessed from cloud-based services. Some examples include, without limitation: a video file containing a musical performance (e.g., a music video), a file containing visualizations synchronized to audio, a file that includes an embedded audio track, but may also function with a separate audio source, a media file used for lyric synchronization purposes, whether shown to an audience or used internally for cueing or playback control. As used herein, the term “media file” is intended to be interpreted broadly and may refer to various possible implementations of storing or organizing media content. While a media file may refer to a conventional, structured digital file (e.g., an .mp4, .mp3, or other container format), it should be appreciated that media content may also be stored, transmitted, or processed in alternative forms, such as in memory buffers, streams, segmented chunks, or dynamically generated data structures. Accordingly, the term “media file” as used in this specification is not limited to traditional file system objects, but should be understood to encompass any representation of media content, regardless of how it is stored, accessed, or formatted, including those that do not reside as discrete files in a file system. Thus, references to “media files” throughout this disclosure should be interpreted to include all such variations unless expressly stated otherwise.

The term “video” as in “primary video” or “secondary video” refers to a type of media or media file comprising visual content that may include embedded audio or may be presented in synchronization with a separate audio content stream. Non-limiting examples include: music videos generated for commercial release, concert footage or live performance recordings, artist-created or user-generated videos synchronized to a musical work, plain lyrics (text or words), lyrics with animated or stylized background visuals, short form videos, social media videos, and/or visual content where the artist or others are dancing or performing in time with the song. The music video may include an audio track or not include an audio track.

As used herein, the term “video” (whether alone, or in combination with another word, such as primary video, secondary video, lyric video, video processor, etc.) is used in a generic sense and refers broadly to any sequence or presentation of visual content, whether pre-recorded, real-time, or dynamically generated, including but not limited to images, text, animations, graphics, visual effects, or any combination thereof, rendered or displayed in any medium capable of conveying visual information to a viewer, including displays, displays, projections, surfaces, or light-based visualization systems. “Video” can also refer to media or media file comprising visual content that may include embedded audio or may be presented in synchronization with a separate audio content stream, such as music videos generated for commercial release, concert footage or live performance recordings, artist-created or user-generated videos synchronized to a musical work, plain lyrics (text or words), lyrics with animated or stylized background visuals, short form videos, social media videos, and/or visual content where the artist or others are dancing or performing in time with the song.

The term “music video” should further refers to a type of media file comprising visual content that corresponds to, illustrates, or accompanies a musical composition. The music video may include a live recording of the artist performing a musical work, an artist lip-syncing or performing the musical work, abstract or thematic visuals, animation, or any combination thereof. The music video may include embedded audio or may be presented in synchronization with a separate audio content stream. Non-limiting examples include: music videos generated for commercial release, concert footage or live performance recordings, artist-created or user-generated videos synchronized to a musical work, lyric videos with animated or stylized background visuals, and/or visual content where the artist or others are dancing or performing in time with the song. The music video may include an audio track or not include an audio track.

The term “audio content” refers to any sound recording, soundtrack, audio file, audio stream, or live-generated audio output, associated with or corresponding to a musical performance. Audio content may include instrumental or vocal components, and may be embedded within another media file (e.g., a video file) or stored separately as a standalone file. Audio content may be streamed, buffered, or rendered in any format suitable for synchronized playback. Non-limiting examples include: an audio track embedded within a media file such as an MP4, MKV or other multimedia container, a standalone audio file such as a WAV, MP3, AAC, FLAC, or AIFF file, audio content streamed over a network or retrieved from a local or remote storage device, audio used as the timing reference for synchronizing video and/or lyrics, and audio containing lead vocals, background vocals, harmonies, or instrumental-only mixes.

The terms “synchronization” and “synchronized”, as used herein, refer to the temporal coordination or alignment of two or more media elements such that they are presented, rendered, or otherwise experienced in a manner that is consistent with a shared time reference or intended sequence. Synchronization may occur at various levels of precision, depending on the embodiment, and may include alignment of media elements based on timecodes, presentation timestamps, start times, frame indices, waveform features, beat positions, lyric timing data, or other temporal markers. Synchronization may be absolute or relative and may be implemented using system clocks, media playback positions, metadata cues, shared event triggers, or pre-authored alignment. Synchronization may also refer to initiating playback of multiple media components simultaneously and/or maintaining phase alignment across different playback devices or streams during ongoing execution. Examples include simultaneous playback of a media file, lyrics, and audio content from a shared start time, matching of lyric display timing to the progression of an audio track or video playback, alignment of a secondary video to specific portions or segments of a primary media timeline, pre-authored synchronization, where all media files are created with equal duration and aligned start times. And/or real-time synchronization using shared clocks or dynamic playback correction to minimize drift between streams.

As used herein, the terms “display” and “display device” are used interchangeably and refer to any standalone visual output apparatus or system capable of rendering visual content to a viewer. A display device in general (and unless specified or narrowed otherwise) may include, without limitation, a monitor, projector (e.g., in combination with a display, mesh, hologauze, etc), LED panel, OLED display, LCD display, holographic fan, transparent display, or any other visual rendering hardware, media or canvas capable of presenting images, video, text, or visual effects. A display device is understood to be a structurally independent unit, and is not intended to mean a portion, segment, or subdivided area of a larger display or panel. For example, references to a first display and a second display mean two physically separate display devices, and not two regions of the same device or display. In this context, the simultaneous rendering of content on a first display and a second display requires that each display be implemented on a structurally distinct device. However, it is further understood that some display systems may be constructed from multiple physically adjacent display modules—such as an LED wall composed of plug-and-play LED panels. Such a multi-module arrangement may be considered a single display device when configured to operate as a unified visual surface under coordinated control. Alternatively, individual modules within such a wall may be treated and considered as separate display devices if addressed and/or operated independently. The classification of such a configuration as one or multiple displays shall depend on system control structure and playback assignment, not physical proximity.

In any of the embodiments herein, any of the displays can be connected via the computer system 1000 or controller to an external video source 1520, and can also be configured to display real-time content, such as live video feeds, social media interactions, or event updates.

It should be appreciated that the systems depicted in FIGS. 12, 13, 14 and 15 include numerous options and permutations, including functionality that integrates substantially all of the technology and embodiments disclosed in this specification. However, it should be noted that such systems include numerous options (some of which may be mutually exclusive), and it is unlikely that any one system would include all such functionality all together.

Embodiments of the techniques described herein with respect to FIGS. 15 and 16 may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer systems 1000 described herein are merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. It should be appreciated that for efficiency in prosecution, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of conducting the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square,” “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct.

he foregoing detailed description describes various exemplary implementations of the present disclosure for purposes of illustration. It will be understood that the features, elements, and configurations described herein may be implemented in any suitable manner, including individually or in any combination with one another, unless explicitly stated otherwise. Additional implementations, variations, and modifications will be apparent to those of ordinary skill in the art in view of the present disclosure.

The following description sets forth further illustrative aspects and embodiments of the present disclosure. These aspects are provided to further demonstrate the breadth and flexibility of the disclosed subject matter and may be practiced independently or in combination with one another and with any of the implementations described above. It should be understood that any feature described in connection with one aspect may be used in combination with any other aspect, unless such combination is clearly incompatible. Variations, modifications, and substitutions may be made without departing from the scope of the present disclosure.

In some aspects, a system for outputting audio/visual content comprises memory storing pre-recorded audio content and visual content, a controller operatively connected with the memory and configured to output the visual content to a display and output the audio content to an audio output device, and at least one sensor operatively connected with the controller. The at least one sensor may be configured to provide position and/or orientation data to the controller based on a sensed position and/or orientation of an individual, and the controller may be configured to output the visual content at a position and/or orientation on the display based on the position and/or orientation data.

In certain embodiments, the system further comprises a display operatively connected with the controller. The display may comprise any suitable type of display, including an opaque display, an augmented display, or a projection-based system such as a projector and holographic mesh. In projection-based implementations, the projector may be configured to project the visual content at a position and/or orientation on the mesh based on the position and/or orientation data.

In some embodiments, the visual content comprises dynamic lyric content. The visual lyric content may be output in temporal alignment with the audio content output. In certain implementations, the visual lyric content and the audio content are stored in memory as a single file, while in other implementations they are stored as multiple files. In further embodiments, the audio content and the visual content may be stored together as a synchronized audio-visual asset.

In some aspects, the controller is configured to determine an origin point and/or initial direction of visual lyric content movement on the display based on the position and/or orientation data. The controller may further be configured to present the visual content only at the time of a corresponding playback cue of the audio content.

In certain embodiments, the at least one sensor comprises a wearable worn by a performer. The wearable may comprise smart glasses configured to display advanced visual lyrics to the performer prior to their corresponding playback time on the display. In some implementations, the sensor comprises an optical sensor configured to provide optical signal data representative of electromagnetic radiation. The system may further include a wireless transmitter configured to transmit orientation and/or position information from the sensor to the controller, the wireless transmitter comprising one or more communication interfaces such as Bluetooth, Wi-Fi, ultra-wideband (UWB), Zigbee, or other radio-frequency protocols.

In some aspects, a method of presenting synchronized lyrics comprises outputting audio content stored in memory, outputting visual lyric content stored in memory, sensing a position and/or orientation of a performer and generating a sensor output signal based on the sensed position and/or orientation, and orienting the output visual lyric content based on the sensor output signal. In certain embodiments, the visual lyric content is output in temporal alignment with the audio content and positioned on a display based on the sensor output signal. The sensing may be performed by a wearable sensor worn by the performer. In some implementations, advanced visual lyrics are provided to the performer on a second display prior to display to an audience.

In some embodiments, instructions stored on a non-transitory computer-readable medium, when executed by one or more processors, cause a system to perform any of the methods described herein.

In certain aspects, a display system comprises memory storing lyric content, a controller configured to output the lyric content to a display in temporal alignment with audio content, and at least one sensor configured to provide position and/or orientation data. The controller may use the data to determine an origin point and/or initial direction of lyric content movement on the display. The sensor may include a wearable, such as smart glasses, or may include one or more sensing technologies such as an inertial measurement unit (IMU), an optical or infrared beacon, and/or a camera-based detector. The system may further include a wireless transmitter for communicating sensor data. The lyric content may be presented only at the time of corresponding playback cues, and audio and lyric content may be stored together as a synchronized asset.

In some aspects, a system for outputting audio/visual content during a live performance comprises a controller configured to receive audio input from a performer, memory storing visual lyric content, and at least one sensor configured to sense orientation and/or position of the performer. The controller may be configured to output visual lyric content to a display based on the received audio input and sensor data. The system may further comprise a microphone configured to receive audio from the performer.

In certain embodiments, the at least one sensor comprises a wearable worn by the performer, such as smart glasses. The sensor may alternatively or additionally comprise an optical sensor. In some implementations, the controller outputs lyric content upon detecting annunciation of corresponding words by the performer such that lyric timing is responsive to live vocal delivery. The controller may perform phoneme and/or pitch detection and map detected phonetic elements to corresponding lyric characters, syllables, or words stored in memory.

In some embodiments, the controller adjusts the spelling or rendering of displayed lyric content based on characteristics of the performer's vocalization. For example, elongation of a sound may cause corresponding letters to be prolonged or repeated in real time. The controller may dynamically orient visual lyrics to maintain readability, including maintaining left-to-right presentation regardless of initial direction.

In certain implementations, the controller and sensor determine a direction the performer is facing and position lyrics accordingly. The system may detect a position of the performer's mouth and render lyrics such that they appear to emanate from the mouth. Facial landmark detection may be used for determining mouth position. In some embodiments, the sensor is positioned on a microphone used by the performer.

In some embodiments, lyrics are animated such that they are projected in a direction corresponding to the performer's facing direction, one letter at a time, and may follow a curved path to maintain readable word formation. The lyrics may enlarge as they move away from the performer, disintegrate before reaching an edge of the display, or otherwise animate dynamically. Letters may be repeated when corresponding phonemes are elongated.

In some aspects, a method of displaying lyrics during a live performance comprises sensing a position and/or orientation of a performer, receiving audio corresponding to a vocal performance, and outputting visual lyrics in temporal alignment with the vocal performance, with positioning based on the performer's position and/or orientation. The lyrics may be projected in a direction corresponding to the performer's facing direction and animated letter-by-letter. Repetition of letters may correspond to elongated phonemes.

In certain embodiments, a system for generating synchronized lyric display during a live vocal performance comprises one or more input devices configured to capture an audio signal, memory storing lyric data, a controller configured to process the audio signal to detect phonetic elements, and a display configured to render corresponding text. The controller may correlate detected phonetic elements with stored lyric data and render text in temporal synchronization with the performance. In some implementations, the controller performs predictive determination of upcoming lyric content and renders text anticipatorily based on partial phonetic detection.

In some aspects, a system for synchronized audiovisual playback across multiple output devices comprises one or more displays, including a first display and an augmented display, an audio output device, storage storing media content including audio, visual content, and visual lyric content, and a controller configured to output the respective content to the respective devices. The controller may synchronize visual lyric content with audio using timestamps, beat detection, waveform analysis, or other synchronization techniques. The content may be stored in a single file or multiple files, and visual lyric content may be integrated with or separate from other media content.

In certain embodiments, visual lyric content may be presented on one display and migrate to another display, such as from a primary display to an augmented display. The media content may include pre-recorded visual imagery of a performer, and the controller may coordinate playback of audio, visual, and lyric content in a synchronized manner.

In some aspects, a system comprises multiple display devices, including a primary display and a holographic fan display, and a controller configured to output visual content such that a visual element transitions from the primary display to the holographic display.

In certain embodiments, a method of presenting synchronized audiovisual content across multiple displays comprises playing a primary audiovisual stream on a first display, identifying predefined temporal segments corresponding to repeated portions of the audio, presenting different secondary videos on a second display for different occurrences of the same segment, and synchronizing initiation of each secondary video with the corresponding segment while maintaining uninterrupted playback of the primary stream. The second display may present filler content when no secondary video is active, and the filler content may be independent from the primary stream.

What is claimed is:

1. A system for outputting audio/visual content, comprising:
memory storing pre-recorded audio content and visual content;
a controller operatively connected with the memory, the controller configured to output the visual content to a display, and output the audio content to an audio output device; and
at least one sensor operatively connected with the controller, the at least one sensor configured to provide position and/or orientation data to the controller based on a sensed position and/or orientation of an individual, wherein the controller is configured to output the visual content at a position and/or orientation on the display based on the position and/or orientation data.

2. The system of claim 1, wherein the visual content comprises dynamic lyric content.

3. The system of claim 2, wherein the visual lyric content is output in temporal alignment with the audio content output.

4. The system of claim 2, wherein the controller determines an origin point and/or initial direction of the visual lyric content movement on the display based on the position and/or orientation data.

5. The system of claim 2, further comprising a display operatively connected with the controller.

6. The system of claim 1, further comprising a display, wherein the display comprises a projector and holographic mesh, the projector configured to project the visual content at a position and/or orientation on the mesh based on the position and/or orientation data.

7. The system of claim 1, wherein the sensor comprises a wearable worn by the performer.

8. The system of claim 7, wherein the wearable comprises smart glasses, wherein the smart glasses are configured to display advance visual lyric content to the performer prior to their corresponding playback time of the visual lyric content appearing on the display.

9. The system of claim 1, wherein the sensor comprises an optical sensor, wherein the controller receives optical signal data representative of electromagnetic radiation received by the optical sensor.

10. The system of claim 1, wherein the controller is configured to dynamically update the position and/or orientation of the visual content on the display in real time based on changes in the position and/or orientation data.

11. The system of claim 1, wherein the visual content is presented on the display only at the time of a corresponding playback cue of the audio content.

12. The system of claim 1, wherein the audio content and the visual content are stored together as a synchronized audio-visual asset in the memory.

13. A method of presenting synchronized lyrics, comprising:
outputting audio content stored in memory;
outputting visual lyric content stored in memory;
sensing a position and/or orientation of a performer and generating a sensor output signal based on the sensed position and/or orientation; and
orienting the output visual lyric content based on the sensor output signal.

14. A method according to claim 13, wherein the visual lyric content is output in temporal alignment with the output of the audio content and oriented at a position on the display based on the sensor output signal.

15. The method of claim 13, wherein the sensing is performed by a wearable sensor worn by a performer.

16. The method of claim 13, further comprising providing advanced visual lyric content to the performer on a second display prior to the visual lyric content being displayed based on the sensor output signal.

17. A non-transitory computer-readable medium storing instructions that, when executed by at least one processor, cause a computer system to perform the method of claim 13.

18. A system for outputting audio/visual content, comprising:
a controller, the controller configured to receive audio input from a performer,
memory storing visual lyric content, the memory operatively connected with the controller, the controller configured to output the visual lyric content to a display based on the received audio input; and
at least one sensor operatively connected with the controller and configured to sense an orientation and/or position of the performer and, based thereon, output position and/or orientation data to the controller, wherein the controller uses the position and/or orientation data to determine an origin point and/or initial direction of visual lyric content movement on the display.

19. The system of claim 18, wherein the at least one sensor comprises a wearable worn by the performer.

20. The system of claim 19, wherein the wearable comprises smart glasses, wherein the smart glasses are configured to display advanced visual lyric content to the performer prior to the visual lyric content appearing on the display.
